(19) United States
(12) Patent Application Publication
(10) Pub. No.: US 2024/0014831 A1
(43) Pub. Date: Jan. 11, 2024

(54) SYSTEMS, APPARATUS, ARTICLES OF MANUFACTURE, AND METHODS FOR WIRELESS NETWORK OPTIMIZATION

(71) Applicant: Intel Corporation, Santa Clara, CA (US)

(72) Inventors: Valerie Parker, Portland, OR (US); Stephen Palermo, Chandler, AZ (US)

(21) Appl. No.: 18/346,006

(22) Filed: Jun. 30, 2023

Related U.S. Application Data
(60) Provisional application No. 63/436,363, filed on Dec. 30, 2022.

(51) Int. Cl. H04B 1/00; H04W 72/54

(52) U.S. Cl. CPC H04B 1/0003; H04W 72/54

(57) ABSTRACT

Systems, apparatus, articles of manufacture, and methods are disclosed for wireless network optimization. An example apparatus includes interface circuitry, machine readable instructions, and programmable circuitry. The example interface circuitry is to obtain multi-access wireless data from a wireless device associated with a network, the multi-access wireless data associated with an operation of at least one of the wireless device or infrastructure of the network. Additionally, the example programmable circuitry is to utilize the machine readable instructions to compute, in substantially real time relative to the operation, a measurement based on the multi-access wireless data. The example programmable circuitry is also to determine, in substantially real time relative to the operation, a change to a configuration of at least one of the wireless device or a virtual radio based on the measurement, the virtual radio associated with the network.

### RELATED APPLICATION

This patent claims the benefit of U.S. Provisional Patent Application No. 63/436,363, which was filed on Dec. 30, 2022. U.S. Provisional Patent Application No. 63/436,363 is hereby incorporated herein by reference in its entirety. Priority to U.S. Provisional Patent Application No. 63/436,363 is hereby claimed.

### FIELD OF THE DISCLOSURE

This disclosure relates generally to wireless networks and, more particularly, to systems, apparatus, articles of manufacture, and methods for wireless network optimization.

### BACKGROUND

Communication systems may utilize a network of multiple frequencies, spectrum, and types, such as fourth or fifth or sixth generation cellular (e.g., 4G or 5G or 6G), Citizens Broadband Radio Service (CBRS), private cellular, Wireless Fidelity (Wi-Fi), satellite (e.g., a geosynchronous equatorial orbit (GEO) satellite, a non-governmental organization (NGO) satellite, etc.), etc. In some examples, a user equipment (UE) device (also referred to as a UE) has multiple connectivity options such that the UE can connect to a network utilizing one or more of the multiple frequency spectrums and/or types.

### BRIEF DESCRIPTION OF THE DRAWINGS

FIG. 1 is an illustration of an example wireless communication system.

FIG. 2 is a block diagram of example wireless measurement engine circuitry to determine a measurement, a statistic, etc., associated with a network (e.g., a wired and/or wireless network) based on wireless data, such as Wi-Fi data, 5G NR sounding reference signal (SRS) data, timing data, noise data (e.g., 5G NR SRS measurement data, power data, clock drift data, jitter data, slicing configuration data, radio frequency data, etc.), etc., and/or any combination(s) thereof.

FIG. 3 is an illustration of a first example workflow to optimize and/or otherwise improve a wireless network using the wireless measurement engine circuitry of FIG. 2.

FIG. 4 is an illustration of a second example workflow to optimize and/or otherwise improve a wireless network using the wireless measurement engine circuitry of FIG. 2.

FIG. 5 is an illustration of an example wireless communication system that may be managed and/or controlled by the wireless measurement engine circuitry of FIG. 2.

FIG. 6 is an illustration of an example server, which may be implemented by the wireless measurement engine circuitry of FIG. 2, determining wireless measurements based on cellular data.

FIG. 7 is an illustration of another example wireless communication system that may be managed and/or controlled by the wireless measurement engine circuitry of FIG. 2.

FIG. 8 is an illustration of yet another example wireless communication system that may be managed by the wireless measurement engine circuitry of FIG. 2.

FIG. 9 is an illustration of an example wireless measurement determination architecture that can be utilized to implement the wireless measurement engine circuitry of FIG. 2.

FIG. 10 is an illustration of another example wireless measurement determination architecture that can be utilized to implement the wireless measurement engine circuitry of FIG. 2.

FIG. 11 is an illustration of an example workflow, which can be utilized by the wireless measurement engine circuitry of FIG. 2, to determine wireless measurements.

FIG. 12A depicts an example data management workflow, which can be utilized by the wireless measurement engine circuitry of FIG. 2, to process radio access network data.

FIG. 12B is an example workflow to enqueue and/or dequeue data using the dynamic load balancers of FIG. 12A.

FIG. 12C depicts an example implementation of the dynamic load balancers of FIG. 12A and/or FIG. 12B.

FIG. 12D depicts an example implementation of the dynamic load balancers of FIG. 12A and/or FIG. 12B.

FIG. 13 is a first illustration of example wireless communication layers that may be utilized to generate wireless measurements associated with an example wireless device.

FIG. 14 is a second illustration of example wireless communication layers that may be utilized to generate wireless measurements associated with an example wireless device.

FIG. 15 is a third illustration of example wireless communication layers that may be utilized to generate wireless measurements associated with an example wireless device.

FIG. 16 is a fourth illustration of example wireless communication layers that may be utilized to generate wireless measurements associated with an example wireless device.

FIG. 17 illustrates an overview of an example edge cloud configuration for edge computing that may implement the examples disclosed herein.

FIG. 18 illustrates operational layers among example endpoints, an example edge cloud, and example cloud computing environments that may implement the examples disclosed herein.

FIG. 19 illustrates an example approach for networking and services in an edge computing system that may implement the examples disclosed herein.

FIG. 20 depicts an example edge computing system for providing edge services and applications to multi-stakeholder entities, as distributed among one or more client compute platforms, one or more edge gateway platforms, one or more edge aggregation platforms, one or more core data centers, and a global network cloud, as distributed across layers of the edge computing system.

FIG. 21 illustrates a drawing of a cloud computing network, or cloud, in communication with a number of Internet of Things (IoT) devices, according to an example.

FIG. 22 illustrates network connectivity in non-terrestrial (satellite) and terrestrial (mobile cellular network) settings, according to an example.

FIG. 23 is a flowchart representative of example machine-readable instructions and/or example operations that may be executed by example processor circuitry to implement the example wireless measurement engine circuitry of FIG. 2 to cause an adjustment to a network based on wireless measurements.

FIG. 24 is another flowchart representative of example machine-readable instructions and/or example operations that may be executed by example processor circuitry to implement the example wireless measurement engine circuitry of FIG. 2 to cause an adjustment to a network based on wireless measurements.

FIG. 25 is a flowchart representative of example machine-readable instructions and/or example operations that may be executed by example processor circuitry to implement the example wireless measurement engine circuitry of FIG. 2 to change a network associated with a wireless device.

FIG. 26 is a flowchart representative of example machine-readable instructions and/or example operations that may be executed by example processor circuitry to implement the example wireless measurement engine circuitry of FIG. 2 to determine wireless measurements.

FIG. 27 is another flowchart representative of example machine-readable instructions and/or example operations that may be executed by example processor circuitry to implement the example wireless measurement engine circuitry of FIG. 2 to determine wireless measurements.

FIG. 28 is a flowchart representative of example machine-readable instructions and/or example operations that may be executed by example processor circuitry to implement the example wireless measurement engine circuitry of FIG. 2 to change a communication connection associated with a wireless device based on a reference signal comparison.

FIG. 29A is a plot representative of a known reference signal transmitted from a base station to a wireless device.

FIG. 29B is a plot representative of the known reference signal of FIG. 29A in an in-phase and quadrature representation.

FIG. 30A is a plot representative of an example resulting reference signal that does not include expected data at a frame, slot, and symbol corresponding to a known reference signal.

FIG. 30B is a plot representative of the resulting reference signal of FIG. 30A in an in-phase and quadrature representation.

FIG. 31A is a plot representative of an example resulting reference signal including data in an unexpected frame, slot, and symbol.

FIG. 31B is a plot representative of the resulting reference signal of FIG. 31A in an in-phase and quadrature representation.

FIG. 32A is a plot representative of an example noisy resulting reference signal including data in the expected frame, slot, and symbol.

FIG. 32B is a plot representative of the resulting reference signal of FIG. 32A in an in-phase and quadrature representation.

FIG. 33 illustrates a block diagram for an example IoT processing system architecture upon which any one or more of the techniques (e.g., operations, processes, methods, and methodologies) discussed herein may be performed, according to an example.

FIG. 34 is a block diagram of an example processing platform including processor circuitry structured to execute the example machine-readable instructions and/or the example operations of FIGS. 23-28 to implement the example wireless measurement engine circuitry of FIG. 2.

FIG. 35 is a block diagram of an example implementation of the processor circuitry of FIGS. 33 and/or 34.

FIG. 36 is a block diagram of another example implementation of the processor circuitry of FIGS. 33 and/or 34.

FIG. 37 is a block diagram of an example software distribution platform (e.g., one or more servers) to distribute software (e.g., software corresponding to the example machine-readable instructions of FIGS. 23-28 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” and “substantially real-time” refer to occurrence in a near instantaneous manner recognizing there may be real-world delays for computing time, transmission, etc. Thus, unless otherwise specified, “substantially real time” and “substantially real-time” refer to being within a 1-second time frame of real time. For example, a first event can occur in substantially real-time relative to a second event provided the first event occurs within 1-second of the second event. As such, substantially real-time recognizes events that occur within a tolerance of some real time event (e.g., the same event, a different event, etc.).

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

Terrestrial and non-terrestrial communication protocols, spectrums, connection technologies, etc., may be used to implement wired and/or wireless communication between communication-enabled devices (e.g., wired and/or wireless devices) commonly referred to as user equipment (UE). In some disclosed examples, a device can be an electronic and/or computing device, such as a handset device (e.g., a smartphone), a tablet, an Internet-of-Things device, industrial equipment, a wearable device, a vehicle, etc., and/or any other physical or tangible items or assets. In some disclosed examples, a device can be active by being powered and/or enabled to transmit and/or receive data. In some disclosed examples, a device can be passive by being nonpowered, unpowered, and/or disabled to transmit and/or receive data. In some disclosed examples, a device that is nonpowered, unpowered, etc., can be an object. For example, a smartphone that is turned off, has a dead battery, has a battery removed, etc., can be a device and/or an object. In some disclosed examples, UEs can include wired or wireless-enabled devices such as smartphones, tablets or tablet computers, laptop computers, desktop computers, wearable devices, or any other device capable of transmitting or receiving data through a wired and/or wireless connection.

Multiple connections are necessary to utilize a network of multiple frequencies, spectrum, and types, such as fourth or fifth or sixth generation cellular (e.g., 4G or 5G or 6G), Citizens Broadband Radio Service (CBRS), private cellular, Wireless Fidelity (Wi-Fi), satellite (e.g., a geosynchronous equatorial orbit (GEO) satellite, a non-governmental organization (NGO) satellite, etc.), etc. The ability to move frictionlessly across these connectivity options and spectrums is necessary for enterprises (e.g., entities who operate enterprise networks) to solve issues with devices that have multiple connectivity options, specifically issues with control, connectivity, and workload consolidation efforts across clients, edge, and cloud options. Conventional connection effectuation is carried out in silos either from fixed spectrum chipsets or mobile spectrum stacks, thereby complicating access methods as well as handling, security, and configuration profiling to ensure quality-of-service (QoS) from each spectrum.

Conventional communication networks are static in the sense of connectivity and configurations. In some instances, conventional communication networks are static in the sense that they are not adequately able to support multiple connection types. In some instances, conventional communication networks are static in the sense that they are unable to support configuration changes to improve efficiency. For example, conventional communication networks are typically configured based on estimated usage and connection type. In some examples, the conventional communication networks are “fixed” and put into operation to support specific wireless connection and predetermined capacity.

Conventional network deployments include deployment of multiple radio base stations to connect to each type of available communication connection (e.g., 4G/5G/6G, Wi-Fi, private radio, etc.). For example, the communication connections can include Long Term Evolution (LTE) (e.g., Cat-22, spectrums 1, 2, 3, 4, 71 Gigahertz (GHz)), 4G LTE (e.g., Cat-20, spectrums B1 . . . B71), 5G new radio (NR) sub-6 GHz (e.g., spectrums n77, n78, n79, n1-n71, etc.), 5G millimeter wave (e.g., spectrum n257, n258, n260, n261, etc.), private network space low earth orbit (LEO) satellites (e.g., spectrums Ku 12-18 GHz spectral bands, Ka 26-40 GHz spectral bands, etc.), public and/or private space satellites (e.g., Ku, Ka, X, S, and ultra high frequency (UHF) bands), GEO satellites (e.g., BeiDou Navigation Satellite System (BDS), Global Positioning System (GPS), Galileo, Glonass, Quasi-Zenith Satellite System (QZSS)), LEO satellites (e.g., IRIDIUM®, STARLINK®, etc.), etc., and/or any combination(s) thereof.

The deployment of multiple radio base stations increases deployment complexity and cost (e.g., monetary cost associated with additional hardware, resource cost associated with increased number of compute, memory, and/or network resources required to be in operation, etc.). Examples disclosed herein overcome such challenges of conventional network deployments by utilizing multi-spectrum and/or communication connection technologies to continuously identify devices that are connected to network(s).

Examples disclosed herein identify optimal and/or otherwise improved selection of communication connection technologies for which an identified device is to connect and communicate using. For example, devices can include electronic devices associated with persons (e.g., pedestrians, persons in an industrial or manufacturing setting, etc.), vehicles, equipment, tools, and the like. Examples disclosed herein can identify an electronic device and communication connection capabilities of the electronic device and, based on a variety of considerations, factors, and data (e.g., connection data, network environment data, etc.), identify a communication connection network of which the electronic device can utilize to effectuate communication with improved QoS (e.g., increased throughput, reduced latency, etc.). A possible advantage of examples disclosed herein is that examples disclosed herein can achieve an ability to connect to one or more spectrums autonomously without friction, which is not achievable with conventional communication networks. A possible advantage of examples disclosed herein is that examples disclosed herein can achieve improved service and choice based on network quality with a lower total cost of ownership for enterprises.

Network quality and usage optimizations are typically focused on a specific set of users (e.g., UEs) using the same connection type (e.g., 4G/5G, Wi-Fi, etc.) with no consideration of actual environmental (e.g., weather conditions) and/or network-centric environmental impacts (e.g., blockage of signal) or actual usage at a particular network node, either a fixed network node or base station (e.g., 5G gNodeB (gNB)) or mobile network node or base station (e.g., satellite node B (sNB), access point on a moving vehicle, etc.). Conventional techniques for optimizing and/or otherwise improving network communications are limited to one connection type and do not consider real-time usage of multi-access users and devices, which can include wireless, wired, active/passive, etc., sensors. Examples disclosed herein overcome the limitations of conventional network communication optimizations by utilizing an array of real-time network telemetry and/or real-world multi-access activity at a specific physical location.

In some disclosed examples, a wireless measurement engine (e.g., a wireless network measurement engine) can invoke Artificial Intelligence/Machine Learning (AI/ML) techniques to utilize multi-access converged connection data at a physical network node and actual network traffic utilization to determine measurements (e.g., network measurements, wireless measurements, wireless network measurements, etc.) based on wireless data, and configure and/or reconfigure network nodes based on the measurements with a re-dimensioned network node that can adapt over time to specifically address the actual needs of connected UEs or gateways.

Determination of wireless measurements may include an active collection of physical layer (e.g., Layer 1 (L1)) data. Analysis of wireless measurements may include a use of the physical layer (e.g., L1 data). Network-focused wireless measurement analytics may refer to optimizing and/or benchmarking network characteristics. Application-focused wireless measurement determination may refer to the collection of physical layer (e.g., L1) wireless network data (e.g., radio access network data, Wi-Fi data, etc.) that can improve application performance and latency associated with electronic devices (e.g., wireless devices, mobile devices, etc.).

In some disclosed examples, the wireless measurement engine can determine wireless measurements, which can include wireless device statistics with uplink and downlink scheduling information including modulation and coding schemes, NR resource blocks, a number of orthogonal frequency-division multiplexing (OFDM) slots per frame, a number of slots per frame, a number of slots per subframe, channel quality indicators (CQIs), rank indicators for antenna quality, signal-to-noise ratios (SNRs), timing advance data, etc.

In some disclosed examples, the wireless measurement engine can determine wireless measurements, which can include radio physical layer (e.g., L1) statistics including how long an application and/or service took to process uplink and/or downlink pipelines on a distributed unit (e.g., a virtual radio access network (vRAN) distributed unit (DU)). In some disclosed examples, the wireless measurement engine can determine wireless measurements, which can include vRAN DU statistics including how many cores (e.g., compute cores) are allocated and what is the utilization per core. In some disclosed examples, the wireless measurement engine can determine wireless measurements, which can include open radio access network (O-RAN) statistics including packet throughput, latencies between a radio unit and a DU, etc. In some disclosed examples, the wireless measurement engine can determine wireless measurements, which can include platform statistics including power consumption statistics that are exposed from the physical layer (e.g., L1 radio layer).

In some disclosed examples, the wireless measurement engine can determine wireless measurements, which can include in-phase (I) and quadrature (Q) samples (also referred to as IQ samples). In some disclosed examples, the IQ samples can include uplink (UL), downlink (DL), and channel sounding samples, which can be generated based on the transmission and/or reception of Sounding Reference Signals (SRS). For example, a base station can transmit a known SRS signal (e.g., a known IQ SRS sample when the known SRS signal is in IQ representation) to a wireless device to cause the wireless device to transmit back the known SRS signal. However, the known SRS signal received from the wireless device may be altered due to interference. As a result, the received SRS signal from the wireless device is different than the known SRS signal. For example, the received SRS signal from the wireless device can be a resulting SRS signal (e.g., a resulting IQ SRS sample when the resulting SRS signal is in IQ representation) because the signal is a result of the interference.

In some disclosed examples, the wireless measurement engine can self-calibrate network nodes using active, live, operational, etc., usage data. For example, the wireless measurement engine can adjust (e.g., automatically adjust) a network node to converged multi-access usage by reconfiguring, based on determining wireless measurements, either fixed or mobile network nodes to accommodate actual-, live-, or real-world usage and telemetry of connected users, devices, or gateways.

In some disclosed examples, the wireless measurement engine can access wireless connectivity at the 1-2 open systems interconnection (OSI) layer (e.g., L1, Layer 2 (L2), etc.), sense the wireless spectrum type, enable the connection, provide multi-access in one base station (or more), and/or the appropriate billing method. In examples disclosed herein, multi-access includes terrestrial (e.g., cellular (e.g., 5G NR, fourth generation (4G)/Long Term Evolution (LTE), etc.), Wi-Fi, citizens broadband radio service (CBRS), public safety spectrum(s), etc.) connectivity as well as non-terrestrial satellite-based connectivity (e.g., Kᵤ band, Kₐ band, low earth orbit (LEO) uplink/downlink (UL/DL), geostationary earth orbit (GEO) UL/DL, proprietary satellite spectrum(s), licensed and/or unlicensed terrestrial spectrums (e.g., a UE connected to a satellite using a licensed terrestrial spectrum), etc.). In some disclosed examples, the wireless measurement engine can use real time, low latency analytics to determine how and when to connect to the UE/device. In some disclosed examples, the wireless measurement engine can perform on the wire modifications to ongoing packet streams using real-time telemetry.

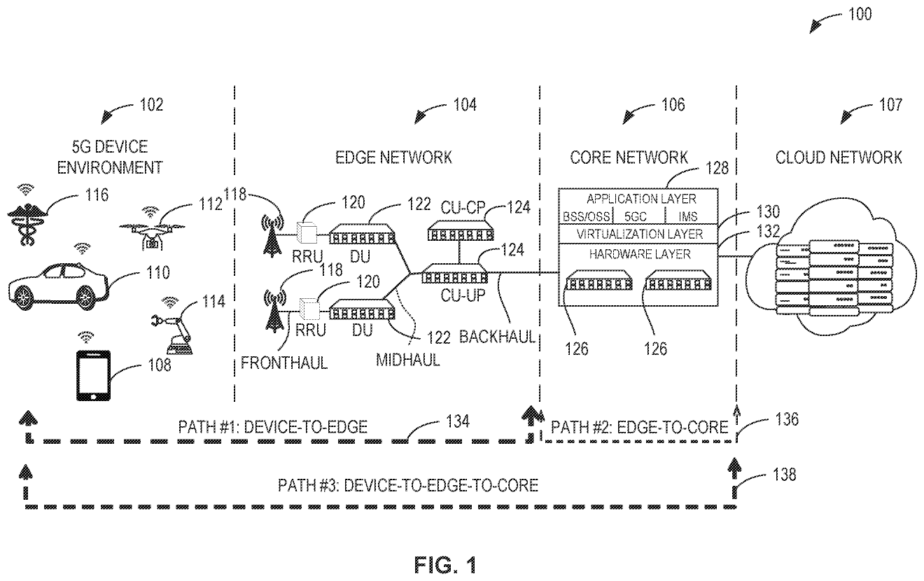

FIG. 1 is an illustration of an example wireless communication system 100. The wireless communication system 100 includes an example device environment 102, an example edge network 104, an example core network 106, and an example cloud network 107. In this example, the device environment 102 is a fifth generation cellular (e.g., 5G) device environment that facilitates the execution of computing and/or electronic tasks using a wireless network, such as a wireless network based on 5G (e.g., a 5G cellular network, a 5G wireless network, etc.).

Additionally or alternatively, the device environment 102 may be implemented by any other generation of cellular technology such as fourth generation cellular (e.g., 4G) LTE and/or sixth generation cellular (e.g., 6G).

In the illustrated example of FIG. 1, the device environment 102 includes example devices (e.g., computing devices, electronic devices, UEs, etc.) 108, 110, 112, 114, 116. The devices 108, 110, 112, 114, 116 include a first example device 108, a second example device 110, a third example device 112, a fourth example device 114, and a fifth example device 116. In the example of FIG. 1, the first device 108 is a 5G-enabled smartphone. Alternatively, the first device 108 may be a tablet computer (e.g., a 5G-enabled tablet computer), a laptop (e.g., a 5G-enabled laptop), a wearable device (e.g., a 5G-enabled wearable device such as a smartwatch or headset), etc. In the example of FIG. 1, the second device 110 is a vehicle (e.g., an automobile, a combustion engine vehicle, an electric vehicle, a hybrid-electric vehicle, an autonomous or autonomous capable vehicle, etc.). For example, the second device 110 can be an electronic control unit and/or any other hardware included in the vehicle, which, in some examples, can be a self-driving, autonomous, or computer-assisted driving vehicle.

In the illustrated example of FIG. 1, the third device 112 is an aerial vehicle. For example, the third device 112 can be processor circuitry and/or any other type of hardware included in an unmanned aerial vehicle (UAV) (e.g., an autonomous UAV, a human or user-controlled UAV, etc.), such as a drone. In the example of FIG. 1, the fourth device 114 is a robot. For example, the fourth device 114 can be a collaborative robot, a robot arm, and/or any other type of machinery used in assembly, emergency, lifting, manufacturing, etc., types of activities, tasks, or operations.

In the illustrated example of FIG. 1, the fifth device 116 is a healthcare associated device. For example, the fifth device 116 can be a server (e.g., a computer server, an edge server, a rack-mount server, etc.) that stores, analyzes, and/or otherwise processes health care records or health care related data. In some examples, the fifth device 116 can be a medical device, such as an infusion pump, a magnetic resonance imaging (MRI) machine, a surgical robot, a vital sign monitoring device, etc. In some examples, one or more of the devices 108, 110, 112, 114, 116 can be a different type of computing device, such as a server, a personal computer, a workstation, a self-learning machine (e.g., a neural network), a mobile device (e.g., a cell phone, a smart phone, a tablet), a personal digital assistant (PDA), an Internet appliance, a digital versatile disk (DVD) player, a compact disk (CD) player, a digital video recorder, a Blu-ray player, a gaming console, a personal video recorder, a set top box, a headset or other wearable device, or any other type of computing or electronic device. In some examples, the device environment 102 may include fewer or more devices and/or types of devices than depicted in the illustrated example of FIG. 1.

In the illustrated example of FIG. 1, the devices 108, 110, 112, 114, 116 and/or, more generally, the device environment 102, are in communication with the edge network 104 via first example networks 118. In the example of FIG. 1, the first networks 118 are cellular networks (e.g., 5G cellular networks). For example, the first networks 118 can be implemented by antennas, radio towers, etc., and/or any combination(s) thereof. Additionally and/or alternatively, one or more of the first networks 118 may be implemented by an Ethernet connection, a digital subscriber line (DSL) connection, a telephone line connection, a coaxial cable system, a fiber optic system, a satellite system, a line-of-site wireless system, a beyond-line-of-site wireless system, a cellular telephone system, a terrestrial network, a non-terrestrial network, etc., and/or any combination(s) thereof.

In the illustrated example of FIG. 1, the edge network 104 includes the first networks 118, example remote radio units (RRUs) 120, example distributed units (DUs) 122, and example centralized units (CUs) 124. In this example, the DUs 122 and/or the CUs 124 are multi-core computing or electronic systems. For example, one or more of the DUs 122 and/or one or more of the CUs 124 can include a plurality of processors (e.g., multi-core processors or multiple instances of multi-core processor circuitry) that can each include a plurality of cores (e.g., compute cores, processor cores, compute or processor core circuitry, etc.). In some examples, the DUs 122 and/or the CUs 124 are edge servers (e.g., 5G edge servers), such as multi-core edge servers, that can effectuate the distribution of data flows (e.g., communication flows, packet flows, a flow of one or more data packets, etc.) through the edge network 104 to a different destination (e.g., the device environment 102 (e.g., 5G device environment), the core network 106, etc.). In some examples, the edge network 104 may include fewer or more of the first networks 118, the RRUs 120, the DUs 122, and/or the CUs 124 than depicted in the illustrated example of FIG. 1.

In the illustrated example of FIG. 1, the RRUs 120 are radio transceivers (e.g., remote radio transceivers, also referred to as remote radio heads (RRHs)) in a base station (e.g., a radio base station). For example, the RRUs 120 can be hardware, which can include radio frequency (RF) circuitry, analog-to-digital/digital-to-analog converters, and/or up/down power converters, that connect to a network of an operator (e.g., a telecommunication service provider (“telco,” or “TSP”), a cellular operator or provider, etc.). In some examples, the RRUs 120 can convert a digital signal to an RF signal, amplify the RF signal to a desired power level, and radiate the amplified RF signal in air via one or more antennas. In some examples, the RRUs 120 can receive a desired band of signal from the air via the one or more antennas and amplify the received signal. The RRUs 120 are termed as remote because the RRUs 120 are typically installed on a mast-top, or tower-top location that is physically distant from base station hardware, which is often mounted in an indoor rack-mounted location or installation. In some examples, the RRUs 120 can be referred to as radio units (RUs).

In the illustrated example of FIG. 1, the RRUs 120 are coupled to and/or otherwise in communication with a respective one of the DUs 122. In some examples, the DUs 122 include hardware that implements real-time L1 scheduling functions (e.g., physical layer control) and/or L2 scheduling functions (e.g., radio link control (RLC), media or medium access control (MAC), etc.). In some examples, the CUs 124 include hardware that implements Layer 3 (L3) scheduling functions, such as packet data convergence control (PDCP) and/or radio resource control (RRC) functions. In some examples, a first one of the CUs 124 is a centralized unit control plane (CU-CP) and a second one of the CUs 124 is a centralized unit user plane (CU-UP).

In some examples, the L1 data can correspond to L1 data of an OSI model. In some examples, the L1 data of an OSI model can correspond to the physical layer of the OSI model (e.g., L1 data can be referred to as physical layer wireless data), L2 data of the OSI model can correspond to the data link layer of the OSI model (e.g., L2 data can be referred to as data link layer wireless data), L3 data of the OSI model can correspond to the network layer of the OSI model (e.g., L3 data can be referred to as network layer wireless data), and so forth. In some examples, the L1 data can correspond to the transmitted raw bit stream over a physical medium (e.g., a wired line physical structure such as coax or fiber, an antenna, a receiver, a transmitter, a transceiver, etc.). In some examples, the L1 data can be implemented by signals, binary transmission, etc. In some examples, the L2 data can correspond to physical addressing of the data, which may include Ethernet data, MAC addresses, logical link control (LLC) data, etc. In some examples, the L3 data can correspond to the functional and procedural means of transferring variable-length data sequences from a source to a destination host via one or more networks, while maintaining the QoS functions.

In the illustrated example of FIG. 1, at least one of (i) one or more of the DUs 122 or (ii) one or more of the CUs 124 implement a vRAN. For example, one or more of the DUs 122, or portion(s) thereof, can be virtualized to implement one or more vRAN DUs. In some examples, one or more of the CUs 124, or portion(s) thereof, can be virtualized to implement one or more vRAN CUs. In some examples, one or more of the DUs 122 and/or one or more of the CUs 124 can execute, run, and/or otherwise implement virtualized baseband functions on vendor-agnostic hardware (e.g., commodity server hardware) based on the principles of network function virtualization (NFV). NFV is a network architecture concept that uses the technologies of information technology (IT) virtualization to virtualize entire classes of network node functions into building blocks that may be connected, or chained together, to create communication services. In some examples, a vRAN (e.g., a vRAN DU, a vRAN CU, etc.) can be referred to as a virtual radio.

RUs, RRUs, RANs, vRANs, DUs, CUs, and/or core servers as disclosed herein can be implemented by FLEXRAN™ Reference Architecture for Wireless Access provided by Intel® Corporation of Santa Clara, California. In some examples, FLEXRAN™ can be implemented by an off-the-shelf general-purpose Xeon® series processor with Intel Architecture server system and/or a virtualized platform including components of processors, input/output (I/O) circuitry, and/or accelerators (e.g., artificial intelligence and/or machine-learning accelerators, ASICs, FPGAs, GPUs, etc.) provided by Intel® Corporation. Additionally or alternatively, FLEXRAN™ can be implemented by a specialized and/or customized server system and/or a virtualized platform including components of processors, input/output (I/O) circuitry, and/or accelerators (e.g., artificial intelligence and/or machine-learning accelerators, ASICs, FPGAs, GPUs, etc.) provided by Intel® Corporation and/or any other manufacturer. A possible advantage of examples disclosed herein is that, in some examples, FlexRAN™ Reference Architecture can enable increased levels of flexibility with the programmable on-board features, memory, and I/O. A possible advantage of examples disclosed herein is that, in some examples, deployments based on the FlexRAN™ Reference Architecture can scale from small to large capacities with the same set of components running different applications or functions, ranging from the RAN to core network and data center including edge computing and media, enabling economies of scale. A possible advantage of examples disclosed herein is that, in some examples disclosed herein, architectures, deployments, and/or systems based on the 3rd Generation Partnership Project (3GPP) standard and/or the Open RAN standard can be implemented by hardware, software, and/or firmware associated with FLEXRAN™. For example, a 3GPP system as disclosed herein can include a server including processor circuitry that can execute and/or instantiate machine-readable instructions to implement FLEXRAN™.

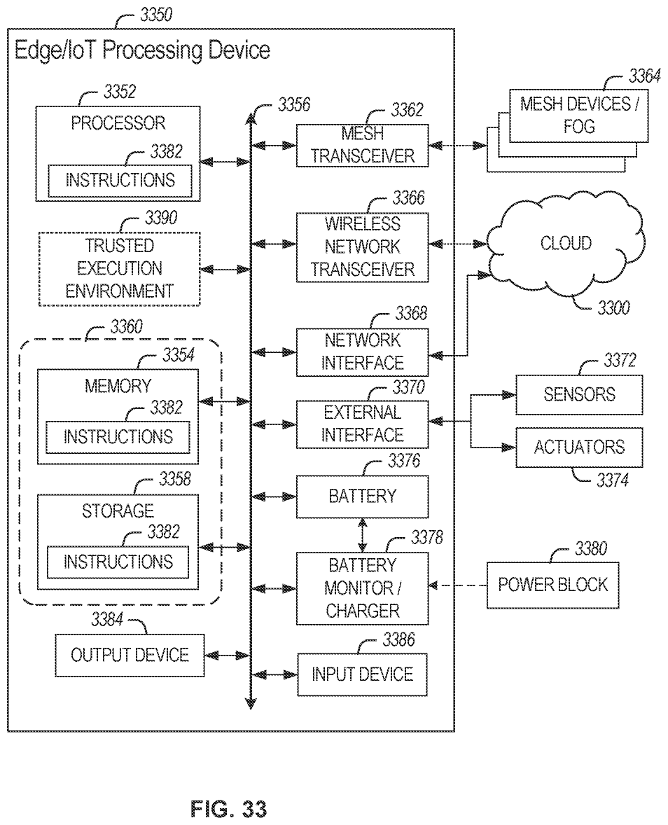

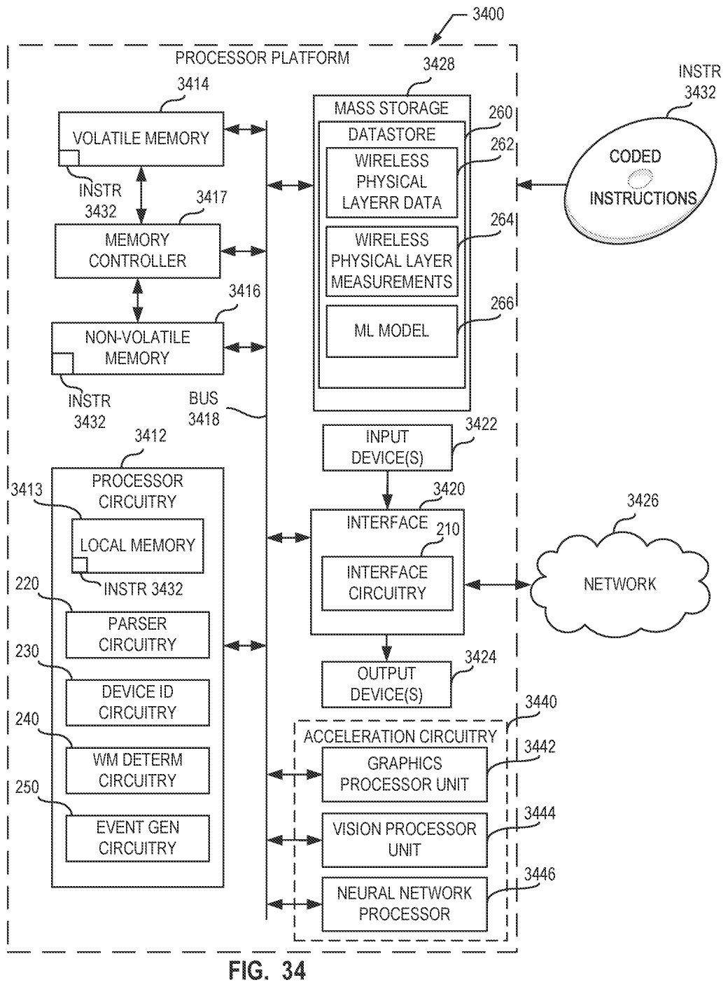

In some examples, hardware platforms, such as the IoT device 3350 of FIG. 33, the processor platform 3400 of FIG. 34, etc., can include hardware accelerator(s), hardware accelerator or acceleration circuitry, etc., that can utilize FLEXRAN™ functionality with improved efficiency compared to non-accelerated deployments. For example, FLEXRAN™ can include functions implemented by different types of Instruction Set Architectures. In some examples, the functions can include Fast-Fourier Transform (FFT), Inverse-Fast-Fourier Transform (IFFT), etc., algorithms, calculations, computations, determinations, etc., which can be implemented by hardware executing and/or instantiating corresponding machine-readable instructions. For example, the IoT device 3350 of FIG. 33, the processor platform 3400 of FIG. 34, etc., can include one or more hardware accelerators that can execute and/or instantiate FFT, IFFT, etc., machine-readable instructions to receive wireless data, calculate and/or determine measurements and/or parameters based on the wireless data, and/or output the measurements/parameters with increased efficiency, increased bandwidth, increased throughput, and/or reduced latency. In some examples, the IoT device 3350 of FIG. 33, the processor platform 3400 of FIG. 34, etc., can include processor circuitry that can offload compute workloads, such as FFT, IFFT, etc., workloads, to the one or more hardware accelerators to process the compute workloads based on the FLEXRAN™ functions.

In the illustrated example of FIG. 1, first connection(s) or communication link(s) between the first networks 118 and the RRUs 120 implement(s) the fronthaul of the edge network 104. Second connection(s) or communication link(s) between the DUs 122 and the CUs 124 implement(s) the midhaul of the edge network 104. Third connection(s) or third communication link(s) between the CUs 124 and the core network 106 implement(s) the backhaul of the edge network 104. In the example of FIG. 1, the core network 106 includes example core devices 126. In some examples, the core devices 126 are multi-core computing or electronic systems. For example, one or more of the core devices 126 can include a plurality of processors (e.g., multi-core processors, multiple instances of processor circuitry, etc.) that each include a plurality of cores (e.g., compute cores, processor cores, compute or processor core circuitry, etc.). For example, one or more of the core devices 126 can be servers (e.g., physical servers, virtual or virtualized servers, etc., and/or any combination(s) thereof). In some examples, one or more of the core devices 126 can be implemented with the same or substantially similar hardware as the DUs 122, the CUs 124, etc. Additionally or alternatively, one or more of the core devices 126 may be implemented by any other type of computing or electronic device.

In the illustrated example of FIG. 1, the core network 106 is implemented by different logical layers including an example application layer 128, an example virtualization layer 130, and an example hardware layer 132. In some examples, the core devices 126 of the hardware layer 132 implement core servers. In some examples, the application layer 128 (or portion(s) thereof), the virtualization layer 130 (or portion(s) thereof), and/or the hardware layer 132 (or portion(s) thereof), implement one or more core servers. For example, a core server can be implemented by the application layer 128, the virtualization layer 130, and/or the hardware layer 132 associated with a first one of the core devices 126, a second one of the cores devices 126, etc., and/or any combination(s) thereof.

In some examples, the application layer 128 can include and/or implement business support systems (BSS), operations support systems (OSS), 5G core (5GC) systems, Internet Protocol multimedia core network subsystems (IMS), etc., in connection with operation of a telecommunications network, such as the wireless communication system 100 of FIG. 1, or portion(s) thereof. In some examples, the virtualization layer 130 can be representative of virtualizations of the physical hardware resources of the core devices 126, such as virtualizations of processor circuitry resources (e.g., central processor units (CPUs), graphics processor units (GPUs), etc.), memory resources (e.g., non-volatile memory, volatile memory, etc.), storage resources (e.g., hard-disk drives (HDDs), solid-state disk (SSD) drives, etc.), network resources (e.g., network interface cards (NICs), network interface circuitry, gateways, routers, etc.), etc. In some examples, the virtualization layer 130 can control and/or otherwise manage the virtualizations of the physical hardware resources with a hypervisor that can run and/or otherwise instantiate one or more virtual machines (VMs), containers, etc., built and/or otherwise composed of the virtualizations of the physical hardware resources.

In the illustrated example of FIG. 1, the core network 106 is in communication with the cloud network 107. In some examples, the cloud network 107 can be implemented by a private and/or public cloud services provider. For example, the cloud network 107 can be implemented by virtual and/or physical hardware, software, and/or firmware resources to execute computing tasks or workloads. In some examples, the cloud network 107 can implement and/or otherwise effectuate Function-as-a-Service (FaaS), Infrastructure-as-a-Service (IaaS), Software-as-a-Service (SaaS), etc., systems.

In the illustrated example of FIG. 1, multiple example communication paths 134, 136, 138 are depicted including a first example communication path 134 (identified by PATH #1: DEVICE-TO-EDGE), a second example communication path 136 (identified by PATH #2: EDGE-TO-CORE), and a third example communication path 138 (identified by PATH #3: DEVICE-TO-EDGE-TO-CORE). In the illustrated example, the first communication path 134 is a device-to-edge communication path that corresponds to communication between one(s) of the devices 108, 110, 112, 114, 116 of the device environment 102 (e.g., the 5G device environment) and one(s) of the first networks 118, RRUs 120, DUs 122, and/or CUs 124 of the edge network 104. The second communication path 136 of the illustrated example is an edge-to-core communication path that corresponds to communication between one(s) of the first networks 118, RRUs 120, DUs 122, and/or CUs 124 of the edge network 104 and one(s) of the core devices 126 of the core network 106. The third communication path 138 of the illustrated example is a device-to-edge-to-core communication path that corresponds to communication between one(s) of the devices 108, 110, 112, 114, 116 and one(s) of the core devices 126 via one(s) of the first networks 118, RRUs 120, DUs 122, and/or CUs 124 of the edge network 104.

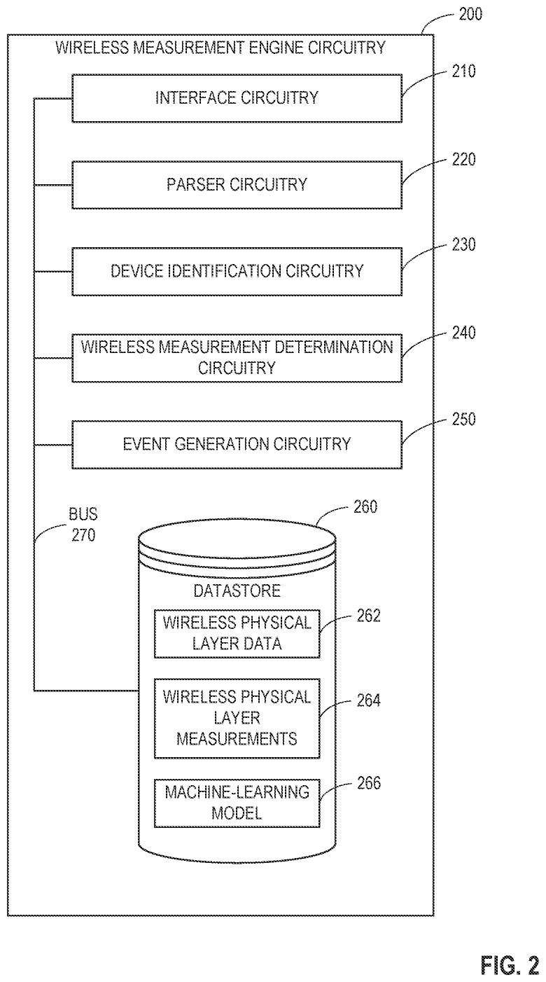

FIG. 2 is a block diagram of wireless measurement engine circuitry 200 to determine a measurement, a statistic, etc., associated with a network (e.g., a wired and/or wireless network) based on wireless data, such as Wi-Fi data, 5G NR sounding reference signal (SRS) data, timing data, noise data (e.g., 5G NR SRS measurement data, power data, clock drift data, jitter data, slicing configuration data, radio frequency data, etc.), etc., and/or any combination(s) thereof. The wireless measurement engine circuitry 200 of FIG. 2 may be instantiated (e.g., creating an instance of, bring into being for any length of time, materialize, implement, etc.) by processor circuitry such as a central processing unit executing instructions. Additionally or alternatively, the wireless measurement engine circuitry 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the wireless measurement engine circuitry 200 may, thus, be instantiated at the same or different times. Some or all of the wireless measurement engine circuitry 200 may be instantiated, for example, in one or more threads executing concurrently on hardware and/or in series on hardware. Moreover, in some examples, some or all of the wireless measurement engine circuitry 200 may be implemented by microprocessor circuitry executing instructions to implement one or more virtual machines and/or containers.

In some examples, the wireless measurement engine circuitry 200, or portion(s) thereof, can implement a measurement engine (e.g., a cellular data measurement engine, a wireless data measurement engine, a wireless measurement engine, etc.). For example, the wireless measurement engine circuitry 200, or portion(s) thereof, can implement a measurement engine based on FlexRAN™ Reference Architecture. In some examples, at least one of one(s) of the first networks 118, one(s) of the RRUs 120, one(s) of the DUs 122, one(s) of the CUs 124, one(s) of the core devices 126, or the cloud network 107 can be implemented by the wireless measurement engine circuitry 200. For example, a first one and/or a second one of the first networks 118, or portion(s) thereof, can be implemented by the wireless measurement engine circuitry 200. In some examples, a first one and/or a second one of the RRUs 120, or portion(s) thereof, can be implemented by the wireless measurement engine circuitry 200. In some examples, a first one and/or a second one of the DUs 122, or portion(s) thereof, can be implemented by the wireless measurement engine circuitry 200. In some examples, a first one and/or a second one of the CUs 124, or portion(s) thereof, can be implemented by the wireless measurement engine circuitry 200. In some examples, a first one and/or a second one of the core devices 126, or portion(s) thereof, can be implemented by the wireless measurement engine circuitry 200. In some examples, the cloud network 107, or portion(s) thereof, can be implemented by the wireless measurement engine circuitry 200.

In the illustrated example of FIG. 2, the wireless measurement engine circuitry 200 includes example interface circuitry 210, example parser circuitry 220, example device identification circuitry 230, example wireless measurement determination circuitry 240, example event generation circuitry 250, an example datastore 260, and an example bus 270. In this example, the datastore 260 includes example wireless physical layer data 262, example wireless physical layer measurements 264, and example machine-learning (ML) model(s) 266. In the example of FIG. 2, the interface circuitry 210, the parser circuitry 220, the device identification circuitry 230, the wireless measurement determination circuitry 240, the event generation circuitry 250, and/or the datastore 260, is/are in communication with one(s) of each other via the bus 270. For example, the bus 270 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCI-E) bus. Additionally or alternatively, the bus 270 may be implemented by any other type of computing or electrical bus.

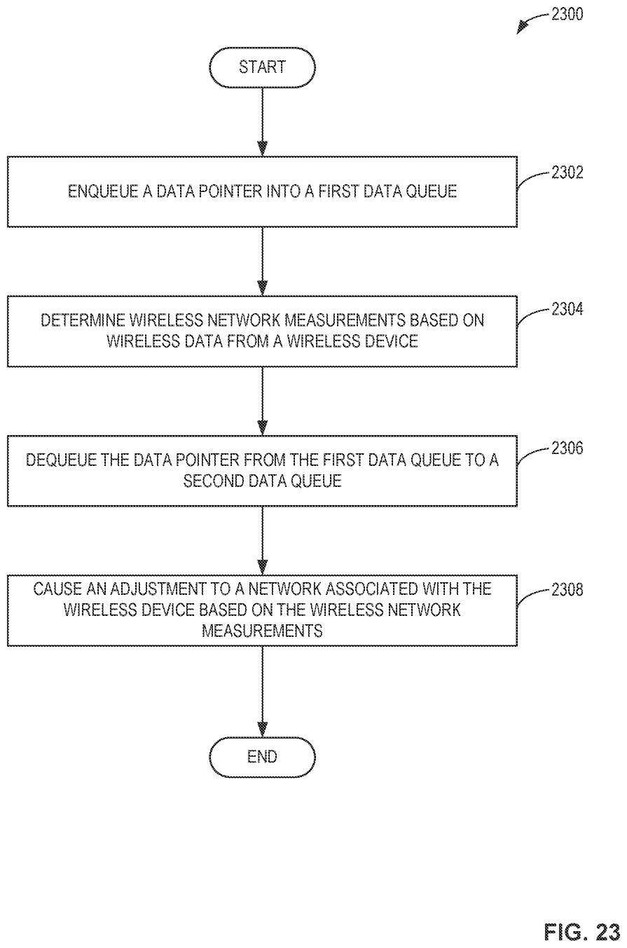

In the illustrated example of FIG. 2, the wireless measurement engine circuitry 200 includes the interface circuitry 210 to receive data from device(s). The wireless measurement engine circuitry 200 of the example of FIG. 2 includes the interface circuitry 210 to transmit data to device(s). In some examples, the interface circuitry 210 stores received and/or transmitted data in the datastore 260 as the wireless physical layer data 262. In some examples, the interface circuitry 210 is instantiated by processor circuitry executing interface instructions and/or configured to perform operations such as those represented by the flowcharts of FIGS. 23, 24, 25, 26, 27, and/or 28. For example, the interface circuitry 210 can transmit and/or receive wireless data (e.g., wireless physical layer data) of any type, such as cellular data (e.g., 4G LTE, 5G, 6G, etc.), satellite data (e.g., beyond line of site data, line of site data, etc.), Wi-Fi data, Bluetooth data, optical data, etc., and/or any combination(s) thereof.

In some examples, the interface circuitry 210 can receive data from one(s) of the devices 108, 110, 112, 114, 116, the first networks 118, the RRUs 120, the DUs 122, the CUs 124, the core devices 126, the device environment 102 (e.g., the 5G device environment), the edge network 104, the core network 106, the cloud network 107, etc., of FIG. 1. In some examples, the interface circuitry 210 can transmit data to one(s) of the devices 108, 110, 112, 114, 116, the first networks 118, the RRUs 120, the DUs 122, the CUs 124, the core devices 126, the device environment 102 (e.g., the 5G device environment), the edge network 104, the core network 106, the cloud network 107, etc., of FIG. 1.

In some examples, the interface circuitry 210 can be implemented by hardware in accordance with any type of interface standard, such as an Ethernet interface, a universal serial bus (USB) interface, a BLUETOOTH® interface, a near field communication (NFC) interface, a PCI interface, a PCIe interface, a secure payment gateway (SPG) interface, a Global Navigation Satellite System (GNSS) interface, a 4G/5G/6G interface, a CBRS interface, a Category 1 (CAT-1) interface, a Category M (CAT-M) interface, a NarrowBand-Internet of Things (NB-IoT) interface, etc., and/or any combination(s) thereof. In some examples, the interface circuitry 210 can be implemented by one or more communication devices such as one or more receivers, one or more transceivers, one or more modems, one or more gateways (e.g., residential, commercial, or industrial gateways), one or more wireless access points (WAPs), and/or one or more network interfaces to facilitate exchange of data with external machines (e.g., computing devices of any kind) by a network, such as the device environment 102 (e.g., the 5G device environment), the edge network 104, the core network 106, the cloud network 107, the first networks 118, etc., of FIG. 1. In some examples, the interface circuitry 210 can implement the communication by, for example, an Ethernet connection, a DSL connection, a telephone line connection, a coaxial cable system, a satellite system or network (e.g., a line-of-sight (LOS) satellite system or network, a beyond-line-of-sight (BLOS) satellite system or network, etc.), a cellular telephone system, an optical connection, etc., and/or any combination(s) thereof.

In the illustrated example of FIG. 2, the wireless measurement engine circuitry 200 includes the parser circuitry 220 to extract portion(s) of data (e.g., physical layer data) received by the interface circuitry 210. In some examples, the parser circuitry 220 is instantiated by processor circuitry executing parser instructions and/or configured to perform operations such as those represented by the flowcharts of FIGS. 23, 24, 25, 26, 27, and/or 28. In some examples, the parser circuitry 220 can extract portion(s) of data from data such as cell site or cell tower data, Wi-Fi data, Bluetooth data, satellite data, location data (e.g., coordinate data, such as azimuth, x-coordinate (horizontal), y-coordinate (vertical), and/or z-coordinate (altitude, elevation, height, etc.) data), registration data (e.g., cellular registration data), SRS data (e.g., SRS measurement data), SNR data, channel impulse response (CIR) data, device identifiers (e.g., vendor identifiers, manufacturer identifiers, device name identifiers, etc.), headers (e.g., Internet Protocol (IP) addresses and/or ports, MAC addresses and/or ports, etc.), payloads (e.g., protocol data units (PDUs), Hypertext Transfer Protocol (HTTP) payloads, Hypertext Transfer Protocol Secure (HTTPs) payloads, etc.), cellular data (e.g., L1 data, L2 data, User Datagram Protocol/Internet Protocol (UDP/IP) data, General Packet Radio Services (GPRS) tunnel protocol user plane (GTP-U) data, SRS data, SNR data, CIR data, etc.), etc., and/or any combination(s) thereof. In some examples, the parser circuitry 220 can store one(s) of the extracted portion(s) in the datastore 260 as the wireless physical layer data 262.

In some examples, the parser circuitry 220 includes and/or implements a dynamic load balancer (DLB) to extract data received by and/or otherwise associated with the interface circuitry 210. In some examples, the dynamic load balancer can be implemented by a Dynamic Load Balancer provided by Intel® of Santa Clara, California. Additionally or alternatively, the parser circuitry 220 may implement a queue management service, which can be implemented by hardware, software, and/or firmware. In some examples, the parser circuitry 220 generates queue events (e.g., data queue events, enqueue events, dequeue events, etc.). In some examples, the queue events can be implemented by an array of data (e.g., a data array). Alternatively, the queue events may be implemented by any other data structure. For example, the parser circuitry 220 can generate a first queue event, which can include a data pointer that references data stored in memory, a priority (e.g., a value indicative of the priority, a data priority, etc.) of the data, etc., and/or any combination(s) thereof. In some examples, the events can correspond to, be indicative of, and/or otherwise be representative of workload(s) (e.g., compute or computational workload(s), data processing workload(s), etc.) to be facilitated by DLB circuitry, which can be implemented by the parser circuitry 220. For example, the parser circuitry 220 can generate a queue event as an indication of data to be enqueued to the DLB circuitry to generate output(s) based on the enqueued data.

In some examples, a queue event, such as the first queue event, can be implemented by an interrupt (e.g., a hardware, software, and/or firmware interrupt) that, when generated and/or otherwise invoked, can indicate to the DLB circuitry (and/or DLB service) that there is/are workload(s) associated with the wireless physical layer data 262 to be performed or carried out. In some examples, the DLB circuitry can enqueue (e.g., add, insert, load, store, etc.) the queue event by adding, enqueueing, inserting, loading, and/or otherwise storing the data pointer, the priority, etc., into first hardware queue(s) (e.g., producer or data producer queue(s), load balancer queue(s), hardware implemented load balancer queue(s), etc.) included in and/or otherwise implemented by the DLB circuitry. Additionally or alternatively, the DLB service can enqueue the queue event by enqueueing, loading, and/or otherwise storing the data pointer, the priority, etc., into the first hardware queue(s).

In some examples, the priority (e.g., the data priority) can be based on waiting for all antenna data (e.g., SRS data from all expected antenna(s)) or waiting for a minimum threshold of data and/or measurements. For example, different queues can have different priorities. In some examples, a first data queue maintained by the DLB circuitry can be associated with a first data priority in which SRS data is not to be enqueued to worker core(s) until the SRS data from all expected antenna(s) is received. In some examples, a second data queue maintained by the DLB circuitry can be associated with a second data priority in which SRS data is not to be enqueued to worker core(s) until a threshold amount of SRS data and/or associated measurements is received and/or determined.

In some examples, a worker core can be a core of processor circuitry that is available to receive a workload to process. For example, the worker core can be idle or not executing a workload. In some examples, the worker core can be busy or executing a workload but may not be busy or executing a workload when the worker core is needed to receive another workload. In some examples, a worker core can be a core of processor circuitry that is configured to handle a particular workload. For example, a workload to be processed can be a machine-learning workload. In some examples, a core of processor circuitry may not be a worker core if the core is not configured to execute and/or instantiate the machine-learning workload. In some examples, a core of processor circuitry may not be a worker core if the core is not configured to execute and/or instantiate the machine-learning workload with increased efficiency and thereby the core may be a sub-optimal or nonideal choice to execute and/or instantiate the machine-learning workload. In some examples, a core of processor circuitry can be a worker core if the core is configured for a particular workload, such as by having a configuration of an operating frequency (e.g., a clock frequency), access to instructions from an Instruction Set Architecture (ISA) (e.g., a machine-learning ISA, a 5G cellular related ISA, etc.), etc., and/or any combination(s) thereof, to execute the workload.

In some examples, the DLB circuitry can dequeue the queue event by dequeuing, loading, and/or otherwise storing the data pointer, the priority, etc., into second hardware queue(s) (e.g., consumer or data consumer queue(s), load balancer queue(s), hardware implemented load balancer queue(s), etc.) that may be accessed by compute cores (e.g., consumer cores of processor circuitry, worker cores of processor circuitry, etc.) for subsequent processing. In some examples, the compute cores are included in and/or otherwise implemented by the parser circuitry 220, and/or, more generally, the wireless measurement engine circuitry 200. In some examples, the compute cores are included in and/or otherwise implemented by the DLB circuitry. In some examples, one or more of the compute cores are separate from the DLB circuitry. Additionally or alternatively, the DLB service can dequeue the queue event by dequeuing, loading, and/or otherwise storing the data pointer, the priority, etc., into the second hardware queue(s).

In some examples, a compute core can write data to the queue event. For example, the queue event can be implemented by a data array. In some examples, the compute core can write data into one or more positions of the data array. For example, the compute core can add data to one or more positions of the data array that does not include data, modify existing data of the data array, and/or remove existing data of the data array. By way of example, the parser circuitry 220 can dequeue a queue event from the DLB circuitry. The parser circuitry 220 can determine that the queue event includes a data pointer that references wireless data, such as SRS data. The parser circuitry 220 can complete (and/or cause completion of) a computation operation or workload on the wireless data, such as identifying data portion(s) of interest from the wireless data, extracting data portion(s) of interest from the wireless data, etc. After completion of the computation operation/workload, the parser circuitry 220 can cause a compute core to write a completion bit, byte, etc., into the queue event. After the completion bit, byte, etc., is written to the queue event, the parser circuitry 220 can enqueue the queue event back to the DLB circuitry.

In some examples, the DLB circuitry can determine that the computation operation has been completed by identifying the completion bit, byte, etc., in the queue event.

In the illustrated example of FIG. 2, the wireless measurement engine circuitry 200 includes the device identification circuitry 230 to identify a device, such as a wireless device that is adapted to effectuate wireless electronic communication. In some examples, the device identification circuitry 230 is instantiated by processor circuitry executing device identification instructions and/or configured to perform operations such as those represented by the flowcharts of FIGS. 23, 24, 25, 26, 27, and/or 28. In some examples, the device identification circuitry 230 can identify one(s) of the devices 108, 110, 112, 114, 116 of FIG. 1 based on the wireless physical layer data 262. For example, the device identification circuitry 230 can identify the one(s) of the devices 108, 110, 112, 114, 116 based on an identifier (e.g., a universally unique identifier (UUID), a UE identifier, a manufacturer identifier, a vendor identifier, etc.), an address (e.g., an IP address, a MAC address, etc.), etc., and/or any combination(s) thereof. In some examples, the device identification circuitry 230 can store the device identification(s) in the datastore 260 as the wireless physical layer data 262.

In some examples, the device identification circuitry 230 can generate association(s) (e.g., data association(s)) of a device (e.g., an identification of a device), a measurement periodicity, and a location. For example, the device identification circuitry 230 can generate one or more data associations of the first device 108, a measurement periodicity of determining a location of the first device 108 two times per second (e.g., 2 Hertz (Hz)), and a location of the first device 108 of in the device environment 102 of FIG. 1 (e.g., a building, a campus, a residential home, a warehouse, etc.). In some examples, the measurement periodicity can be a data collection periodicity of obtaining cellular data from a device, such as obtaining cellular data from the first device 108 three times per second (e.g., 3 Hz). For example, the device identification circuitry 230 can generate one or more data associations of the first device 108, a data collection periodicity of requesting and/or obtaining reference signal (e.g., SRS) data from the first device 108 three times per second (e.g., 3 Hz), and/or a location of the first device 108 in the device environment 102 of FIG. 1 (e.g., a building, a campus, a residential home, a warehouse, etc.). In some examples, the device identification circuitry 230 can store the one or more associations in the datastore 260 as the wireless physical layer data 262. As used herein, the term “measurement frequency” may be used interchangeably with “sampling frequency” and/or “data sampling frequency.”

In the illustrated example of FIG. 2, the wireless measurement engine circuitry 200 includes the wireless measurement determination circuitry 240 to calculate and/or determine a measurement, a statistic, etc., associated with the wireless transmission of data between one or more first devices and one or more second devices. In some examples, the wireless measurement determination circuitry 240 is instantiated by processor circuitry executing wireless measurement determination instructions and/or configured to perform operations such as those represented by the flowcharts of FIGS. 23, 24, 25, 26, 27, and/or 28. In some examples, the wireless measurement determination circuitry 240 can calculate, determine, generate, and/or output wireless measurement based on wireless data. For example, the wireless measurement determination circuitry 240 can determine location measurements (e.g., coordinate data, such as azimuth, x-coordinate (horizontal), y-coordinate (vertical), and/or z-coordinate (altitude, elevation, height, etc.) coordinate data), registration data (e.g., cellular registration data), SRS measurements (e.g., SRS measurement data), signal-to-noise ratio (SNR) measurements, channel impulse response (CIR) measurements, device identifier data (e.g., vendor identifiers, manufacturer identifiers, device name identifiers, etc.), header data (e.g., IP addresses and/or ports, MAC addresses and/or ports, etc.), payload data (e.g., PDUs, HTTP payloads, HTTPs payloads, etc.), cellular measurements (e.g., L1 data, L2 data, UDP/IP data, GTP-U data, SRS data, SNR data, CIR data, etc.), Wi-Fi measurements, Bluetooth measurements, satellite measurements, etc., and/or any combination(s) thereof. In some examples, the wireless measurement determination circuitry 240 can store the wireless measurements in the datastore 260 as the wireless physical layer measurements 264. As used herein, the term “measurement” may be used interchangeably with the term “parameter.”

In some examples, the wireless physical layer measurements 264 can include L1 latency measurements, such as downlink latency measurements (e.g., a minimum downlink latency, a maximum downlink latency, an average downlink latency), downlink latency per transmission time interval (TTI) measurements (e.g., minimum, maximum, average, etc.), uplink latency measurements (e.g., minimum, maximum, average, etc.), uplink latency per TTI measurements (e.g., minimum, maximum, average, etc.), SRS latency measurements (e.g., minimum, maximum, average, etc.), SRS latency per TTI measurements (e.g., minimum, maximum, average, etc.), etc. In some examples, the wireless physical layer measurements 264 can include L1 cellular measurements, such as a cellular data throughput between MAC and physical layer (PHY) layers for each active cell, active wireless device, and/or each uplink and/or downlink per wireless device. In some examples, the wireless physical layer measurements 264 can include L1 baseband unit (BBU) core usage measurements, such as a percentage core utilization of respective compute cores of a BBU. In some examples, the wireless physical layer measurements 264 can include L1 O-RAN fronthaul measurements, such as a total number of receive (RX) packets, a number of RX packets that arrive on time, a number of RX packets that arrive early, a number of RX packets that arrive late, a number of RX packets that are corrupt, a number of RX packets that are duplicate, etc.

In some examples, the wireless physical layer measurements 264 can include L1 vRAN measurements, such as a number of RX packets per second, RX throughput, transmit (TX) packets per second, TX throughput, etc. In some examples, the wireless physical layer measurements 264 can include vRAN port measurements, such as a number of RX physical uplink shared channel (PUSCH) packets per each antenna port, a number of RX SRS packets per each antenna port, a number of RX physical random access channel (PRACH) packets per each antenna port, etc. In some examples, the wireless physical layer measurements 264 can include any other type of wireless measurement, such as a number of PDSCH per slot, a number of physical downlink control channel (PDCCH) per slot, a number of channel state information reference signal (CSIRS) per slot, a number of PUSCH per slot, a number of SRS per slot, a number of L1 cells, a number of L1 cores, a number of L1 radios, a number of L1 antenna ports, a number of L1 symbols, downlink MAC PHY measurements, a number of uplink MAC PHY measurements, IQ measurements, latency measurements, cell measurements, core usage measurements, etc.

In some examples, the wireless measurement determination circuitry 240 can calculate, determine, generate, and/or output wireless measurement, such as a number of carriers, a download bandwidth, an upload bandwidth, a download fast Fourier transform (FFT) size, an upload FFT size, a number of downlink resource blocks, a number of uplink resource blocks, a number of transmission antennas, a number of receiving antennas, a number of downlink ports, a number of uplink ports, a numerology measurement, a cellular identifier, a single-sideband (SSB) power, an SSB period, an SSB subcarrier spacing, an SSB subcarrier offset, an SSB mask, a number of active SSBs, a demodulation reference signal (DMRS) type measurement, a PRACH configuration index or identifier, a PRACH subcarrier spacing measurement, a PRACH zero correlation zone configuration measurement, a PRACH restricted set measurement, a PRACH root sequence index, a PRACH starting frequency, a PRACH frequency division multiplexing (FDM) measurement, a PRACH SSB random access channel (RACH) measurement, a PRACH number of receive RU (NrofRXRU) measurement, a cyclic prefix measurement, a group hop flag measurement, a sequence hop flag measurement, a hopping index or identifier, a frame duplex mode measurement, a time division duplex (TDD) period measurement, a slot configuration measurement, an uplink throughput measurement, a downlink throughput measurement, a transmission comb, etc.

In some examples, the wireless measurement determination circuitry 240 can calculate, determine, generate, and/or output wireless measurements, such as a number (e.g., a maximum number) of downlink channels in a slot, a number (e.g., a maximum number) of downlink data channels in a slot, a number (e.g., a maximum number) of downlink control channels in a slot, a number (e.g., a maximum number) of uplink channels in a slot, a number (e.g., a maximum number) of uplink data channels in a slot, a number (e.g., a maximum number) of uplink control channels in a slot, a number (e.g., a maximum number) of reference signal (e.g., SRS) channels in a slot, etc. Additionally or alternatively, the wireless measurement determination circuitry 240 may calculate, determine, generate, and/or output any other type and/or quantity of wireless measurements associated with wireless data.

In some examples, the wireless measurement determination circuitry 240 determines reliability data associated with a network. For example, the wireless measurement determination circuitry 240 can identify an antenna and/or a receiver at which the wireless physical layer data 262 is received. In some examples, the wireless measurement determination circuitry 240 can determine that the antenna and/or the receiver have technical specifications such as an operating frequency, a bandwidth, a polarization, an antenna gain, a platform height, an incident angle, an azimuth beamwidth, an elevation beamwidth, a horizontal beamwidth, a vertical beam width, an electrical down tilt, an upper side lobe level, a front to back ratio, isolation between ports, a power rating, an impedance, an antenna configuration, a return loss, etc. For example, the wireless measurement determination circuitry 240 can determine that the wireless physical layer data 262 from a first antenna with first technical specifications can have increased reliability and/or increased data integrity (and/or reduced uncertainty or data uncertainty or error rate) with respect to the wireless physical layer data 262 from a second antenna with second technical specifications. For example, the first antenna can have a higher power rating, azimuth beamwidth, etc., than the power rating, the azimuth beamwidth, etc., of the second antenna. In some examples, the technical specifications of the antennas and/or the receivers can be input to the machine-learning model 266 to improve an accuracy of the output(s). In some examples, the output(s) of the machine-learning model 266 can include reliability indicators, uncertainty values, etc., associated with the wireless measurement determinations. For example, the output(s) of the machine-learning model 266 can include (i) a percentage of dropped wireless data packets, (ii) a reliability indicator (e.g., a reliability indicator of 70% reliable where 100% is the most reliable and 0% is the least reliable, 85% reliable, 98% reliable, etc.) representative (e.g., a reliability metric representative) of the accuracy of the percentage and/or a reliability of the underlying data (e.g., a quantification of the reliability of data from one or more first antennas of a first base station). Additionally or alternatively, any other input to the machine-learning model 266, such as the wireless physical layer data 262 and/or the wireless physical layer measurements 264, can be assigned reliability data or values to be evaluated by the machine-learning model 266.

In the illustrated example of FIG. 2, the wireless measurement engine circuitry 200 includes the event generation circuitry 250 to generate an event (e.g., data representative of an event, event data representative of an event, etc.) to cause action(s), operation(s), etc., to be executed. In some examples, the event generation circuitry 250 is instantiated by processor circuitry executing event generation instructions and/or configured to perform operations such as those represented by the flowcharts of FIGS. 23, 24, 25, 26, 27, and/or 28. In some examples, an event can be implemented by data representative of a command, a direction or directive, an instruction, etc. In some examples, an event can be implemented by data representative of an alert, an indication, a notification, a warning, etc. In some examples, the event generation circuitry 250 can generate an event to invoke one(s) of the devices 108, 110, 112, 114, 116 of FIG. 1 to execute action(s), operation(s), etc. For example, the event generation circuitry 250 can generate an event that, when received and/or otherwise identified by the second device 110, causes the second device 110 to switch or change to a different wireless network (e.g., from Wi-Fi to 5G cellular). In some examples, the event generation circuitry 250 can generate an event that, when received by the fourth device 114, to change a transmission configuration associated with an antenna of the fourth device 114 to improve wireless communication performance. In some examples, the event generation circuitry 250 can generate an event to be indicative of an alert, an indication, etc., of an abnormal condition (e.g., a sudden or immediate drop in bandwidth, throughput, etc., a loss of wireless connectivity, etc.) associated with the device environment 102, and/or, more generally, the wireless communication system 100. In some examples, the event generation circuitry 250 can store the event(s) in the datastore 260 as the wireless physical layer data 262 and/or the wireless physical layer measurements 264.

In the illustrated example of FIG. 2, the wireless measurement engine circuitry 200 includes the datastore 260 to record data (e.g., the wireless physical layer data 262, the wireless physical layer measurements 264, the machine-learning model 266, etc.). In some examples, the datastore 260 is instantiated by processor circuitry executing datastore instructions and/or configured to perform operations such as those represented by the flowcharts of FIGS. 23, 24, 25, 26, 27, and/or 28. The datastore 260 of FIG. 2 can be implemented by a volatile memory and/or a non-volatile memory (e.g., flash memory). The datastore 260 may additionally or alternatively be implemented by one or more double data rate (DDR) memories, such as DDR, DDR2, DDR3, DDR4, DDR5, mobile double data rate (mDDR), etc. The datastore 260 may additionally or alternatively be implemented by one or more mass storage devices such as HDD(s), CD drive(s), DVD drive(s), SSD drive(s), etc. While in the illustrated example the datastore 260 is illustrated as a single datastore, the datastore 260 may be implemented by any number and/or type(s) of datastores. Furthermore, the data stored in the datastore 260 may be in any data format such as, for example, binary data, comma delimited data, tab delimited data, structured query language (SQL) structures, an executable (e.g., an executable binary, an ML configuration image, etc.), etc. In some examples, the datastore 260 can implement one or more databases. As used herein, “database” refers to an organized body of related data, regardless of the manner in which the data or the organized body thereof is represented. For example, the organized body of related data can be in the form of one or more of a table, a map, a grid, a packet, a datagram, a frame, a file, an e-mail, a message, a document, a report, a list or in any other form.

In some examples, the wireless physical layer data 262 can include data received by the interface circuitry 210. For example, the wireless physical layer data 262 can be data received from one(s) of the devices 108, 110, 112, 114, 116, the first networks 118, the RRUs 120, the DUs 122, the CUs 124, the core devices 126, the device environment 102, the edge network 104, the core network 106, the cloud network 107, etc., of FIG. 1. In some examples, the wireless physical layer data 262 can include network data, GPS data, 4G LTE/5G/6G data, location data, direction and/or speed data (e.g., direction and/or speed data associated with one(s) of the devices 108, 110, 112, 114, 116). In some examples, the wireless physical layer data 262 can include an identifier of an antenna and/or a receiver (e.g., a base station, an IoT device, a gateway, etc.) that received the wireless physical layer data 262. For example, the wireless measurement determination circuitry 240 can determine where the wireless physical layer data 262 is received and what hardware received the wireless physical layer data 262 based on the identifier of the antenna and/or the receiver. In some examples, the wireless physical layer data 262 can include device identification data, event data, reference signal (e.g., SRS) data, CIR data, SNR data, etc., and/or any combination(s) thereof. In some examples, the wireless physical layer data 262 can be data obtained via a terrestrial network and/or a non-terrestrial network. For example, the wireless physical layer data 262 can be obtained by a terrestrial network, such as a wired Ethernet network or a 5G wireless network. In some examples, the wireless physical layer data 262 can be obtained by a non-terrestrial network, such as satellite network (e.g., a LOS satellite network, a BLOS satellite network, etc.).

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the wireless measurement engine circuitry 200 can train the ML model 266 with data to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the wireless measurement engine circuitry 200 generates the ML model 266 as neural network model(s). The wireless measurement engine circuitry 200 can use a neural network model to execute an AI/ML workload, which, in some examples, may be executed using one or more hardware accelerators. In general, machine-learning models/architectures that are suitable to use in the example approaches disclosed herein include recurrent neural networks. However, other types of machine learning models could additionally or alternatively be used such as supervised learning artificial neural network (ANN) models, clustering models, classification models, etc., and/or a combination thereof. Example supervised learning ANN models can include two-layer (2-layer) radial basis neural networks (RBN), learning vector quantization (LVQ) classification neural networks, etc. Example clustering models can include k-means clustering, hierarchical clustering, mean shift clustering, density-based clustering, etc. Example classification models can include logistic regression, support-vector machine or network, Naive Bayes, etc. In some examples, the wireless measurement engine circuitry 200 can compile, generate, and/or otherwise output the ML model 266 as a lightweight machine-learning model.

In general, implementing an ML/AI system involves two phases, a learning/training phase and an inference phase. In the learning/training phase, the wireless measurement engine circuitry 200 uses a training algorithm to train the ML model 266 to operate in accordance with patterns and/or associations based on, for example, training data. In general, the ML model 266 include(s) internal parameters (e.g., configuration register data) that guide how input data is transformed into output data, such as through a series of nodes and connections within the ML model 266 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the wireless measurement engine circuitry 200 can invoke supervised training to use inputs and corresponding expected (e.g., labeled) outputs to select parameters (e.g., by iterating over combinations of select parameters) for the ML model 266 that reduce model error. As used herein, “labeling” refers to an expected output of the machine learning model (e.g., a classification, an expected output value, etc.). Alternatively, the wireless measurement engine circuitry 200 may invoke unsupervised training (e.g., used in deep learning, a subset of machine learning, etc.) that involves inferring patterns from inputs to select parameters for the ML model 266 (e.g., without the benefit of expected (e.g., labeled) outputs).

In some examples, the wireless measurement engine circuitry 200 trains the ML model 266 using unsupervised clustering of operating observables. For example, the operating observables can include reference signal data (e.g., SRS measurement data), a certificate (e.g., a digital certificate), an IP address, a manufacturer and/or vendor identifier, a MAC address, a serial number, a universal unique identifier (UUID), data associated with a UE, the wireless physical layer data 262, the wireless physical layer measurements 264, etc., and/or any combination(s) thereof. However, the wireless measurement engine circuitry 200 may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the wireless measurement engine circuitry 200 can train the ML model 266 until the level of error is no longer reducing. In some examples, the wireless measurement engine circuitry 200 can train the ML model 266 locally on the wireless measurement engine circuitry 200 and/or remotely at an external computing system communicatively coupled to a network. In some examples, the wireless measurement engine circuitry 200 trains the ML model 266 using hyperparameters that control how the learning is performed (e.g., a learning rate, a number of layers to be used in the machine learning model, etc.). In some examples, the wireless measurement engine circuitry 200 can use hyperparameters that control model performance and training speed such as the learning rate and regularization parameter(s). The wireless measurement engine circuitry 200 can select such hyperparameters by, for example, trial and error to reach an optimal model performance. In some examples, the wireless measurement engine circuitry 200 utilizes Bayesian hyperparameter optimization to determine an optimal and/or otherwise improved or more efficient network architecture to avoid model overfitting and improve the overall applicability of the ML model 266. Alternatively, the wireless measurement engine circuitry 200 may use any other type of optimization. In some examples, the wireless measurement engine circuitry 200 can perform re-training. The wireless measurement engine circuitry 200 can execute such re-training in response to override(s) by a user of the wireless measurement engine circuitry 200, a receipt of new training data, etc.

In some examples, the wireless measurement engine circuitry 200 facilitates the training of the ML model 266 using training data. In some examples, the wireless measurement engine circuitry 200 utilizes training data that originates from locally generated data, such as 4G LTE L1 data, 5G L1 data, 6G L1 data, reference signal (e.g., SRS) data, radio identifiers, CIR data, SNR data, etc. In some examples, the wireless measurement engine circuitry 200 utilizes training data that originates from externally generated data. For example, the wireless measurement engine circuitry 200 can utilize L1 data, L2 data, etc., from any data source (e.g., a RAN system, a satellite, etc.).

In some examples where supervised training is used, the wireless measurement engine circuitry 200 can label the training data (e.g., label training data or portion(s) thereof as object identification data, location data, etc.). Labeling is applied to the training data by a user manually or by an automated data pre-processing system. In some examples, the wireless measurement engine circuitry 200 can pre-process the training data using, for example, an interface (e.g., interface circuitry, network interface circuitry, etc.) to extract and/or otherwise identify data of interest and discard data not of interest to improve computational efficiency. In some examples, the wireless measurement engine circuitry 200 sub-divides the training data into a first portion of data for training the ML model 266, and a second portion of data for validating the ML model 266.

Once training is complete, the wireless measurement engine circuitry 200 can deploy the ML model 266 for use as executable construct(s) that process(es) an input and provides output(s) based on the network of nodes and connections defined in the ML model 266. The wireless measurement engine circuitry 200 can store the ML model 266 in a datastore, such as the datastore 260, that can be accessed by the wireless measurement engine circuitry 200, a cloud repository, etc. In some examples, the wireless measurement engine circuitry 200 can transmit the ML model 266 to external computing system(s) via a network. In some examples, in response to transmitting the ML model 266 to the external computing system(s), the external computing system(s) can execute the ML model 266 to execute AI/ML workloads with at least one of improved efficiency or performance to achieve improved object tracking, location detection and/or determination, etc., and/or any combination(s) thereof.

Once trained, the deployed one(s) of the ML model 266 can be operated in an inference phase to process data. In the inference phase, data to be analyzed (e.g., live data) is input to the ML model 266, and the ML model 266 execute(s) to create output(s). This inference phase can be thought of as the AI “thinking” to generate the output based on what it learned from the training (e.g., by executing the ML model 266 to apply the learned patterns and/or associations to the live data). In some examples, input data undergoes pre-processing before being used as an input to the ML model 266. Moreover, in some examples, the output data can undergo post-processing after it is generated by the ML model 266 to transform the output into a useful result (e.g., a display of data, a detection and/or identification of an object, a location determination of an object, an instruction to be executed by a machine, etc.).

In some examples, output of the deployed one(s) of the ML model 266 can be captured and provided as feedback. By analyzing the feedback, an accuracy of the deployed one(s) of the ML model 266 can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, the outputs of the ML model 266 can be the wireless physical layer measurements 264, or portion(s) thereof. In some examples, the outputs of the ML model 266 can be a recommendation to change an aspect of a network. For example, the recommendation can be to increase an antenna power of a transmitting UE and/or a receiving base station. In some examples, the recommendation can be to activate, enable, and/or increase a number of compute cores of a base station that is allocated to handle and/or process network traffic to improve network performance and/or throughput (e.g., increase performance and/or increase throughput). In some examples, the recommendation can be to deactivate, disenable, and/or decrease a number of compute cores of a base station that is allocated to handle and/or process network traffic to conserve power.

As used herein, “data” is information in any form that may be ingested, processed, interpreted and/or otherwise manipulated by processor circuitry to produce a result. The produced result may itself be data. As used herein, a “dataset” is a set of one or more collections of information (e.g., unprocessed and/or raw data, calculated and/or determined measurements based on the unprocessed and/or raw data, etc.) in any form that may be ingested, processed, interpreted and/or otherwise manipulated by processor circuitry to produce a result. The produced result may itself be data. As used herein, a “model” is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data. As used herein “threshold” is expressed as data such as a numerical value represented in any form, that may be used by processor circuitry as a reference for a comparison operation.

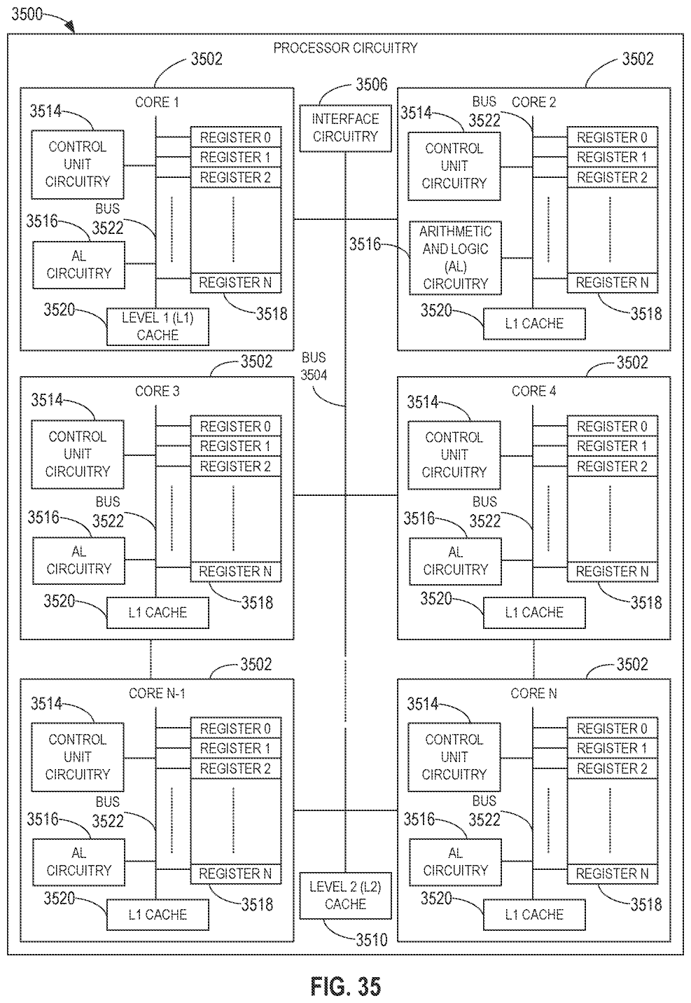

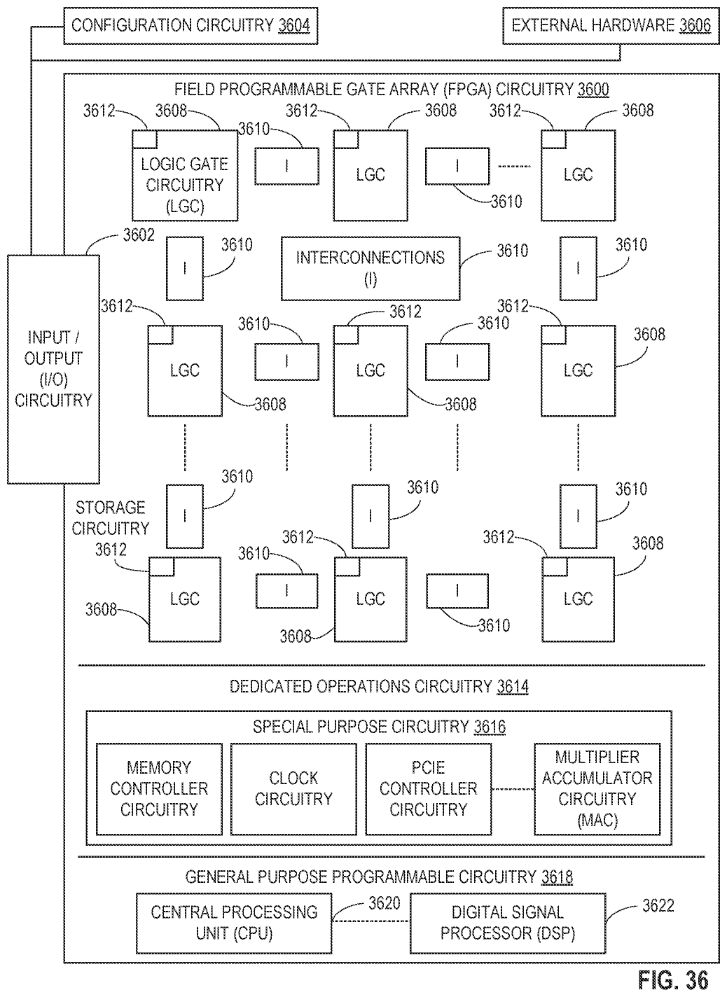

In some examples, the wireless measurement engine circuitry 200 includes means for receiving and/or transmitting data (e.g., wireless physical layer data). For example, the means for receiving and/or transmitting data may be implemented by the interface circuitry 210. In some examples, the interface circuitry 210 may be instantiated by processor circuitry such as the example processor 3352 of FIG. 33, the example processor circuitry 3412 of FIG. 34, the example microprocessor 3500 of FIG. 35, and/or the example FPGA circuitry 3600 of FIG. 36. For instance, the interface circuitry 210 may be instantiated by the example microprocessor 3500 of FIG. 35 executing machine executable instructions such as those implemented by one or more blocks of one(s) of FIGS. 23-28. In some examples, the interface circuitry 210 may be instantiated by hardware logic circuitry, which may be implemented by an ASIC, XPU, or the FPGA circuitry 3600 of FIG. 36 structured to perform operations corresponding to the machine readable instructions. Additionally or alternatively, the interface circuitry 210 may be instantiated by any other combination of hardware, software, and/or firmware. For example, the interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the wireless measurement engine circuitry 200 includes means for extracting data (e.g., wireless physical layer data) and/or means for parsing data (e.g., wireless physical layer data). For example, the means for extracting and/or parsing data may be implemented by the parser circuitry 220. In some examples, the parser circuitry 220 may be instantiated by processor circuitry such as the example processor 3352 of FIG. 33, the example processor circuitry 3412 of FIG. 34, the example microprocessor 3500 of FIG. 35, and/or the example FPGA circuitry 3600 of FIG. 36. For instance, the parser circuitry 220 may be instantiated by the example microprocessor 3500 of FIG. 35 executing machine executable instructions such as those implemented by one or more blocks of one(s) of FIGS. 23-28. In some examples, the parser circuitry 220 may be instantiated by hardware logic circuitry, which may be implemented by an ASIC, XPU, or the FPGA circuitry 3600 of FIG. 36 structured to perform operations corresponding to the machine readable instructions. Additionally or alternatively, the parser circuitry 220 may be instantiated by any other combination of hardware, software, and/or firmware. For example, the parser circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the wireless measurement engine circuitry 200 includes means for identifying a device. For example, the means for identifying a device may be implemented by the device identification circuitry 230. In some examples, the device identification circuitry 230 may be instantiated by processor circuitry such as the example processor 3352 of FIG. 33, the example processor circuitry 3412 of FIG. 34, the example microprocessor 3500 of FIG. 35, and/or the example FPGA circuitry 3600 of FIG. 36. For instance, the device identification circuitry 230 may be instantiated by the example microprocessor 3500 of FIG. 35 executing machine executable instructions such as those implemented by one or more blocks of one(s) of FIGS. 23-28. In some examples, the device identification circuitry 230 may be instantiated by hardware logic circuitry, which may be implemented by an ASIC, XPU, or the FPGA circuitry 3600 of FIG. 36 structured to perform operations corresponding to the machine readable instructions. Additionally or alternatively, the device identification circuitry 230 may be instantiated by any other combination of hardware, software, and/or firmware. For example, the device identification circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the wireless measurement engine circuitry 200 includes means for determining a measurement (e.g., a wireless physical layer measurement). For example, the means for determining a measurement may be implemented by the wireless measurement determination circuitry 240. In some examples, the wireless measurement determination circuitry 240 may be instantiated by processor circuitry such as the example processor 3352 of FIG. 33, the example processor circuitry 3412 of FIG. 34, the example microprocessor 3500 of FIG. 35, and/or the example FPGA circuitry 3600 of FIG. 36. For instance, the wireless measurement determination circuitry 240 may be instantiated by the example microprocessor 3500 of FIG. 35 executing machine executable instructions such as those implemented by one or more blocks of one(s) of FIGS. 23-28. In some examples, the wireless measurement determination circuitry 240 may be instantiated by hardware logic circuitry, which may be implemented by an ASIC, XPU, or the FPGA circuitry 3600 of FIG. 36 structured to perform operations corresponding to the machine readable instructions. Additionally or alternatively, the wireless measurement determination circuitry 240 may be instantiated by any other combination of hardware, software, and/or firmware. For example, the wireless measurement determination circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the wireless measurement engine circuitry 200 includes means for generating an event (e.g., event data). For example, the means for generating an event may be implemented by the event generation circuitry 250. In some examples, the event generation circuitry 250 may be instantiated by processor circuitry such as the example processor 3352 of FIG. 33, the example processor circuitry 3412 of FIG. 34, the example microprocessor 3500 of FIG. 35, and/or the example FPGA circuitry 3600 of FIG. 36. For instance, the event generation circuitry 250 may be instantiated by the example microprocessor 3500 of FIG. 35 executing machine executable instructions such as those implemented by one or more blocks of one(s) of FIGS. 23-28. In some examples, the event generation circuitry 250 may be instantiated by hardware logic circuitry, which may be implemented by an ASIC, XPU, or the FPGA circuitry 3600 of FIG. 36 structured to perform operations corresponding to the machine readable instructions. Additionally or alternatively, the event generation circuitry 250 may be instantiated by any other combination of hardware, software, and/or firmware. For example, the event generation circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the wireless measurement engine circuitry 200 includes means for storing data. For example, the means for storing data may be implemented by the datastore 260. In some examples, the datastore 260 may be instantiated by processor circuitry such as the example processor 3352 of FIG. 33, the example processor circuitry 3412 of FIG. 34, the example microprocessor 3500 of FIG. 35, and/or the example FPGA circuitry 3600 of FIG. 36. For instance, the datastore 260 may be instantiated by the example microprocessor 3500 of FIG. 35 executing machine executable instructions such as those implemented by one or more blocks of one(s) of FIGS. 23-28. In some examples, the datastore 260 may be instantiated by hardware logic circuitry, which may be implemented by an ASIC, XPU, or the FPGA circuitry 3600 of FIG. 36 structured to perform operations corresponding to the machine readable instructions. Additionally or alternatively, the datastore 260 may be instantiated by any other combination of hardware, software, and/or firmware. For example, the datastore 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the wireless measurement engine circuitry 200 is illustrated in FIG. 2, one or more of the elements, processes, and/or devices illustrated in FIG. 2 may be combined, divided, re-arranged, omitted, eliminated, and/or implemented in any other way. Further, the example interface circuitry 210, the example parser circuitry 220, the example device identification circuitry 230, the example wireless measurement determination circuitry 240, the example event generation circuitry 250, the example datastore 260, the example bus 270, and/or, more generally, the example wireless measurement engine circuitry 200 of FIG. 2, may be implemented by hardware alone or by hardware in combination with software and/or firmware. Thus, for example, any of the example interface circuitry 210, the example parser circuitry 220, the example device identification circuitry 230, the example wireless measurement determination circuitry 240, the example event generation circuitry 250, the example datastore 260, the example bus 270, and/or, more generally, the example wireless measurement engine circuitry 200, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example wireless measurement engine circuitry 200 of FIG. 2 may include one or more elements, processes, and/or devices in addition to, or instead of, those illustrated in FIG. 2, and/or may include more than one of any or all of the illustrated elements, processes, and devices.

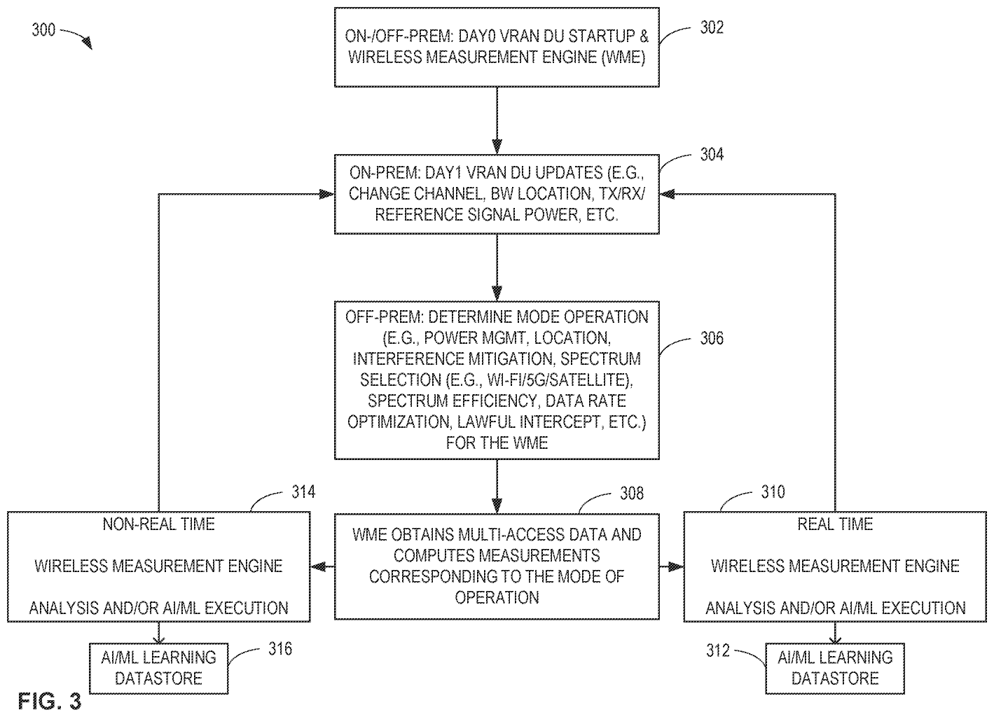

FIG. 3 is an illustration of a first example workflow 300 to optimize and/or otherwise improve a wireless network using the wireless measurement engine circuitry 200 of FIG. 2. The first workflow 300 begins at block 302, at which a vRAN DU and the wireless measurement engine circuitry 200 of FIG. 2, which may be implemented as part of the vRAN DU, as disclosed herein are started up and/or initialized on- and/or off-premises. For example, the vRAN DU may be a virtual radio that is to control the wireless network and the wireless measurement engine circuitry 200 may be implemented as part of the vRAN DU. At block 304, the vRAN DU updates (e.g., change(s) channel, bandwidth (BW) location, transmit (TX) power, receive (RX) power, reference signal (e.g., SRS) power, etc.) the wireless network and/or one or more devices in communication with the wireless network.

In the illustrated example of FIG. 3, at block 306, the wireless measurement engine circuitry 200 determines a mode of operation (e.g., power management, location detection/identification/determination, interference mitigation, spectrum selection, spectrum efficiency, data rate optimization, lawful intercept, etc.) for the wireless measurement engine circuitry 200. For example, the wireless measurement engine circuitry 200 can operate in a power management mode of operation, a location detection/identification/determination mode of operation, an interference mitigation mode of operation, a spectrum selection mode of operation, a spectrum efficiency mode of operation, a data rate optimization mode of operation, a lawful intercept mode of operation, among others. In some examples, the modes of operation are autonomous. For example, a user can configure the wireless measurement engine circuitry 200 to autonomously operate in a mode of operation by causing transmission of a signal to the wireless measurement engine circuitry 200 from a compute device that is remote with respect to the wireless measurement engine circuitry 200. For example, the user can configure the wireless measurement engine circuitry 200, which may be implemented by a vRAN DU executed and/or instantiated at a BBU, by causing transmission of a signal from a compute device located at an office of an enterprise and/or from the user's home.

In the illustrated example of FIG. 3, at block 308, the wireless measurement engine circuitry 200 obtains multi-access (e.g., multi-spectrum) data (e.g., at least one of 5G data, Wi-Fi data, satellite data, or any other type of wireless data) and computes measurements (e.g., wireless physical layer measurements) corresponding to the mode of operation. For example, the multi-access data is associated with an operation of at least one of a wireless device associated with the wireless network or the wireless network. Additionally, at block 308, the wireless measurement engine circuitry 200 computes the measurements in substantially real time relative to the operation. At block 310, the wireless measurement engine circuitry 200 analyzes the wireless measurements and/or executes and/or instantiates the machine-learning model 266 of FIG. 2 to generate output(s) in substantially real-time relative to the operation. For example, the output(s) can be recommendations to change a network configuration, such as how the vRAN DU is to operate (e.g., cause the vRAN DU to change a channel, increase/decrease TX/RX/reference signal power, etc.). At block 312, the wireless measurement engine circuitry 200 causes storage of the output(s) to an AI/ML learning datastore to improve performance of the machine-learning model 266.

In the illustrated example of FIG. 3, at block 314, the wireless measurement engine circuitry 200 analyzes the wireless measurements and/or executes and/or instantiates the machine-learning model 266 of FIG. 2 to generate output(s) in non-real time relative to the operation. For example, the output(s) can be recommendations to change a network configuration, such as how the vRAN DU is to operate (e.g., cause the vRAN DU to change a channel, increase/decrease TX/RX/reference signal power, etc.). At block 316, the wireless measurement engine circuitry 200 causes storage of the output(s) to an AI/ML learning datastore to improve performance of the machine-learning model 266. For example, the data stored in the AI/ML learning datastore can be used to train and/or retrain the machine-learning model 266.

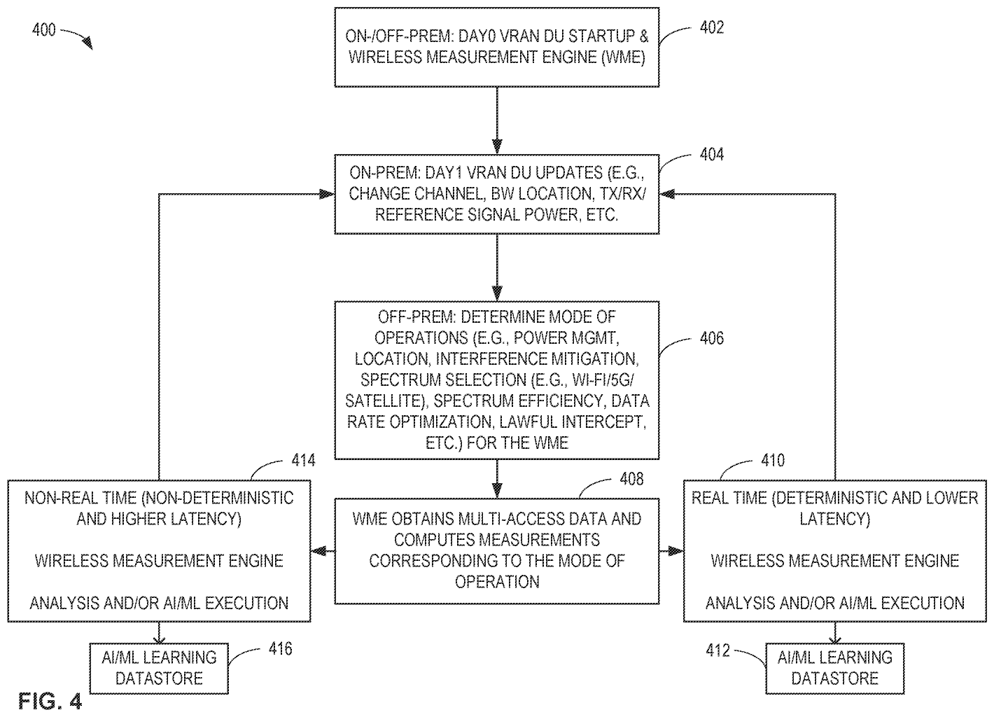

FIG. 4 is an illustration of a second example workflow 400 to optimize and/or otherwise improve a wireless network using the wireless measurement engine circuitry 200 of FIG. 2. The second workflow 400 begins at block 402, at which a vRAN DU and the wireless measurement engine circuitry 200 of FIG. 2, which may be implemented as part of the vRAN DU, as disclosed herein are started up and/or initialized on- and/or off-premises. For example, the vRAN DU can be initialized based on an average cell density of the wireless network. Example average cell densities include 12 100 megahertz (MHz) massive multiple input, multiple output (MIMO) RUs, 54 40 MHz sector NodeBs (NBs), among others. At block 404, the vRAN DU updates (e.g., change(s) channel, bandwidth (BW) location, transmit (TX) power, receive (RX) power, reference signal (e.g., SRS) power, etc.) of the wireless network and/or one or more devices in communication with the wireless network. For example, the vRAN DU can update to a different cell density, such as increasing from a first cell density at block 402 to a second cell density greater than the first cell density. For example, the vRAN DU can update for 18 100 MHz massive MIMO RUs, 78 MHz sector NBs, among others.

In the illustrated example of FIG. 4, at block 406, the wireless measurement engine circuitry 200 determines a mode of operation (e.g., power management, location detection/identification/determination, interference mitigation, spectrum selection, lawful intercept, etc.). In the example of FIG. 4, the wireless measurement engine circuitry 200 determines that the wireless measurement engine circuitry 200 is configured to operate in an interference mitigation mode of operation for one or more cells of the wireless network and/or one or more UEs in the wireless network. At block 408, the wireless measurement engine circuitry 200 obtains multi-access (e.g., multi-spectrum) data (e.g., at least one of 5G data, Wi-Fi data, satellite data, or any other type of wireless data) and computes measurements (e.g., wireless physical layer measurements) corresponding to the mode of operation. For example, the multi-access data is associated with an operation of at least one of a wireless device associated with the wireless network or the wireless network. Additionally, at block 308, the wireless measurement engine circuitry 200 computes the measurements in substantially real time relative to the operation. Additionally, for example, the wireless measurement engine circuitry 200 computes UL PUSCH measurements/statistics because UL PUSCH measurements/statistics can indicate a level of interference corresponding to one or more cells of the wireless network and/or one or more UEs in the wireless network. At block 410, the wireless measurement engine circuitry 200 analyzes the wireless measurements and/or executes and/or instantiates the machine-learning model 266 of FIG. 2 to generate output(s) in substantially real-time relative to the operation. For example, the output(s) can be recommendations to change a network configuration, such as how the vRAN DU is to operate (e.g., cause the vRAN DU to change a channel, increase/decrease TX/RX/reference signal power, etc.) to reduce interference associated with one or more wireless devices on the network. In some examples, at block 410, the recommendations can be to change a count of MIMO resources (e.g., MIMO RUs) to reduce interference associated with one or more wireless devices on the network. At block 412, the wireless measurement engine circuitry 200 causes storage of the output(s) to an AI/ML learning datastore to improve performance of the machine-learning model 266.

In the illustrated example of FIG. 4, at block 414, the wireless measurement engine circuitry 200 analyzes the wireless measurements and/or executes and/or instantiates the machine-learning model 266 of FIG. 2 to generate output(s) in non-real time relative to the operation. For example, the output(s) can be recommendations to change a network configuration, such as how the vRAN DU is to operate (e.g., cause the vRAN DU to change a channel, increase/decrease TX/RX/reference signal power, etc.). At block 416, the wireless measurement engine circuitry 200 causes storage of the output(s) to an AI/ML learning datastore to improve performance of the machine-learning model 266. For example, the data stored in the AI/ML learning datastore can be used to train and/or retrain the machine-learning model 266.

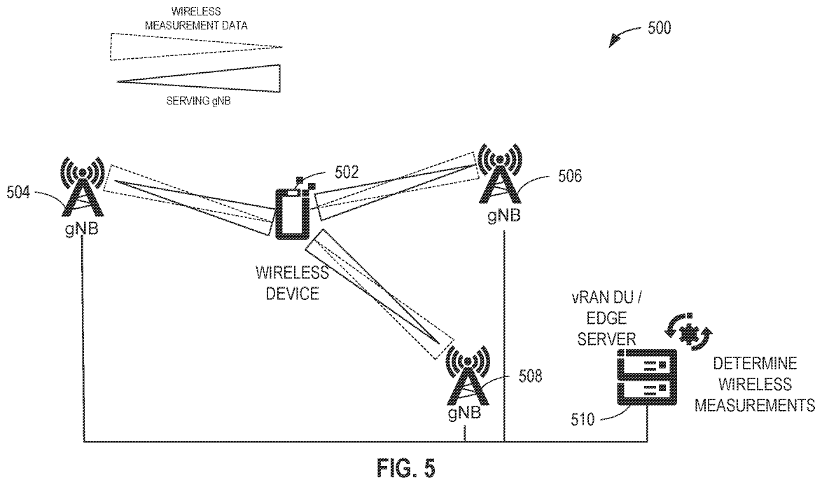

FIG. 5 is an illustration of a second example wireless communication system 500 that may be managed and/or controlled by the wireless measurement engine circuitry 200 of FIG. 2. The second example wireless communication system 500 includes an example wireless device 502 (e.g., a UE), a first example gNodeB (gNB) 504 (e.g., a 5G gNB), a second example gNB 506, a third example gNB 508, and an example server 510. In this example, the wireless device 502 is a smartphone, but may be any other type of wireless device. In this example, the gNBs 504, 506, 508 are 5G cellular base stations. Additionally or alternatively, the gNBs 504, 506, 508 may be any other type of communication interface such as a Wi-Fi access point (AP), a Bluetooth AP, satellite receiver, etc. In this example, the server 510 is a vRAN DU and/or edge server. Additionally or alternatively, the server 510 may be any other type of physical and/or virtualized server such as a server provided by and/or managed by a cloud services provider.

In example operation, the wireless device 502 transmits wireless data, such as 5G reference signal (e.g., SRS) data, Wi-Fi data packets, etc., to one(s) of the gNBs 504, 506, 508. The one(s) of the gNBs 504, 506, 508 provide, output, and/or cause transmission of the wireless data to the server 510. The server 510 can determine wireless measurements as disclosed herein in substantially real-time. The server 510 can determine to change the second wireless communication system 500 based on the wireless measurements. For example, the server 510 can instruct the wireless device 502 via one(s) of the gNBs 504, 506, 508 to increase a transmission power associated with an antenna of the wireless device 502, switch from a 5G network to a Wi-Fi network, etc., and/or any combination(s) thereof. In the example of FIG. 5, the server 510 can implement the wireless measurement engine circuitry 200 of FIG. 2.

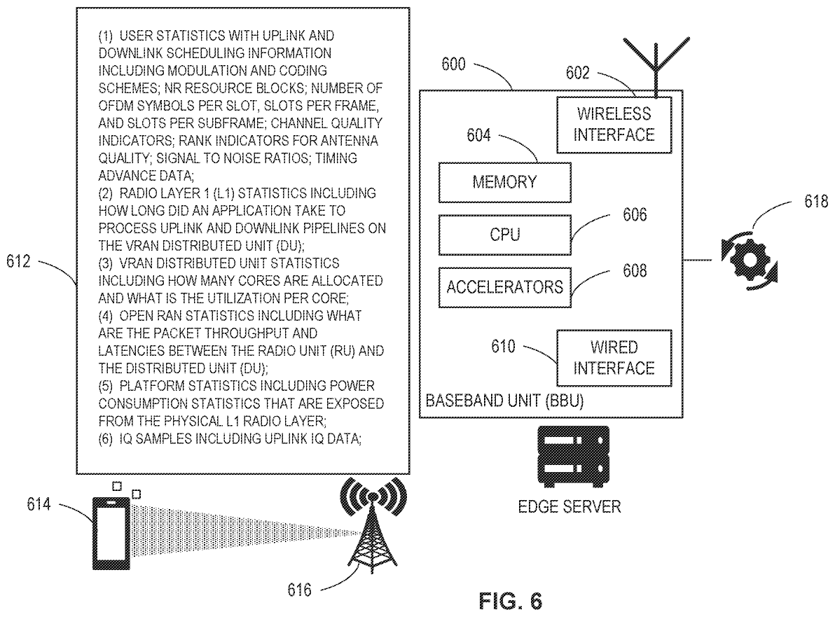

FIG. 6 is an illustration of an example server 600, which may be implemented by the wireless measurement engine circuitry 200 of FIG. 2, determining wireless measurements based on cellular data. The server 600 of the illustrated example is an edge server. Alternatively, the server 600 may be any other type of server. In the illustrated example, the server 600 implements a BBU. For example, the server 600, or portion(s) thereof, can be a BBU that includes and/or is implemented by the wireless measurement engine circuitry 200 of FIG. 2. In the example of FIG. 6, the server 600 includes an example wireless interface 602, example memory 604, an example CPU 606, example accelerators 608, and an example wired interface 610. For example, the accelerators 608 can include one or more FPGAs, one or more GPUs, one or more ASICs, one or more AI/ML hardware accelerators, etc., and/or any combination(s) thereof.

In example operation, the wireless interface 602 and/or the wired interface 610 can obtain example measurements 612 (e.g., wireless measurements, network measurements, etc.) associated with an example UE 614 or any other type of communication-enabled device via an example RU 616. For example, the measurements 612 can include user statistics with uplink and downlink scheduling information, radio layer (L1) statistics, vRAN DU statistics, O-RAN statistics (e.g., statistics based on and/or associated with the Open Radio Access Network (O-RAN) standard), platform statistics, IQ samples (e.g., quadrature samples), etc., and/or any combination(s) thereof, associated with a UE or any other type of communication-enabled device. In some examples, one(s) of the measurements 612 can be determined by the RU 616 and/or the server 600 based on wireless data, such as the wireless physical layer data 262 of FIG. 2. For example, the wireless measurement engine circuitry 200 of FIG. 2 can determine one(s) of the measurements 612 of FIG. 6 based on the wireless physical layer data 262 of FIG. 2. In the example of FIG. 6, the measurements 612 can include user statistics with uplink and downlink scheduling information, radio layer statistics (e.g., L1 statistics), vRAN distributed unit statistics, open RAN (O-RAN) statistics, platform statistics, IQ samples (e.g., quadrature samples), etc.

A possible advantage of examples disclosed herein is that the server 600 can utilize the measurements 612 to effectuate uplink and/or downlink scheduling of wireless communication. For example, the server 600 can identify an example wireless communication type selection 618 based on the measurements 612. In some examples, the server 600 can determine based on the measurements 612 that an application executed and/or instantiated by the UE 614 is to switch or transition from a first type of wireless communication (e.g., 4G LTE, 5G, Wi-Fi, etc.) to a second type of wireless communication (e.g., 4G LTE, 5G, Wi-Fi, etc.), which can have increased bandwidth (e.g., the second type of wireless communication has a first bit rate (e.g., bits per second (bps)) that is greater than a second bit rate (e.g., bps) of the first type of wireless communication). In some examples, a user associated with the UE 614, a service level agreement (SLA) and/or policy (e.g., an enterprise policy) associated with the UE 614, etc., can specify that an application executed and/or instantiated by the UE 614 is to run with reduced data usage on a wireless connection (e.g., a 4G LTE data plan, a 5G data plan, a Wi-Fi hotspot data plan, etc.). For example, the server 600 can instruct the UE 614 to switch from a first type of wireless communication to a second type of wireless communication based on the specification to run with reduced data usage, the measurements 612, etc., and/or any combination(s) thereof. For example, an application associated with the UE 614 may utilize a first amount of data (e.g., kilobytes (KB)) when utilizing the first type of wireless communication and a second amount of data (e.g., KB) when utilizing the second type of wireless communication where the second amount of data is less than the first amount of data. In some examples, a user associated with the UE 614, an SLA/policy associated with the UE 614, etc., can determine to enable the UE 614 to connect a video call on a specific cellular network (e.g., 4G LTE, 5G, etc.) instead of a different type of wireless network (e.g., Wi-Fi). For example, the server 600 can instruct the UE 614 to switch from 5G to Wi-Fi based on the measurements 612, which can include application-focused RAN statistics and/or wireless measurements.

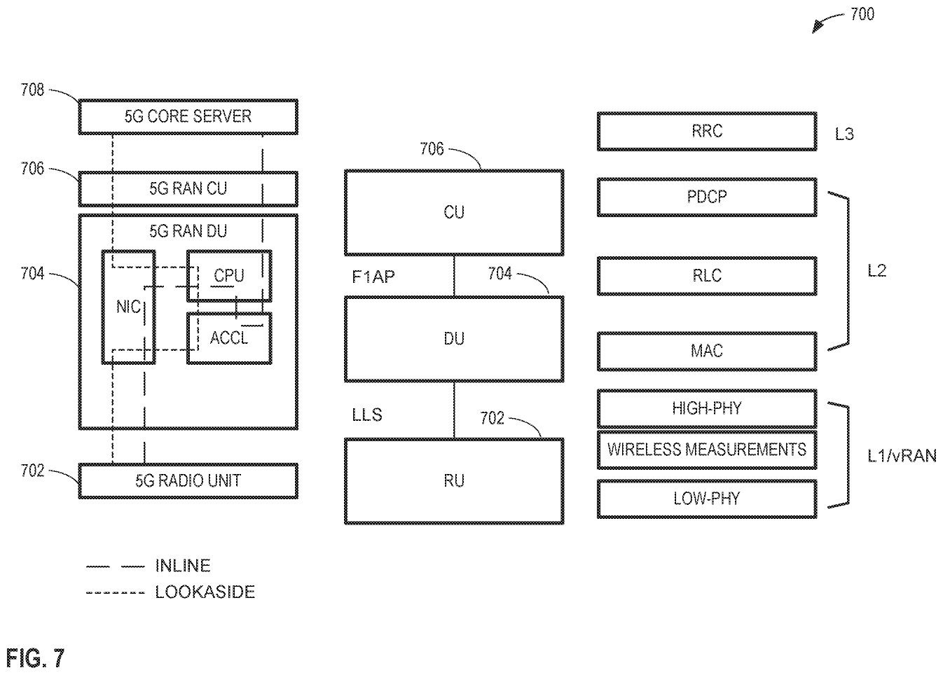

FIG. 7 is an illustration of a third example wireless communication system 700 that may be managed and/or controlled by the wireless measurement engine circuitry 200 of FIG. 2. The third wireless communication system 700 includes an example radio unit (RU) 702, an example RAN DU 704, an example RAN CU 706, and an example core server 708. In the example of FIG. 7, the RU 702 is a 5G RU, the RAN DU 704 is a 5G RAN DU, the RAN CU 706 is a 5G RAN CU, and the core server 708 is a 5G core server. In the example of FIG. 7, the RU 702 is in communication with the DU 704 via a lower layer split (LLS) protocol. Additionally, in the example of FIG. 7, the DU 704 is in communication with the CU 706 via an F1 application protocol (F1AP).

In the illustrated example of FIG. 7, the RU 702 can execute, instantiate, and/or implement L1 functions, operations, etc., such as low physical layer (LOW-PHY) functions/operations, wireless measurement functions/operations, and high physical layer (HIGH-PHY) functions/operations. For example, the RU 702 can determine the wireless physical layer measurements 264 of FIG. 2 at the L1 and/or vRAN layer of the third wireless communication system 700. In the example of FIG. 7, the DU 704 and/or the CU 706 can execute, instantiate, and/or implement L2 functions, operations, etc., such as MAC functions/operations, RLC functions/operations, and PDCP functions/operations. In the example of FIG. 7, the CU 706 can execute, instantiate, and/or implement L3 functions, operations, etc., such as RRC functions.

In the illustrated example of FIG. 7, the DU 704 includes one or more example NICs, one or more example CPUs, and one or more example accelerators. In some examples, the DU 704 implements inline acceleration. For example, when implementing inline acceleration, the one or more accelerators of the DU 704 execute and/or instantiate part or all of the L1 pipeline. As such, when implementing inline acceleration, the DU 704 can reduce the throughput between the one or more CPUs and the one or more accelerators. In some examples, the DU 704 implements look-aside acceleration. For example, when implementing look-aside acceleration, the one or more CPUs offloads one or more selected functions to the one or more accelerators. As such, the one or more CPUs are free to utilize cycles to process other tasks, while the one or more accelerators are working on the one or more selected functions to be accelerated. Once the one or more CPUs receive processed data back from the one or more accelerators, the one or more CPUs can switch back to the original processing context and continue the pipeline execution until other function(s) to be accelerated arise.

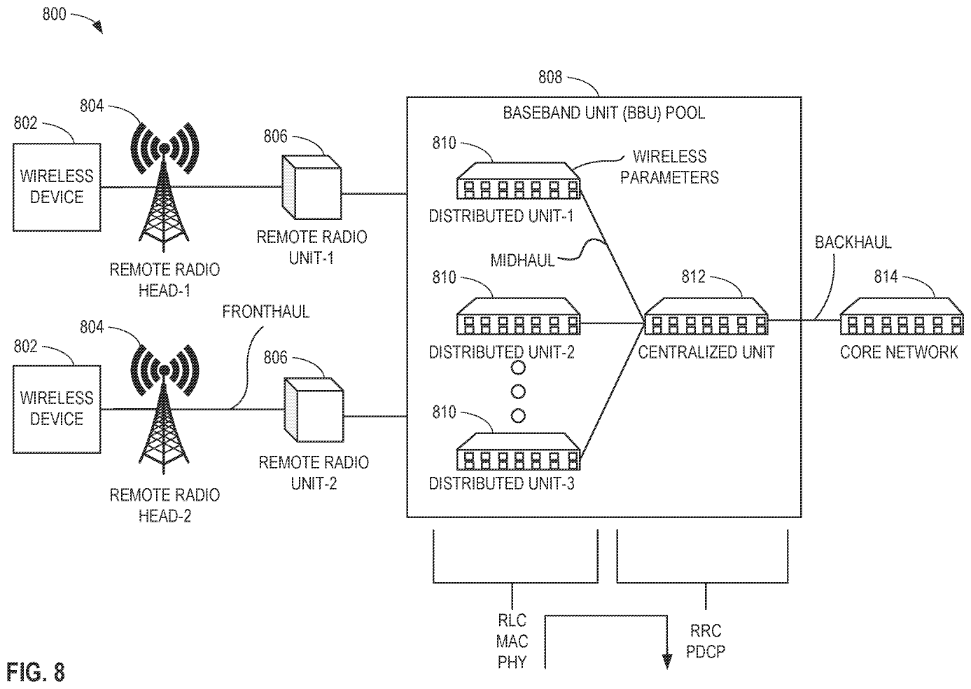

FIG. 8 is an illustration of a fourth example wireless communication system 800 that may be managed by the wireless measurement engine circuitry 200 of FIG. 2. The fourth wireless communication system 800 includes example wireless devices 802, example remote radio heads (RRHs) 804, example remote radio units (RRUs) 806, an example baseband unit (BBU) pool 808, and an example core network 814. The BBU pool 808 includes example distributed units (DUs) 810 and an example centralized unit (CU) 812. In the example of FIG. 8, the communication link(s) between the RRHs 804 and the RRUs 806 may implement a fronthaul of the fourth wireless communication system 800. In the example of FIG. 8, the communication link(s) between the DUs 810 and the CU 812 may implement a midhaul of the fourth wireless communication system 800. In the example of FIG. 8, the communication link(s) between the CU 812 and the core network 814 may implement a backhaul of the fourth wireless communication system 800. In the example of FIG. 8, the DUs 810 can execute, instantiate, and/or implement functions, operations, etc., such as PHY, MAC, and RLC functions/operations. In the example of FIG. 8, the CU 812 can execute, instantiate, and/or implement functions, operations, etc., such as RRC and PDCP functions/operations.

In example operation, the wireless devices 802 transmit and/or cause transmission of wireless data (e.g., 5G data, Wi-Fi data, satellite data, etc.) to the DUs 810 via the RRHs 804 and the RRUs 806. In example operation, the DUs 810 can determine wireless measurements based on the wireless data in substantially real-time. In example operation, the DUs 810 can determine the wireless measurements in substantially real-time for on-premises analysis, which can include AI/ML analytics and/or processing. In example operation, the DUs 810 can direct and/or instruct at least one(s) of the wireless devices 802, the RRHs 804, or the RRUs 806 to change a device and/or network configuration to improve operation of the fourth wireless communication system 800. In example operation, the core network 814 can obtain the wireless measurements in non-real time for off-premises analysis, which can include AI/ML analytics and/or processing. In example operation, the core network 814 can direct and/or instruct at least one(s) of the wireless devices 802, the RRHs 804, the RRUs 806, the DUs 810, or the CU 812 to change a device and/or network configuration to improve operation of the fourth wireless communication system 800.

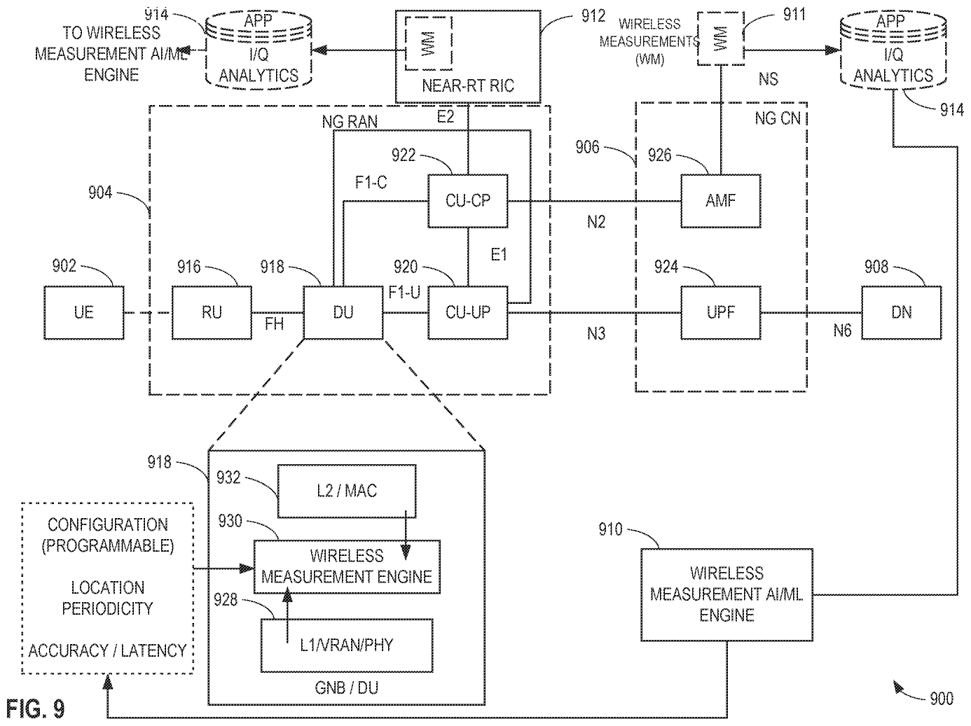

FIG. 9 is an illustration of an example wireless measurement determination architecture 900 that can be utilized to implement the wireless measurement engine circuitry 200 of FIG. 2.

The wireless measurement determination architecture 900 includes an example UE 902, an example next generation radio access network (NG RAN) 904, an example next generation core network (NG CN) 906, an example data network (DN) 908, an example wireless measurement AI/ML engine 910, an example near-real time radio access network intelligent controller (near-RT RIC) 912, and example I/Q analytics applications 914. The NG RAN 904 includes and/or implements an example RU 916, an example DU 918, an example CU-UP 920, and an example CU-CP 922. The NG CN 906 includes and/or implements an example user plane function (UPF) 924 and an example access and mobility management function (AMF) 926.

In the illustrated example of FIG. 9, the DU 918 implements a gNodeB (gNB) (e.g., a 5G gNB). In the example of FIG. 9, the DU 918 includes and/or implements an example L1 interface 928, an example wireless measurement engine 930, and an example L2 interface 932. For example, the L1 interface 928 can be implemented by a PHY (e.g., PHY hardware, PHY circuitry, etc.) that executes and/or instantiates a vRAN. In the example of FIG. 9, the wireless measurement engine 930 can be implemented by the wireless measurement engine circuitry 200 of FIG. 2. The example L2 interface 932 of FIG. 9 can be implemented by a MAC layer (e.g., MAC hardware, software, and/or firmware).

In the illustrated example of FIG. 9, the UE 902 can correspond to one of the devices 108, 110, 112, 114, 116 of FIG. 1. In some examples, the RU 916 can correspond to the first networks 118 and/or the RRUs 120 of FIG. 1. In some examples, the DU 918 can correspond to one of the DUs 122 of FIG. 1. In some examples, the CU-UP 920 can correspond to the CU-UP of FIG. 1. In some examples, the CU-CP 922 can correspond to the CU-CP of FIG. 1. In some examples, the NG CN 906 can correspond to one of the core devices 126 of FIG. 1. In some examples, the DN 908 can correspond to the core network 106 and/or the cloud network 107 of FIG. 1. In some examples, the NG RAN 904, or portion(s) thereof, can include and/or be implemented by the wireless measurement engine circuitry 200. For example, the RU 916, the DU 918, the CU-UP 920, and/or the CU-CP 922 can include and/or be implemented by the wireless measurement engine circuitry 200.

In example operation, the wireless measurement engine 930 can receive measurement requests (e.g., a request for measurements, statistics, etc., based on wireless data associated with the UE 902); configure the NG RAN 904 and the UE 902 for measurement determination; and calculate example wireless measurement 911 of the UE 902 based on UE and/or RAN measurements. In some examples, the wireless measurement engine 930 receives reference signals (e.g., SRS) measurements and/or other information from a gNB, such as a gNB implemented by the NG RAN 904, via the AMF 926. In some examples, the wireless measurement engine 930 can configure the UE 902 via the DU 918 to transmit reference signal (e.g., SRS) data based on a configuration periodicity and/or transmission comb. In some examples, the wireless measurement engine 930 calculates and/or otherwise determines the wireless measurements 911 and outputs the wireless measurements 911 to the wireless measurement AI/ML engine 910 to analyze the wireless measurements 911, trends thereof, etc., to determine insights into a wireless communication network associated with the UE 902.

In some examples, the wireless measurement engine 930 publishes the wireless measurements 911 of the UE 902 to the I/Q analytics applications 914 that can consume the wireless measurement results to effectuate compute workloads (e.g., network-related workloads, AI/ML-related workloads, etc.). A possible advantage of examples disclosed herein is that the wireless measurement engine 930 can configure a rate at which reference signal (e.g., SRS) data is obtained from the UE 902 and/or a rate at which reference signal (e.g., SRS) measurements based on the reference signal (e.g., SRS) data can be available for storage, access, and/or transmission to other hardware, software, and/or firmware. For example, the wireless measurement AI/ML engine 910 can output a recommendation to change a configuration, a location periodicity, an accuracy and/or latency, etc., and instruct the wireless measurement engine 930 to effectuate the change (e.g., configure the UE 902 to transmit data from the UE 902 to the L1 interface 928 at a specified rate and/or using a specified configuration).

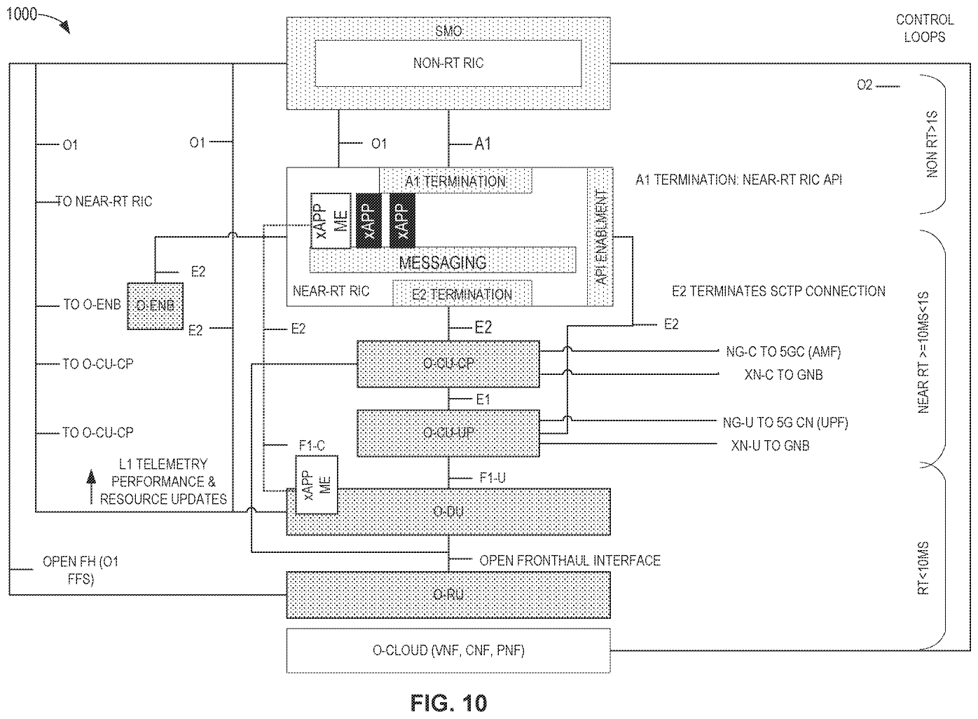

FIG. 10 is an illustration of a second example wireless measurement determination architecture 1000 that can be utilized to implement the wireless measurement engine circuitry 200 of FIG. 2. The second wireless measurement determination architecture 1000 of the illustrated example is based on at least one of the 3GPP standard or the O-RAN standard (e.g., an RU based on the O-RAN protocol is an O-RU, a DU based on the O-RAN protocol is a O-DU, etc.). In the illustrated example of FIG. 10, a measurement engine (ME) xAPP is an application configured and/or otherwise adapted to run on a near-RT RIC that identifies data to consume via a wireless measurement engine and provide wireless measurement results. In some examples, the ME xAPP can be independent of the near-RT RIC. In the illustrated example of FIG. 10, the ME xAPP can retrieve and/or otherwise access data from an instance of the wireless measurement engine of the O-RU, the O-DU, the O-CU, etc. via an example E2 interface.

In the illustrated example of FIG. 10, the near-RT RIC can be the logical node that enables near-RT control and/or optimization of RAN elements and resources via fine-grained data collection via the wireless measurement engine and action over the E2 interface. In the illustrated example of FIG. 10, interfaces can be specified by the 3GPP standard (e.g., F1-c, F1-u, and E1 interfaces). In the illustrated example of FIG. 10, interfaces can be specified by the O-RAN standard (e.g., A1, E2, O1, Open Fronthaul Interface, etc.). In the illustrated example of FIG. 10, 01 and Open-Fronthaul (FH) interfaces FCAPS (Fault, Configuration, Accounting, Performance, Security) interface with configuration, reconfiguration, registration, security, performance, monitoring aspects exchange with individual nodes (e.g., O-CU-UP, O-CU-CP, O-DU, O-RU, as well as near-RT RIC).

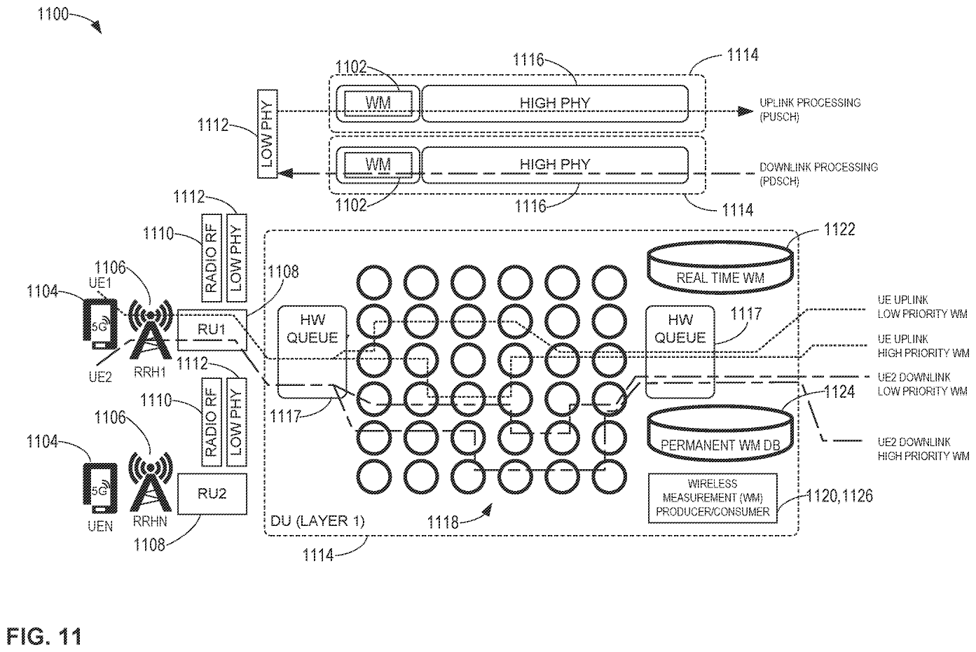

FIG. 11 is an illustration of an example workflow 1100, which can be utilized by the wireless measurement engine circuitry 200 of FIG. 2, to determine example wireless measurements 1102 (identified by WM). The example workflow 1100 of FIG. 11 may be implemented by the wireless measurement engine circuitry 200 of FIG. 2. In the example workflow 1100, example wireless devices 1104, such as UEs (identified by UE1, UE2, UEN) transmit and/or cause transmission of wireless data, such as Wi-Fi data, reference signal (e.g., SRS) data, etc., to example RRHs 1106 (identified by RRH1, RRHN). In the example workflow 1100, the RRHs 1106 output the wireless data to example radio units 1108 (identified by RU1, RU2) via example radio RF circuitry 1110 and example low physical layer (PHY) circuitry 1112.

In the example workflow 1100 of FIG. 11, the radio RF circuitry 1110 and/or the low PHY circuitry 1112 output the received wireless data to an example DU 1114. In the example of FIG. 1, the DU 1114 includes and/or implements example high PHY circuitry 1116. For example, the DU 1114 can determine the wireless measurements 1102 based on the received wireless data, and output the wireless measurements 1102 via the high PHY circuitry 1116 for uplink processing (e.g., PUSCH). In some examples, the DU 1114 receives data from a different logical entity for downlink processing (e.g., physical downlink shared channel (PDSCH)).

In the example workflow 1100 of FIG. 11, the DU 1114 determines the WMs 1102 using either hardware alone, or via a combination of hardware, software, and/or firmware. For example, the DU 1114 can provide a data pointer that references wireless data from the wireless devices 1104 that is stored in memory, mass storage, etc. In the example workflow 1100, the DU 1114 can provide the data pointer to an example hardware queue 1117, which can be implemented by a dynamic load balancer as disclosed herein. In the example workflow 1100, the hardware queue 1117 can enqueue the data pointer to first one(s) of example compute cores 1118, which can implement example wireless measurement producers 1120 (e.g., wireless measurement producer cores) because the first one(s) of example compute cores 1118 can generate and/or produce the wireless measurements 1102. In some examples, the first one(s) of the compute cores 1118 can store the wireless measurements 1102 in example real time wireless measurement memory and/or storage 1122. In some examples, the first one(s) of the compute cores 1118 can store the wireless measurements 1102 in example permanent wireless measurement memory and/or storage 1124.

In the example workflow 1100 of FIG. 11, after determining the wireless measurements 1102, the first one(s) of the compute cores 1118 of the DU 1114 can provide an indication of the completion of the wireless measurement workloads to the hardware queue 1117. In the example workflow 1100, after receiving the completion indication, the hardware queue 1117 can dequeue the data pointer that references the wireless measurements 1102 to second one(s) of the compute cores 1118, which can implement example wireless measurement consumers 1126 (e.g., wireless measurement consumer cores) because the second one(s) of the compute cores 1118 can consume and/or utilize the wireless measurements 1102 for subsequent processing, functions, operations, etc. For example, the second one(s) of the compute cores 1118 can output the wireless measurements 1102 for uplink processing (e.g., low priority uplink processing, high priority uplink processing, etc.). In the example workflow 1100, the above operations can occur in reverse, such as processing downlink processing via the hardware queue 1117 and the wireless measurement producer/consumer cores 1120, 1126.

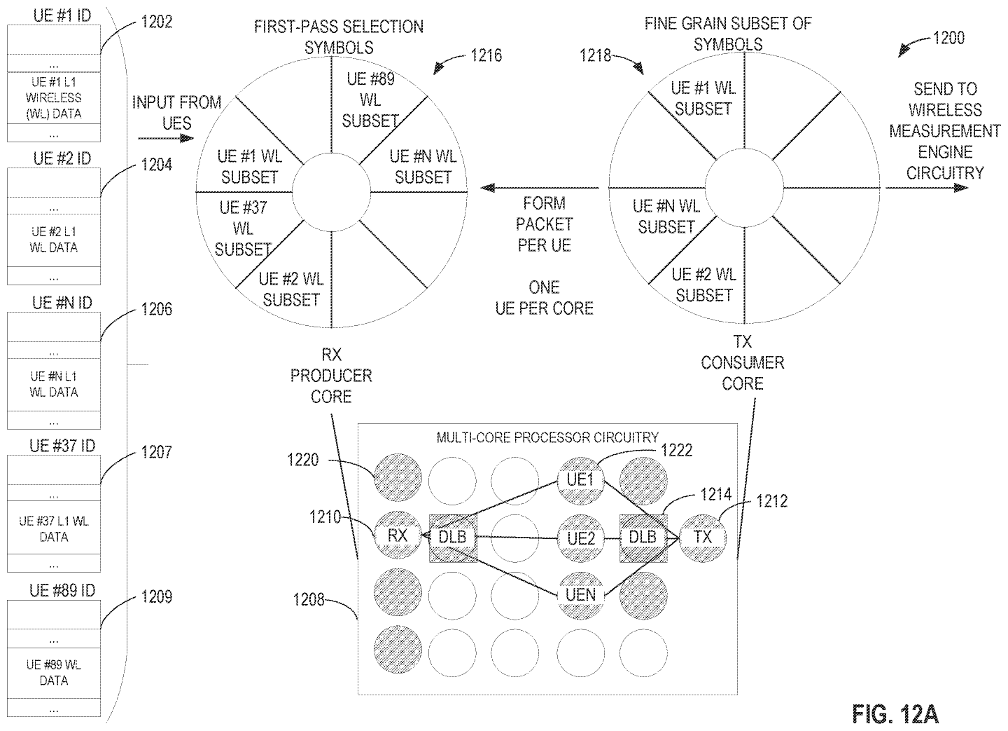

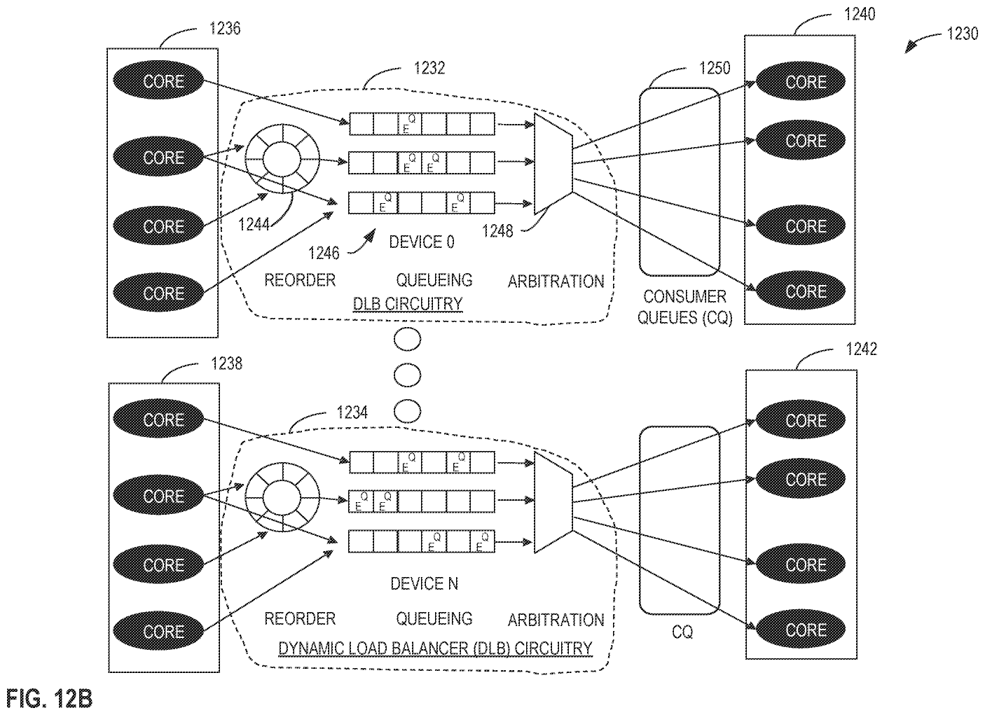

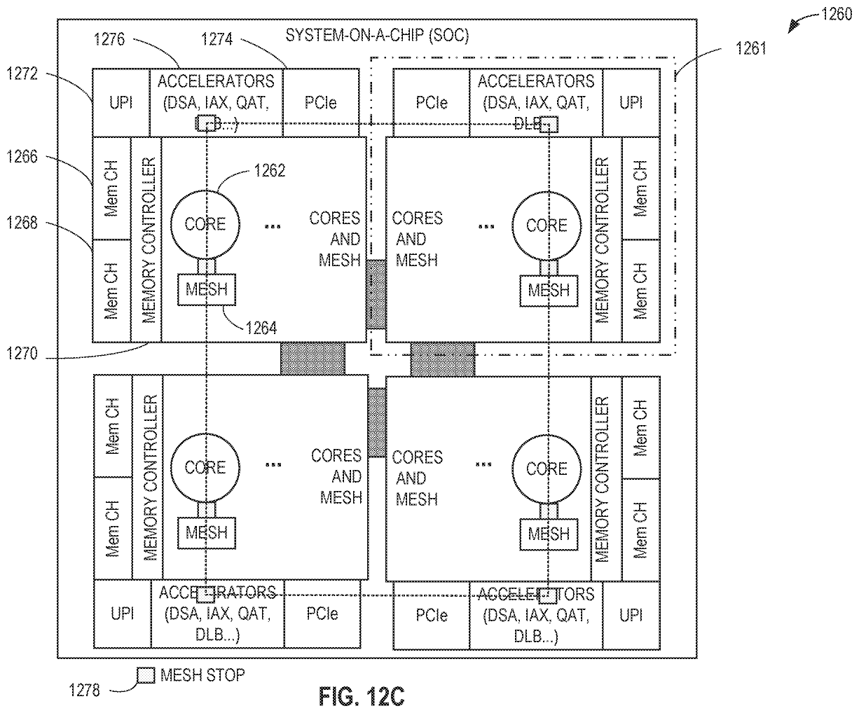

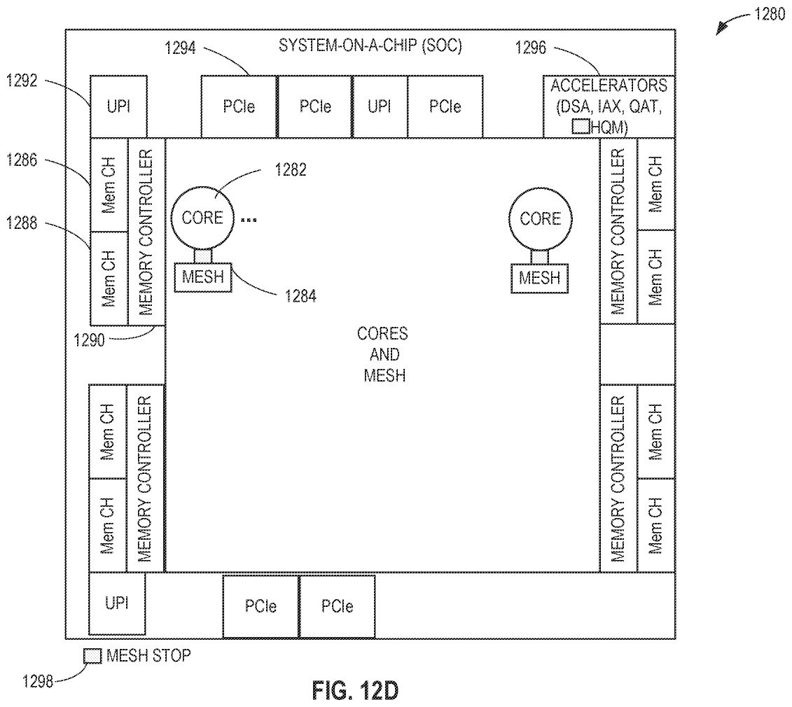

FIG. 12A is a block diagram of an example data management workflow 1200, which can be utilized by the wireless measurement engine circuitry 200 of FIG. 2, to determine wireless measurements associated with wireless device(s) in a wireless communication environment. The data management workflow 1200 includes example UE data 1202, 1204, 1206, 1207, 1209 and example multi-core processor circuitry 1208. The UE data 1202, 1204, 1206, 1207, 1209 includes first example UE data 1202 generated by a first UE having a first UE identifier (identified by UE #1 ID), second example UE data 1204 generated by a second UE having a second UE identifier (identified by UE #2 ID), third example UE data 1206 generated by a third UE having a third UE identifier (identified by UE #N ID), fourth example UE data 1207 generated by a fourth UE having a fourth UE identifier (identified by UE #37 ID), and fifth example UE data 1209 generated by a fifth UE having a fifth UE identifier (identified by UE #89 ID). For example, the UE data 1202, 1204, 1206, 1207, 1209 can include L1 wireless data such as L1 SRS data, L1 Wi-Fi data, etc.

In some examples, the multi-core processor circuitry 1208 can be implemented by a CPU, a DSP, a GPU, an FPGA, an Infrastructure Processing Unit (IPU), network interface circuitry (NIC) (e.g., a smart NIC), an XPU, etc., or any other type of processor circuitry. In the example of FIG. 12A, the multi-core processor circuitry 1208 includes a plurality of example cores 1210, 1212, which include an example receiver or receive (RX) core 1210 and an example transmitter or transmit (TX) core 1212. Additionally, the example multi-core processor circuitry 1208 includes example DLB circuitry 1214. For example, in the data management workflow 1200, the DLB circuitry 1214 can dynamically balance workload(s) across one(s) of one or more second example cores 1222. In some examples, one or more instances of the DLB circuitry 1214 can be included in respective ones of the cores 1210, 1212. For example, a core of the multi-core processor circuitry 1208 can include one or more instances of the DLB circuitry 1214 in an uncore region associated with the core. An example uncore region refers to a region of processor circuitry that is not in a core of the processor circuitry but closely connected to a core of the processor circuitry.

In some examples, the RX core 1210 can implement a first example ring buffer 1216. In some examples, the TX core 1212 can implement a second example ring buffer 1218. In the example data management workflow 1200, one or more first example cores 1220, which include the RX core 1210, can receive the UE data 1202, 1204, 1206, 1207, 1209 from UEs. In some examples, the UE data 1202, 1204, 1206, 1207, 1209 can be cleartext, ciphertext, etc. In some examples, the UE data 1202, 1204, 1206, 1207, 1209 can be transmitted in 512-byte packets. Alternatively, the UE data 1202, 1204, 1206, 1207, 1209 may be transmitted in any other byte sized packets and/or data format. In the example data management workflow 1200, the one or more first cores 1220 can extract data of interest (e.g., extract subset(s) or portion(s) of the data) from the UE data 1202, 1204, 1206, 1207, 1209, such as the L1 reference signal (e.g., SRS) data, the L1 Wi-Fi data, etc. In some examples, the one or more first cores 1220 can store the extracted data in the first ring buffer 1216. For example, the one or more first cores 1220 can extract L1 wireless data from the first UE data 1202 and add and/or insert the extracted L1 wireless data into the first ring buffer 1216. A possible advantage of examples disclosed herein the RX core 1210 can extract subset(s) of incoming data based on a UE identifier.

In the example data management workflow 1200, the one or more first cores 1220 can generate queue events corresponding to respective ones of the UE data 1202, 1204, 1206, 1207, 1209. For example, the one or more first cores 1220 can generate a first queue event including the first UE identifier, a second queue event including the second UE identifier, and a third queue event including the third UE identifier. In some examples, the queue events can be implemented by an array of data. Alternatively, the queue events may be implemented by any other data structure. In some examples, the queue events can include data pointers that reference respective locations in memory at which the UE data 1202, 1204, 1206, 1207, 1209 is stored. For example, the first queue event can include a first data pointer that corresponds to a memory address, a range of memory addresses, etc., at which the first UE data 1202, or portion(s) thereof, are stored. In the example data management workflow 1200, the one or more first cores 1220 can enqueue the first through third queue events into the DLB circuitry 1214. For example, the one or more first cores 1220 can enqueue the first through third queue events into hardware-managed queues (e.g., portion(s) of memory). In some examples, the DLB circuitry 1214 can select one of the identifiers to process based on a priority value, which may be included in the queue events.

In the example data management workflow 1200, the DLB circuitry 1214 can dequeue the first through third queue events to one or more of the second cores 1222 (cores identified by UE1, UE2, UEN), which can implement worker cores. In the example data management workflow 1200, the one or more second cores 1222 can execute computational task(s), operation(s), etc., on the UE data 1202, 1204, 1206, 1207, 1209 associated with the respective dequeued queue events. For example, the one or more second cores 1222 can execute a cryptographic, encryption, etc., task (e.g., an IP security (IPSec) task) on the UE data 1202, 1204, 1206, 1207, 1209. In response to completing the task(s), the one or more second cores 1222 can enqueue the queue events back to the DLB circuitry 1214. For example, the DLB circuitry 1214 can reorder and/or otherwise re-assemble the UE data 1202, 1204, 1206, 1207, 1209 (e.g., data packets that include and/or otherwise implement the UE data 1202, 1204, 1206, 1207, 1209). In the example data management workflow 1200, the DLB circuitry 1214 can dequeue the queue events to the TX core 1212, which can cause the TX core 1212 to transmit the reordered and/or reassembled data packets (e.g., encrypted data packets) to different hardware, software, and/or firmware. In some examples, the TX core 1212 can provide the data packets to the second ring buffer 1218. In some examples, the data included in the second ring buffer 1218 can include less data than data originally inserted in the first ring buffer 1216. For example, UE #1 L1 wireless (WL) data in the first ring buffer 1216 can include a first quantity of L1 wireless data (e.g., a first number of measurements, a first number of bits, etc.) and UE #1 WL subset in the second ring buffer 1218 can include a second quantity of L1 wireless data less than the first quantity.

In some examples, the TX core 1212 can transmit the data packets from the second ring buffer 1218 to the wireless measurement engine circuitry 200 of FIG. 2. For example, the wireless measurement engine circuitry 200 of FIG. 2, which may be implemented by one or more cores of the multi-core processor circuitry 1208, can execute the ML model 266 of FIG. 2 utilizing the data packets as ML input(s) to generate ML output(s), which can include wireless measurements, network configuration change recommendation(s), UE network configuration change recommendation(s), etc., associated with the UEs that generated the UE data 1202, 1204, 1206, 1207, 1209. In some examples, the TX core 1212 can provide the data packets from the second ring buffer 1218 to the first ring buffer 1216. For example, the data packets can be provided from the first ring buffer 1216 to the UEs that generated the UE data 1202, 1204, 1206, 1207, 1209.

In the example data management workflow 1200, the multi-core processor circuitry 1208 can obtain first wireless data from a first antenna of a base station and second wireless data from a second antenna of the base station. For example, the first wireless data can be first UE #1 L1 wireless data received at a first antenna of a base station from a UE and the second wireless data can be second UE #1 L1 wireless data received at a second antenna of the same base station.

In the example data management workflow 1200, the multi-core processor circuitry 1208 can store the first wireless data (e.g., first cellular data) in a first linked list, such as a first portion identified by UE #1 WL Subset in the first ring buffer 1216, which can be stored in memory associated with the multi-core processor circuitry 1208. In the example data management workflow 1200, the multi-core processor circuitry 1208 can store the second wireless data (e.g., second cellular data) in a second linked list, such as a second portion of the first ring buffer 1216 (e.g., the first ring buffer 1216 can include multiple slices with each slice corresponding to L1 wireless data from the UE). In some examples, the first linked list is associated with the first antenna and the second linked list is associated with the second antenna.

In the example data management workflow 1200, the wireless measurement engine circuitry 200 (e.g., one or more cores of the multi-core processor circuitry 1208) can determine a wireless measurement of the UE based on at least one of the first wireless data (e.g., first cellular data) or the second wireless data (e.g., second cellular data). For example, the RX core 1210 can enqueue a first data pointer that references UE #1 L1 WL data stored in memory in the first linked list, which can be included in and/or implemented by the DLB circuitry 1214. In the example data management workflow 1200, the DLB circuitry 1214 can dequeue the first data pointer to the one or more second cores 1222. The one or more second cores 1222 can determine wireless measurements based on the UE #1 L1 WL data. In the example data management workflow 1200, after the determination(s), the one or more second cores 1222 can provide the first data pointer back to the DLB circuitry 1214. For example, the first data pointer can reference the wireless measurements stored in memory associated with the multi-core processor circuitry 1208. Additionally or alternatively, the one or more second cores 1222 can provide a second data pointer to the DLB circuitry 1214. For example, the second data pointer can reference the wireless measurements stored in memory associated with the multi-core processor circuitry 1208. In some examples, the DLB circuitry 1214 can store the first data pointer and/or the second data pointer in a third linked list, such as a slice of the second ring buffer 1218 identified by UE #1 WL Subset. In some examples, the wireless measurement engine circuitry 200 (e.g., one or more cores of the multi-core processor circuitry 1208) can access the wireless measurements based on the first data pointer (e.g., accessing memory location(s) identified by the first data pointer) and/or the second data pointer (e.g., accessing memory location(s) identified by the second data pointer). In some examples, the wireless measurement engine circuitry 200 can determine a recommendation to change a network configuration of a network associated with the UE based on the wireless measurements.

In some examples, the multi-core processor circuitry 1208 and/or the wireless measurement engine circuitry 200 can obtain at least one of the first wireless data or the second wireless data based on Intel® FLEXRAN™ Reference Architecture. In some examples, the multi-core processor circuitry 1208 and/or the wireless measurement engine circuitry 200 can store the at least one of the first wireless data or the second wireless data based on Intel® FLEXRAN™ Reference Architecture. In some examples, the multi-core processor circuitry 1208 and/or the wireless measurement engine circuitry 200 can determine the wireless measurements based on Intel® FLEXRAN™ Reference Architecture.

In some examples, the multi-core processor circuitry 1208 can aggregate a plurality of wireless data sets associated with a UE using a linked list. For example, the first ring buffer 1216 and/or the second ring buffer 1218 can include multiple slices, each of which can be associated with the same UE. For example, the first ring buffer 1216 can include multiple UE #1 WL Subset slices, where a first slice (e.g., a first data slice, a first portion, a first data portion, a first data buffer portion, etc.) can be first wireless data received by a first antenna of a first base station, a second slice can be second wireless data received by a second antenna of the first base station or a different base station, etc. In some examples, the multi-core processor circuitry 1208 can identify respective priorities of portions of the plurality of wireless data sets with a linked list associated with a UE. For example, each slice of the first ring buffer 1216 and/or the second ring buffer 1218 can have a different data or data handling priority, processing priority, etc.

In some examples, the multi-core processor circuitry 1208 can format the portions of the plurality of wireless data sets from a first data format to a second data format with a linked list. For example, cellular data stored in the first ring buffer 1216 can have a first data format and cellular data stored in the second ring buffer 1218 can have a second data format different from the first data format. In some examples, the second data format is based on a type of wireless measurement engine utilized to determine wireless measurements. In some examples, wireless data can be converted from the first data format into the second data format when moved from the first ring buffer 1216 to the second ring buffer 1218. In some examples, wireless data can be converted from the second data format into the first data format when moved from the second ring buffer 1218 to the first ring buffer 1216.

In some examples, the multi-core processor circuitry 1208 can generate a wireless measurement engine packet based on the portions of the plurality of wireless data sets in the second data format, and the wireless measurements associated with the UE can be based on the wireless measurement engine packet. For example, the wireless measurement engine circuitry 200 can obtain wireless data from the second ring buffer 1218 in the second data format, generate a wireless measurement engine packet including the wireless data in the second data format, and determine a wireless measurement associated with the UE based on the wireless measurement engine packet. In some examples, the wireless measurement engine packet can be a data packet that can be transmitted to an electronic device, a UE, etc. In some examples, the wireless measurement engine packet can be consumed by an application and/or a service. For example, the wireless measurement engine circuitry 200 can generate a graphical user interface (GUI) after a consumption (e.g., execution of an application and/or a service based on data included in the measurement engine packet) of the wireless measurement engine packet.

FIG. 12B is an example workflow 1230 to enqueue and/or dequeue data using the dynamic load balancers of FIG. 12A. The workflow 1230 of the illustrated example of FIG. 12B includes first example DLB circuitry 1232 and second example DLB circuitry 1234. In some examples, the first DLB circuitry 1232 and/or the second DLB circuitry 1234 can implement the DLB circuitry 1214 of FIG. 12A. In some examples, the first DLB circuitry 1232 and/or the second DLB circuitry 1234 can implement the parser circuitry 220 of FIG. 2, or portion(s) thereof. In some examples, the first DLB circuitry 1232 and/or the second DLB circuitry 1234 can implement the first ring buffer 1216 and/or the second ring buffer 1218 of FIG. 12A.

In the illustrated example of FIG. 12B, the workflow 1230 includes first example producer cores 1236 and second example producer cores 1238 that are in communication with a respective one of the DLB circuitry 1232, 1234. The example first producer cores 1236 and/or the example second producer cores 1238 can be cores of multi-core processor circuitry as disclosed herein, such as the one or more first cores 1220 and/or the RX core 1210 of the multi-core processor circuitry 1208 of FIG. 12A. In the example of FIG. 12B, first example consumer cores 1240 and second example consumer cores 1242 are in communication with a respective one of the DLB circuitry 1232, 1234. The example first consumer cores 1240 and/or the example second consumer cores 1242 can be cores of multi-core processor circuitry as disclosed herein, such as the one or more second cores 1222 of the multi-core processor circuitry 1208 of FIG. 12A.

In some examples, fewer or more than instances of the DLB circuitry 1232, 1234 and/or fewer or more than the producer cores 1236, 1238 and/or consumer cores 1240, 1242 depicted in the illustrated example may be used. In the example of FIG. 12B, there is no cross-device arbitration (e.g., DEVICE 0 does not arbitrate for DEVICE N), however, in other examples, there may be cross-device arbitration. In some examples, the DLB circuitry 1232, 1234 correspond to a hardware-managed system of queues (e.g., hardware-implemented queues, hardware-implemented data queues, etc.) and arbiters (e.g., hardware-implemented arbiters) that link the producer cores 1236, 1238 and the consumer cores 1240, 1242. In some examples, one or both of the DLB circuitry 1232, 1234 can be a PCI or PCI-E device in processor circuitry. For example, one or both of the DLB circuitry 1232, 1234 can be an accelerator (e.g., a hardware accelerator) included either in processor circuitry or in communication with the processor circuitry.

In the example of FIG. 12B, the DLB circuitry 1232, 1234 includes example reorder logic circuitry 1244, example queueing logic circuitry 1246, and example arbitration logic circuitry 1248. In this example, the reorder logic circuitry 1244, the queueing logic circuitry 1246, and/or the arbitration logic circuitry 1248 can be implemented by hardware. In some examples, the reorder logic circuitry 1244, the queueing logic circuitry 1246, and/or the arbitration logic circuitry 1248 can be implemented by hardware, software, firmware and/or any combination of hardware, software, and/or firmware. In some examples, the reorder logic circuitry 1244, the queueing logic circuitry 1246, and/or the arbitration logic circuitry 1248 can implement the first ring buffer 1216 of FIG. 12A. In some examples, the reorder logic circuitry 1244, the queueing logic circuitry 1246, and/or the arbitration logic circuitry 1248 can implement the second ring buffer 1218 of FIG. 12A.

In the example workflow 1230, the reorder logic circuitry 1244 can obtain data from one or more of the producer cores 1236, 1238 and facilitate reordering operations. For example, the reorder logic circuitry 1244 can inspect a data pointer from one of the producer cores 1236, 1238. In some examples, the data pointer can be associated with wireless data, or portion(s) thereof. For example, the data pointer can reference a UE identifier, such as UE #1 of FIG. 12A, and/or, more generally, wireless data associated with the UE identifier. In some examples, the reorder logic circuitry 1244 can determine that the data pointer is associated with a known data sequence. In some examples, the producer cores 1236, 1238 can enqueue the data pointer with the queueing logic circuitry 1246 because the data pointer is not associated with a known data flow and may not need to be reordered and/or otherwise processed by the reorder logic circuitry 1244.

In some examples, the reorder logic circuitry 1244 stores the data pointer and other data pointers associated with data packets in the known data flow in a buffer (e.g., a ring buffer, a first-in first-out (FIFO) buffer, etc.) until a portion of or an entirety of the data pointers in connection with the known data flow are obtained and/or otherwise identified. In the example of FIG. 12B, the reorder logic circuitry 1244 can transmit the data pointers to one or more of the queues maintained by the queueing logic circuitry 1246 to maintain an order of the known data sequence. For example, the queues can store the data pointers as queue elements (QEs).

In the illustrated example of FIG. 12B, the queueing logic circuitry 1246 implements a plurality of queues (e.g., hardware-implemented queues, hardware-implemented data queues, etc.) or buffers (e.g., hardware-implemented buffers, hardware-implemented data buffers, etc.) to store data pointers or other information. In some examples, the queueing logic circuitry 1246 transmits data pointers in response to filling an entirety of the queue(s). In some examples, the queueing logic circuitry 1246 transmits data pointers from one or more of the queues to the arbitration logic circuitry 1248 on an asynchronous or synchronous basis.

In some examples, the arbitration logic circuitry 1248 can be configured and/or instantiated to perform arbitration by selecting a given one of the consumer cores 1240, 1242. For example, the arbitration logic circuitry 1248 can implement one or more arbiters, sets of arbitration logic circuitry (e.g., first arbitration logic circuitry, second arbitration logic circuitry, etc.), etc., where each of the one or more arbiters, each of the sets of arbitration logic circuitry, etc., can correspond to a respective one of the consumer cores 1240, 1242. In some examples, the arbitration logic circuitry 1248 is based on consumer readiness (e.g., a consumer core having space available for an execution or completion of a task), task availability, etc. In the example workflow 1230, the arbitration logic circuitry 1248 transmits and/or otherwise facilitates a passage of data pointers from the queueing logic circuitry 1246 to example consumer queues 1250.

In the example workflow 1230, the consumer cores 1240, 1242 are in communication with the consumer queues 1250 to obtain data pointers for subsequent processing. In some examples, a length (e.g., a data length) of one or more of the consumer queues 1250 are programmable and/or otherwise configurable. In some examples, the DLB circuitry 1232, 1234 generate an interrupt (e.g., a hardware interrupt) to one(s) of the consumer cores 1240, 1242 in response to a status, a change in status, etc., of the consumer queues 1250. Responsive to the interrupt, the one(s) of the consumer cores 1240, 1242 can retrieve the data pointer(s) from the consumer queues 1250.

In the illustrated example of FIG. 12B, the DLB circuitry 1232, 1234 can check a status (e.g., full, not full, not empty, etc.) of the consumer queues 1250. In some examples, the DLB circuitry 1232, 1234 can track fullness of the consumer queues 1250 by observing enqueues on an associated producer port (e.g., a hardware port) of the DLB circuitry 1232, 1234. For example, in response to each enqueueing, the DLB circuitry 1232, 1234 can determine that a corresponding one of the consumer cores 1240, 1242 has completed work on a QE and, thus, a location of the QE is now available in the queues maintained by the queueing logic circuitry 1246. For example, a format of the QE can include a bit (e.g., a data bit) that is indicative whether a consumer queue token, which can represent a location of the QE in the consumer queues 1250, is being returned. In some examples, new enqueues that are not completions of prior dequeues do not return consumer queue tokens because there is no associated entry in the consumer queues 1250.

FIG. 12C depicts an example implementation of the DLB circuitry 1214 of FIG. 12A and/or the DLB circuitry 1232, 1234 of FIG. 12B. The illustrated example of FIG. 12C depicts a first example system-on-a-chip (SoC) 1260. For example, the first SoC 1260 can be processor circuitry implemented by a semiconductor package including a plurality of example semiconductor tiles (or dies) 1261. In some examples, the first SoC 1260 can implement the DLB circuitry 1214 of FIG. 12A, the first DLB circuitry 1232 of FIG. 12B, and/or the second DLB circuitry 1234 of FIG. 12B. The first SoC 1260 includes a plurality of example cores 1262, example mesh circuitry 1264 (e.g., mesh fabric circuitry), example memory channels 1266, 1268, example memory controllers 1270, Ultra Path Interconnects (UPIs) 1272, example PCIe interconnects 1274, example accelerators 1276, and example mesh stops 1278.

In the illustrated example of FIG. 12C, the accelerators 1276 can be implemented by one or more Data Streaming Accelerators (DSAs) (e.g., one or more DSAs provided by Intel®), one or more Analytics Accelerators (e.g., one or more Intel Analytics Accelerators (IAX) provided by Intel®), one or more QuickAssist Technology (QAT) accelerators (e.g., one or more QAT accelerators provided by Intel®), and/or one or more instances of DLB circuitry as disclosed herein, etc. In some examples, the accelerators 1276 can be implemented by the DLB circuitry 1214 of FIG. 12A, the first DLB circuitry 1232 of FIG. 12B, and/or the second DLB circuitry 1234 of FIG. 12B. For example, the DLB circuitry of the accelerators 1276 can implement uncore accelerators because the DLB circuitry is in an uncore region of the first SoC 1260. A possible advantage of examples disclosed herein is that in some examples, the cores 1262 can offload scheduling tasks to the DLB circuitry of the accelerators 1276 to increase the availability of the cores 1262 for other high value added application workload processing, such as AI/ML application workload processing.

FIG. 12D depicts another example implementation of the DLB circuitry 1214 of FIG. 12A and/or the DLB circuitry 1232, 1234 of FIG. 12B. The illustrated example of FIG. 12D depicts a second example SoC 1280. For example, the second SoC 1280 can be processor circuitry implemented by a semiconductor package, which may be implemented as a single semiconductor tile or die. Alternatively, the second SoC 1280 may be implemented by more than one tile or die. In some examples, the second SoC 1280 can implement the DLB circuitry 1214 of FIG. 12A, the first DLB circuitry 1232 of FIG. 12B, and/or the second DLB circuitry 1234 of FIG. 12B. The example second SoC 1280 of FIG. 12D includes a plurality of example cores 1282, example mesh circuitry 1284 (e.g., mesh fabric circuitry), example memory channels 1286, 1288, example memory controllers 1290, example UPIs 1292, example PCIe interconnects 1294, example accelerators 1296, and example mesh stops 1298.

In the illustrated example of FIG. 12D, the accelerators 1296 can be implemented by one or more DSAs (e.g., one or more DSAs provided by Intel®), one or more Analytics Accelerators (e.g., one or more IAX provided by Intel®), one or more QAT accelerators (e.g., one or more QAT accelerators provided by Intel®), and/or one or more instances of DLB circuitry as disclosed herein. The cores 1282 of the example of FIG. 12D share the same one(s) of the accelerators 1296 while one or more of the cores 1262 of FIG. 12C access their own respective accelerators 1276. In some examples, the accelerators 1296 can be implemented by the DLB circuitry 1214 of FIG. 12A, the first DLB circuitry 1232 of FIG. 12B, and/or the second DLB circuitry 1234 of FIG. 12B. In the example of FIG. 12D, the DLB circuitry of the accelerators 1296 can implement uncore accelerators because the DLB circuitry is in an uncore region of the second SoC 1280. A possible advantage of examples disclosed herein is that, in some examples, the cores 1282, can offload scheduling tasks to the DLB circuitry of the accelerators 1296 to increase the availability of the cores 1282 for other high value added application workload processing, such as AI/ML application workload processing.

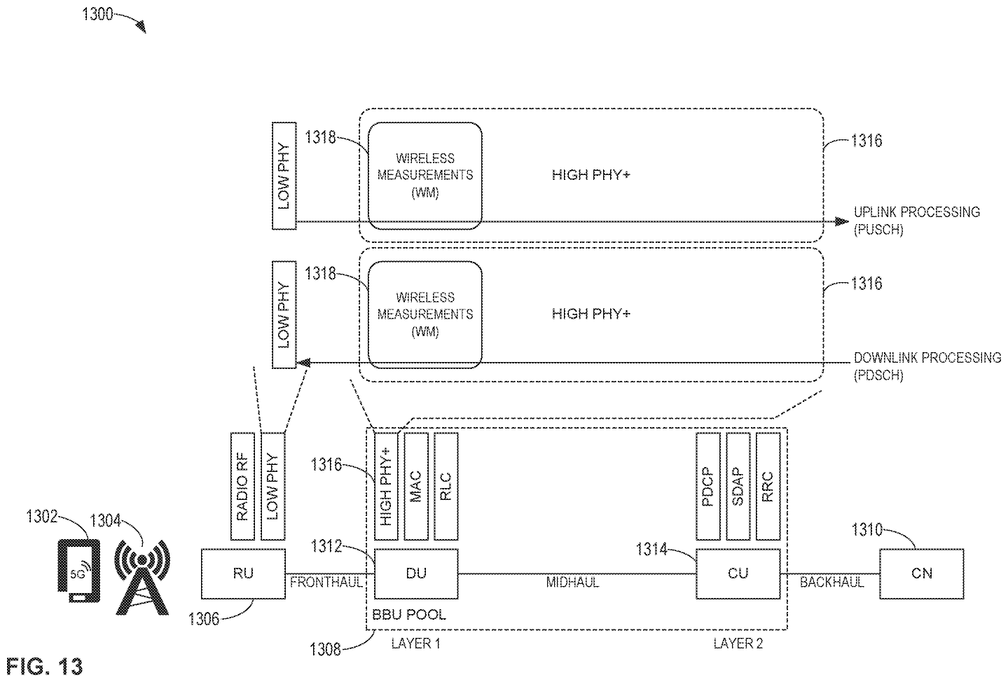

FIG. 13 is a first illustration of example wireless communication layers 1300 that may be utilized to generate wireless measurements associated with an example wireless device 1302.

For example, the wireless device 1302 may communicate with an example RRH 1304, an example RU 1306, an example BBU pool 1308, and an example core network 1310. In the example of FIG. 13, the BBU pool 1308 includes and/or implements an example DU 1312 and an example CU 1314. The example DU 1312 of FIG. 13 includes and/or implements an example high PHY 1316. For example, the high PHY 1316 can be implemented by the wireless measurement engine circuitry 200 of FIG. 2.

In the illustrated example of FIG. 13, the wireless communication layers 1300 include a first layer (L1) implemented by the DU 1312, and/or, more generally, the BBU pool 1308. The example wireless communication layers 1300 of FIG. 13 include a second layer (L2) implemented by the CU 1314, and/or, more generally, the BBU pool 1308. A possible advantage of examples disclosed herein is that the wireless communication layers 1300 of FIG. 13 can effectuate the generation of example wireless measurements 1318 based on wireless data from the wireless device 1302. For example, the wireless device 1302 can transmit PUSCH data to the RRH 1304 to effectuate determination of the wireless measurements 1318. Based on the PUSCH data, the first layer (L1) implemented by the high PHY 1316 of the DU 1312 can generate the wireless measurements 1318. Additionally or alternatively, the first layer (L1) implemented by the high PHY 1316 of the DU 1312 can generate the wireless measurements 1318 based on PDSCH data associated with downlink communication to the wireless device 1302.

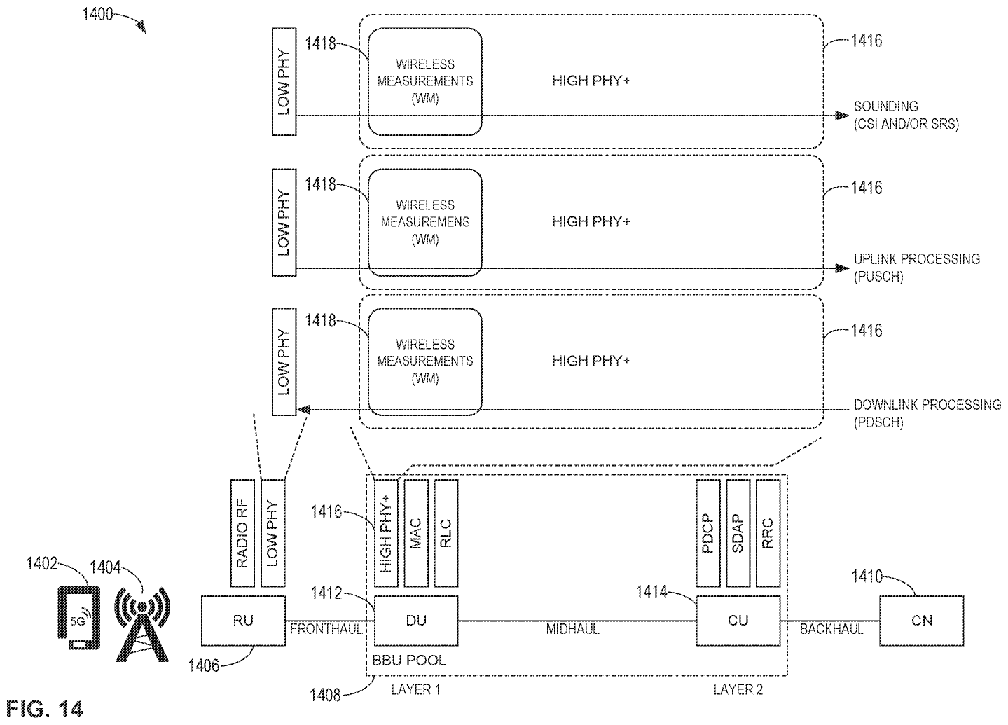

FIG. 14 is a second illustration of example wireless communication layers 1400 that may be utilized to generate wireless measurements associated with an example wireless device 1402. For example, the wireless device 1402 may communicate with an example RRH 1404, an example RU 1406, an example BBU pool 1408, and an example core network 1410. In the example of FIG. 14, the BBU pool 1408 includes and/or implements an example DU 1412 and an example CU 1414. The example DU 1412 of FIG. 14 includes and/or implements an example high PHY 1416. For example, the high PHY 1416 can be implemented by the wireless measurement engine circuitry 200 of FIG. 2.

In the illustrated example of FIG. 14, the wireless communication layers 1400 include a first layer (L1) implemented by the DU 1412, and/or, more generally, the BBU pool 1408. The example wireless communication layers 1400 of FIG. 14 include a second layer (L2) implemented by the CU 1414, and/or, more generally, the BBU pool 1408. A possible advantage of examples disclosed herein is that the wireless communication layers 1400 of FIG. 14 can effectuate the generation of example wireless measurements 1418 based on wireless data from the wireless device 1402. For example, the wireless device 1402 can transmit at least one of sounding data (identified by Sounding (channel state information (CSI) and/or SRS)) or PUSCH data to the RRH 1404 to effectuate determination of the wireless measurements 1418. Based on the sounding data and/or the PUSCH data, the first layer (L1) implemented by the high PHY 1416 of the DU 1412 can generate the wireless measurements 1418. Additionally or alternatively, the first layer (L1) implemented by the high PHY 1416 of the DU 1412 can generate the wireless measurements 1418 based on PDSCH data associated with downlink communication to the wireless device 1402.

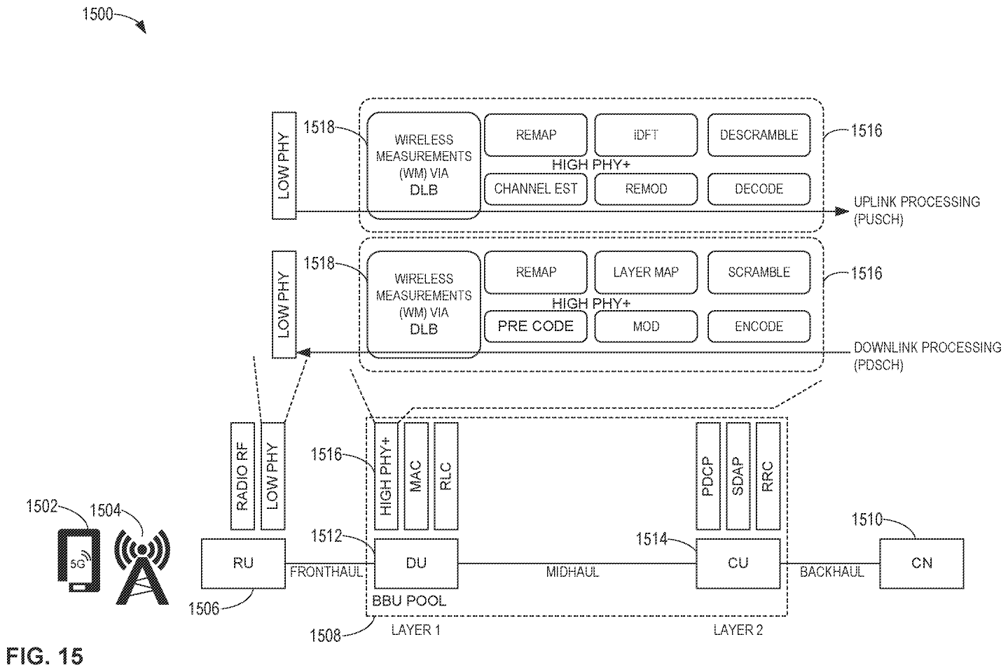

FIG. 15 is a third illustration of example wireless communication layers 1500 that may be utilized to generate wireless measurements associated with an example wireless device 1502.

For example, the wireless device 1502 may communicate with an example RRH 1504, an example RU 1506, an example BBU pool 1508, and an example core network 1510. In the example of FIG. 15, the BBU pool 1508 includes and/or implements an example DU 1512 and an example CU 1514. The example DU 1512 of FIG. 15 includes and/or implements an example high PHY 1516. For example, the high PHY 1516 can be implemented by the wireless measurement engine circuitry 200 of FIG. 2.

In the illustrated example of FIG. 15, the wireless communication layers 1500 include a first layer (L1) implemented by the DU 1512, and/or, more generally, the BBU pool 1508. The example wireless communication layers 1500 of FIG. 15 include a second layer (L2) implemented by the CU 1514, and/or, more generally, the BBU pool 1508. A possible advantage of examples disclosed herein is that the wireless communication layers 1500 of FIG. 15 can effectuate the generation of example wireless measurements 1518 based on wireless data from the wireless device 1502. For example, the wireless device 1502 can transmit PUSCH data to the RRH 1504 to effectuate determination of the wireless measurements 1518 via one or more dynamic load balancers (DLBs). In some examples, the high PHY 1516 of the DU 1512 can process the PUSCH data using one or more functions, operations, etc., such as a remapping operation (identified by REMAP), a channel estimation operation (identified by CHANNEL EST), a remodulation operation (REMOD), etc. Based on the PUSCH data, the first layer (L1) implemented by the high PHY 1516 of the DU 1512 can generate the wireless measurements 1518. Additionally or alternatively, the first layer (L1) implemented by the high PHY 1516 of the DU 1512 can generate the wireless measurements 1518 based on PDSCH data associated with downlink communication to the wireless device 1502.

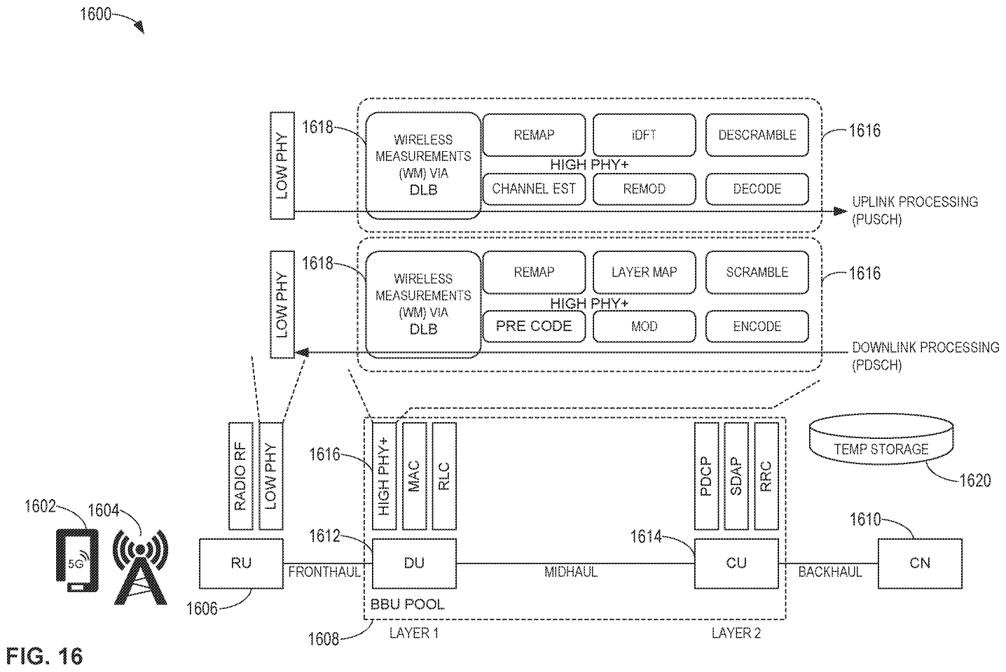

FIG. 16 is a fourth illustration of example wireless communication layers 1600 that may be utilized to generate wireless measurements associated with an example wireless device 1602.

For example, the wireless device 1602 may communicate with an example RRH 1604, an example RU 1606, an example BBU pool 1608, and an example core network 1610. In the example of FIG. 16, the BBU pool 1608 includes and/or implements an example DU 1612 and an example CU 1614. The example DU 1612 of FIG. 16 includes and/or implements an example high PHY 1616. For example, the high PHY 1616 can be implemented by the wireless measurement engine circuitry 200 of FIG. 2.

In the illustrated example of FIG. 16, the wireless communication layers 1600 include a first layer (L1) implemented by the DU 1612, and/or, more generally, the BBU pool 1608. The example wireless communication layers 1600 of FIG. 16 include a second layer (L2) implemented by the CU 1614, and/or, more generally, the BBU pool 1608. A possible advantage of examples disclosed herein is that the wireless communication layers 1600 of FIG. 16 can effectuate the generation of example wireless measurements 1618 based on wireless data from the wireless device 1602. For example, the wireless device 1602 can transmit PUSCH data to the RRH 1604 to effectuate determination of the wireless measurements 1618 via one or more dynamic load balancers (DLBs). In some examples, the high PHY 1616 of the DU 1612 can process the PUSCH data using one or more functions, operations, etc., such as a remapping operation (identified by REMAP), a channel estimation operation (identified by CHANNEL EST), a remodulation operation (REMOD), etc. Based on the PUSCH data, the first layer (L1) implemented by the high PHY 1616 of the DU 1612 can generate the wireless measurements 1618. Additionally or alternatively, the first layer (L1) implemented by the high PHY 1616 of the DU 1612 can generate the wireless measurements 1618 based on PDSCH data associated with downlink communication to the wireless device 1602. In some examples, the DLBs of the high PHY 1616 of the DU 1612 can store at least one of the wireless measurements 1618, the PUSCH data, etc., in example temporary storage 1620, which can be implemented by memory (e.g., cache memory), mass storage, etc.

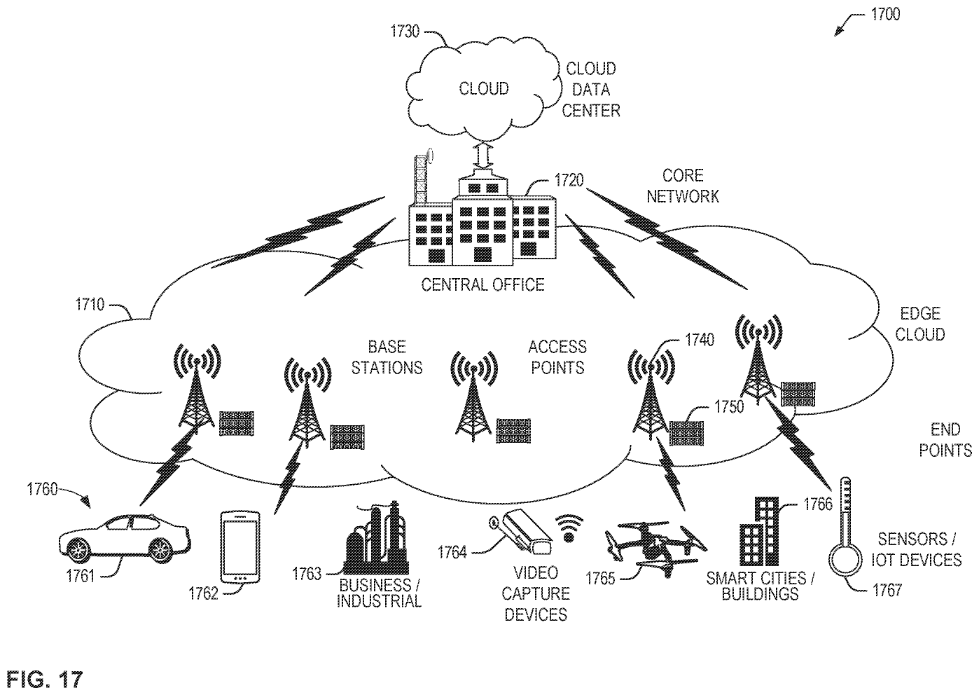

FIG. 17 is a block diagram 1700 showing an overview of a configuration for edge computing, which includes a layer of processing referred to in many of the following examples as an “edge cloud”. As shown, the edge cloud 1710 is co-located at an edge location, such as an access point or base station 1740, a local processing hub 1750, or a central office 1720, and thus may include multiple entities, devices, and equipment instances. The edge cloud 1710 is located much closer to the endpoint (consumer and producer) data sources 1760 (e.g., autonomous vehicles 1761, user equipment 1762, business and industrial equipment 1763, video capture devices 1764, drones 1765, smart cities and building devices 1766, sensors and Internet-of-Things (IoT) devices 1767, etc.) than the cloud data center 1730. Compute, memory, and storage resources that are offered at the edges in the edge cloud 1710 are critical to providing ultra-low latency response times for services and functions used by the endpoint data sources 1760 as well as reduce network backhaul traffic from the edge cloud 1710 toward cloud data center 1730 thus improving energy consumption and overall network usages among other benefits.

In some examples, the edge cloud 1710, the central office 1720, the cloud data center 1730, and/or portion(s) thereof, may implement one or more wireless measurements engines that collect data from and/or compute measurements associated with devices of the endpoint (consumer and producer) data sources 1760 (e.g., autonomous vehicles 1761, user equipment 1762, business and industrial equipment 1763, video capture devices 1764, drones 1765, smart cities and building devices 1766, sensors and IoT devices 1767, etc.). In some examples, the edge cloud 1710, the central office 1720, the cloud data center 1730, and/or portion(s) thereof, may implement one or more measurement engines to execute measurement determination operations with improved accuracy. For example, the edge cloud 1710, the central office 1720, the cloud data center 1730, and/or portion(s) thereof, can be implemented by the wireless measurement engine circuitry 200 of FIG. 2.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., Intel Architecture or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 17, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage and processing as well as remote cloud datacenter based storage and processing. Key performance indicators (KPIs) may be used to identify where sensor data is best transferred and where it is processed or stored. This typically depends on the OSI layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud datacenter. At a more generic level, an edge computing system may be described to encompass any number of deployments operating in the edge cloud 1710, which provide coordination from client and distributed computing devices.

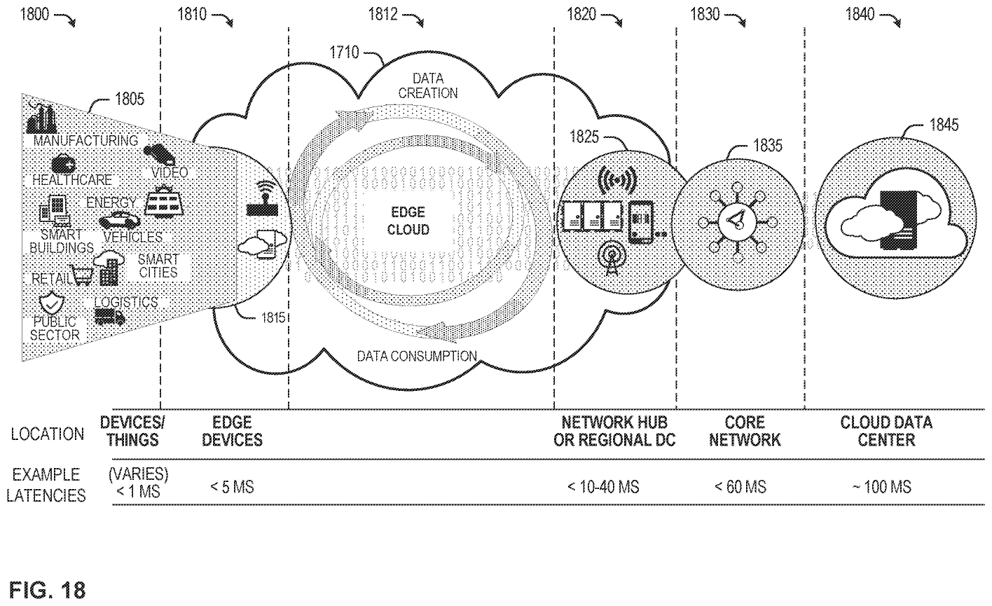

FIG. 18 illustrates operational layers among endpoints, an edge cloud, and cloud computing environments. Specifically, FIG. 18 depicts examples of computational use cases 1805, utilizing the edge cloud 1710 of FIG. 17 among multiple illustrative layers of network computing. The layers begin at an endpoint (devices and things) layer 1800, which accesses the edge cloud 1710 to conduct data creation, analysis, and data consumption activities. The edge cloud 1710 may span multiple network layers, such as an edge devices layer 1810 having gateways, on-premise servers, or network equipment (nodes 1815) located in physically proximate edge systems; a network access layer 1820, encompassing base stations, radio processing units, network hubs, regional data centers (DC), or local network equipment (equipment 1825); and any equipment, devices, or nodes located therebetween (in layer 1812, not illustrated in detail). The network communications within the edge cloud 1710 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1800, under 5 ms at the edge devices layer 1810, to even between 10 to 40 ms when communicating with nodes at the network access layer 1820. Beyond the edge cloud 1710 are core network 1830 and cloud data center 1832 layers, each with increasing latency (e.g., between 50-60 ms at the core network layer 1830, to 100 or more ms at the cloud data center layer 1840). As a result, operations at a core network data center 1835 or a cloud data center 1845, with latencies of at least 50 to 100 ms or more, will not be able to accomplish many time-critical functions of the use cases 1805. Each of these latency values are provided for purposes of illustration and contrast; it will be understood that the use of other access network mediums and technologies may further reduce the latencies. In some examples, respective portions of the network may be categorized as “close edge,” “local edge,” “near edge,” “middle edge,” or “far edge” layers, relative to a network source and destination. For instance, from the perspective of the core network data center 1835 or a cloud data center 1845, a central office or content data network may be considered as being located within a “near edge” layer (“near” to the cloud, having high latency values when communicating with the devices and endpoints of the use cases 1805), whereas an access point, base station, on-premise server, or network gateway may be considered as located within a “far edge” layer (“far” from the cloud, having low latency values when communicating with the devices and endpoints of the use cases 1805). It will be understood that other categorizations of a particular network layer as constituting a “close,” “local,” “near,” “middle,” or “far” edge may be based on latency, distance, number of network hops, or other measurable characteristics, as measured from a source in any of the network layers 1800-1840.

The various use cases 1805 may access resources under usage pressure from incoming streams, due to multiple services utilizing the edge cloud. For example, measurement determination for devices associated with such incoming streams of the various use cases 1805 is desired and may be achieved with example wireless measurement engines (e.g., the wireless measurement engine circuitry 200 of FIG. 2) as disclosed herein. To achieve results with low latency, the services executed within the edge cloud 1710 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement operations to remediate.

Thus, with these variations and service features in mind, edge computing within the edge cloud 1710 may provide the ability to serve and respond to multiple applications of the use cases 1805 (e.g., object tracking, location determination, video surveillance, connected cars, etc.) in real-time or near real-time, and meet ultra-low latency requirements for these multiple applications. These possible advantages enable a whole new class of applications (VNFs), Function-as-a-Service (FaaS), Edge-as-a-Service (EaaS), standard processes, etc.), which cannot leverage conventional cloud computing due to latency or other limitations.

However, with the possible advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 1710 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1710 (network layers 1810-1830), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco,” or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1710.

As such, the edge cloud 1710 is formed from network components and functional features operated by and within edge gateway nodes, edge aggregation nodes, or other edge compute nodes among network layers 1810-1830. The edge cloud 1710 thus may be embodied as any type of network that provides edge computing and/or storage resources which are proximately located to RAN capable endpoint devices (e.g., mobile computing devices, IoT devices, smart devices, etc.), which are discussed herein. In other words, the edge cloud 1710 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 1710 may be servers, multi-tenant servers, appliance computing devices, and/or any other type of computing devices. For example, the edge cloud 1710 may include an appliance computing device that is a self-contained electronic device including a housing, a chassis, a case or a shell. In some examples, the edge cloud 1710 may include an appliance to be operated in harsh environmental conditions (e.g., extreme heat or cold ambient temperatures, strong wind conditions, wet or frozen environments, and the like). In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference, vibration, extreme temperatures), and/or enable submergibility. Example housings may include power circuitry to provide power for stationary and/or portable implementations, such as alternating current (AC) power inputs, direct current (DC) power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, light emitting diodes (LEDs), speakers, I/O ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include IoT devices. The appliance computing device may include hardware and software components to manage local issues such as device temperature, vibration, resource utilization, updates, power issues, physical and network security, etc. The example processor systems of at least FIGS. 33, 34, 35, and/or 36 illustrate example hardware for implementing an appliance computing device. The edge cloud 1710 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code, or scripts.

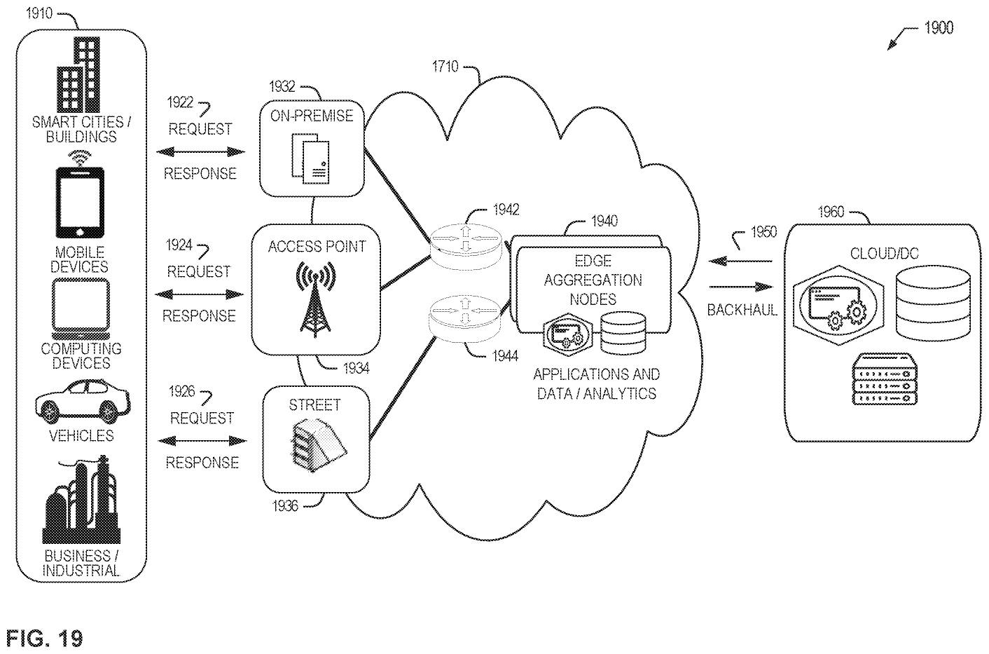

In FIG. 19, various client endpoints 1910 (in the form of mobile devices, computers, autonomous vehicles, business computing equipment, industrial processing equipment) exchange requests and responses that are specific to the type of endpoint network aggregation. For instance, client endpoints 1910 may obtain network access via a wired broadband network, by exchanging requests and responses 1922 through an on-premise network system 1932. Some client endpoints 1910, such as mobile computing devices, may obtain network access via a wireless broadband network, by exchanging requests and responses 1924 through an access point (e.g., cellular network tower) 1934. Some client endpoints 1910, such as autonomous vehicles may obtain network access for requests and responses 1926 via a wireless vehicular network through a street-located network system 1936. However, regardless of the type of network access, the TSP may deploy aggregation points 1942, 1944 within the edge cloud 1710 of FIG. 17 to aggregate traffic and requests. Thus, within the edge cloud 1710, the TSP may deploy various compute and storage resources, such as at edge aggregation nodes 1940, to provide requested content. The edge aggregation nodes 1940 and other systems of the edge cloud 1710 are connected to a cloud or data center (DC) 1960, which uses a backhaul network 1950 to fulfill higher-latency requests from a cloud/data center for websites, applications, database servers, etc. Additional or consolidated instances of the edge aggregation nodes 1940 and the aggregation points 1942, 1944, including those deployed on a single server framework, may also be present within the edge cloud 1710 or other areas of the TSP infrastructure. A possible advantage of examples disclosed herein is that example wireless measurement engines (e.g., the wireless measurement engine circuitry 200 of FIG. 2) as disclosed herein may detect and/or otherwise determine measurements associated with the client endpoints 1910 with improved performance and accuracy and reduced latency.

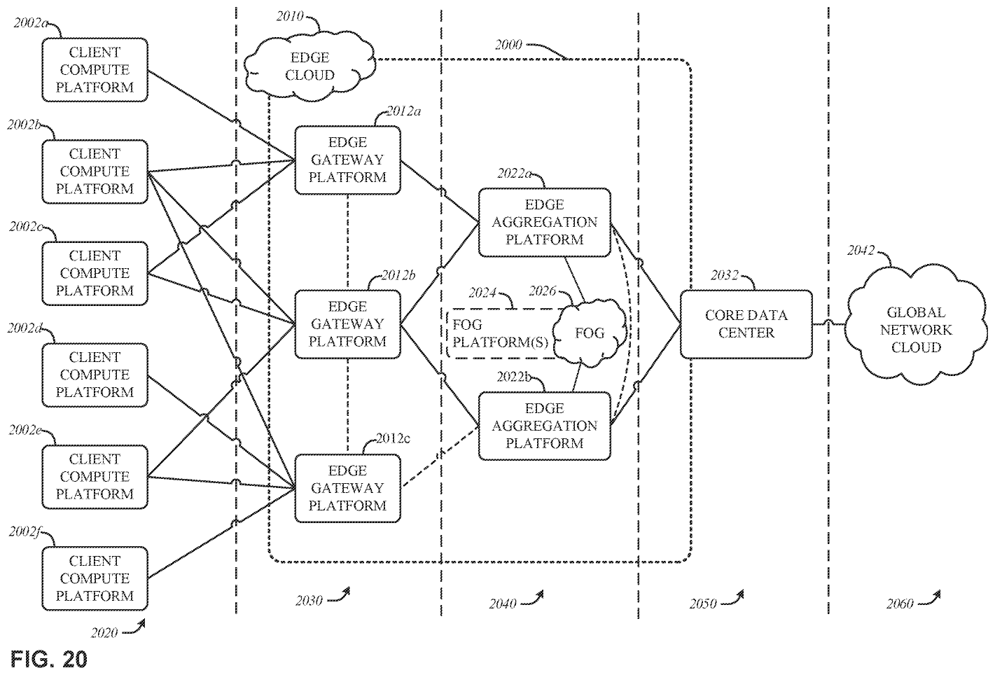

FIG. 20 depicts an example edge computing system 2000 for providing edge services and applications to multi-stakeholder entities, as distributed among one or more client compute platforms 2002, one or more edge gateway platforms 2012, one or more edge aggregation platforms 2022, one or more core data centers 2032, and a global network cloud 2042, as distributed across layers of the edge computing system 2000. The implementation of the edge computing system 2000 may be provided at or on behalf of a telecommunication service provider (“telco,” or “TSP”), internet-of-things service provider, cloud service provider (CSP), enterprise entity, or any other number of entities. Various implementations and configurations of the edge computing system 2000 may be provided dynamically, such as when orchestrated to meet service objectives.

Individual platforms or devices of the edge computing system 2000 are located at a particular layer corresponding to layers 2020, 2030, 2040, 2050, and 2060. For example, the client compute platforms 2002a, 2002b, 2002c, 2002d, 2002e, 2002f are located at an endpoint layer 2020, while the edge gateway platforms 2012a, 2012b, 2012c are located at an edge devices layer 2030 (local level) of the edge computing system 2000. Additionally, the edge aggregation platforms 2022a, 2022b (and/or fog platform(s) 2024, if arranged or operated with or among a fog networking configuration 2026) are located at a network access layer 2040 (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provides a decentralized architecture and serves as an extension to cloud computing by collaborating with one or more edge node devices, providing the subsequent amount of localized control, configuration, and management, and much more for end devices. Furthermore, fog computing provides the ability for edge resources to identify similar resources and collaborate to create an edge-local cloud which can be used solely or in conjunction with cloud computing to complete computing, storage, or connectivity related services. Fog computing may also allow the cloud-based services to expand their reach to the edge of a network of devices to offer local and quicker accessibility to edge devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 2032 is located at a core network layer 2050 (a regional or geographically central level), while the global network cloud 2042 is located at a cloud data center layer 2060 (a national or world-wide layer). The use of “core” is provided as a term for a centralized network location-deeper in the network-which is accessible by multiple edge platforms or components; however, a “core” does not necessarily designate the “center” or the deepest location of the network. Accordingly, the core data center 2032 may be located within, at, or near the edge cloud 2010. Although an illustrative number of client compute platforms 2002a, 2002b, 2002c, 2002d, 2002e, 2002f; edge gateway platforms 2012a, 2012b, 2012c; edge aggregation platforms 2022a, 2022b; edge core data centers 2032; and global network clouds 2042 are shown in FIG. 20, it should be appreciated that the edge computing system 2000 may include any number of devices and/or systems at each layer. Devices at any layer can be configured as peer nodes and/or peer platforms to each other and, accordingly, act in a collaborative manner to meet service objectives. For example, in additional or alternative examples, the edge gateway platforms 2012a, 2012b, 2012c can be configured as an edge of edges such that the edge gateway platforms 2012a, 2012b, 2012c communicate via peer to peer connections. In some examples, the edge aggregation platforms 2022a, 2022b and/or the fog platform(s) 2024 can be configured as an edge of edges such that the edge aggregation platforms 2022a, 2022b and/or the fog platform(s) communicate via peer to peer connections. Additionally, as shown in FIG. 20, the number of components of respective layers 2020, 2030, 2040, 2050, and 2060 generally increases at each lower level (e.g., when moving closer to endpoints (e.g., client compute platforms 2002a, 2002b, 2002c, 2002d, 2002e, 2002f)). As such, one edge gateway platforms 2012a, 2012b, 2012c may service multiple ones of the client compute platforms 2002a, 2002b, 2002c, 2002d, 2002e, 2002f, and one edge aggregation platform (e.g., one of the edge aggregation platforms 2022a, 2022b) may service multiple ones of the edge gateway platforms 2012a, 2012b, 2012c.

Consistent with the examples provided herein, a client compute platform (e.g., one of the client compute platforms 2002a, 2002b, 2002c, 2002d, 2002e, 2002f) may be implemented as any type of endpoint component, device, appliance, or other thing capable of communicating as a producer or consumer of data. For example, a client compute platform can include a mobile phone, a laptop computer, a desktop computer, a processor platform in an autonomous vehicle, etc. In additional or alternative examples, a client compute platform can include a camera, a sensor, etc. Further, the label “platform,” “node,” and/or “device” as used in the edge computing system 2000 does not necessarily mean that such platform, node, and/or device operates in a client or slave role; rather, any of the platforms, nodes, and/or devices in the edge computing system 2000 refer to individual entities, platforms, nodes, devices, and/or subsystems which include discrete and/or connected hardware and/or software configurations to facilitate and/or use the edge cloud 2010. A possible advantage of examples disclosed herein is that example wireless measurement engines (e.g., the wireless measurement engine circuitry 200 of FIG. 2) as disclosed herein may detect and/or otherwise determine measurements associated with the client compute platforms 2002a, 2002b, 2002c, 2002d, 2002e, 2002f with improved performance and accuracy as well as with reduced latency.

As such, the edge cloud 2010 is formed from network components and functional features operated by and within the edge gateway platforms 2012a, 2012b, 2012c and the edge aggregation platforms 2022a, 2022b of layers 2030, 2040, respectively. The edge cloud 2010 may be implemented as any type of network that provides edge computing and/or storage resources which are proximately located to RAN capable endpoint devices (e.g., mobile computing devices, IoT devices, smart devices, etc.), which are shown in FIG. 20 as the client compute platforms 2002a, 2002b, 2002c, 2002d, 2002e, 2002f. In other words, the edge cloud 2010 may be envisioned as an “edge” which connects the endpoint devices and traditional network access points that serves as an ingress point into service provider core networks, including mobile carrier networks (e.g., GSM networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge cloud 2010 may form a portion of, or otherwise provide, an ingress point into or across a fog networking configuration 2026 (e.g., a network of fog platform(s) 2024, not shown in detail), which may be implemented as a system-level horizontal and distributed architecture that distributes resources and services to perform a specific function. For instance, a coordinated and distributed network of fog platform(s) 2024 may perform computing, storage, control, or networking aspects in the context of an IoT system arrangement. Other networked, aggregated, and distributed functions may exist in the edge cloud 2010 between the core data center 2032 and the client endpoints (e.g., client compute platforms 2002a, 2002b, 2002c, 2002d, 2002e, 2002f). Some of these are discussed in the following sections in the context of network functions or service virtualization, including the use of virtual edges and virtual services which are orchestrated for multiple tenants.

As discussed in more detail below, the edge gateway platforms 2012a, 2012b, 2012c and the edge aggregation platforms 2022a, 2022b cooperate to provide various edge services and security to the client compute platforms 2002a, 2002b, 2002c, 2002d, 2002e, 2002f. Furthermore, because a client compute platforms (e.g., one of the client compute platforms 2002a, 2002b, 2002c, 2002d, 2002e, 2002f) may be stationary or mobile, a respective edge gateway platform 2012a, 2012b, 2012c may cooperate with other edge gateway platforms to propagate presently provided edge services, relevant service data, and security as the corresponding client compute platforms 2002a, 2002b, 2002c, 2002d, 2002e, 2002f moves about a region. To do so, the edge gateway platforms 2012a, 2012b, 2012c and/or edge aggregation platforms 2022a, 2022b may support multiple tenancy and multiple tenant configurations, in which services from (or hosted for) multiple service providers, owners, and multiple consumers may be supported and coordinated across a single or multiple compute devices.

In examples disclosed herein, edge platforms in the edge computing system 2000 includes meta-orchestration functionality. For example, edge platforms at the far-edge (e.g., edge platforms closer to edge users, the edge devices layer 2030, etc.) can reduce the performance or power consumption of orchestration tasks associated with far-edge platforms so that the execution of orchestration components at far-edge platforms consumes a small fraction of the power and performance available at far-edge platforms.

The orchestrators at various far-edge platforms participate in an end-to-end orchestration architecture. Examples disclosed herein anticipate that the comprehensive operating software framework (such as, open network automation platform (ONAP) or similar platform) will be expanded, or options created within it, so that examples disclosed herein can be compatible with those frameworks. For example, orchestrators at edge platforms implementing examples disclosed herein can interface with ONAP orchestration flows and facilitate edge platform orchestration and telemetry activities. Orchestrators implementing examples disclosed herein act to regulate the orchestration and telemetry activities that are performed at edge platforms, including increasing or decreasing the power and/or resources expended by the local orchestration and telemetry components, delegating orchestration and telemetry processes to a remote computer, and/or retrieving orchestration and telemetry processes from the remote computer when power and/or resources are available.

The remote devices described above are situated at alternative locations with respect to those edge platforms that are offloading telemetry and orchestration processes. For example, the remote devices described above can be situated, by contrast, at a near-edge platforms (e.g., the network access layer 2040, the core network layer 2050, a central office, a mini-datacenter, etc.). By offloading telemetry and/or orchestration processes at a near edge platforms, an orchestrator at a near-edge platform is assured of (comparatively) stable power supply, and sufficient computational resources to facilitate execution of telemetry and/or orchestration processes. An orchestrator (e.g., operating according to a global loop) at a near-edge platform can take delegated telemetry and/or orchestration processes from an orchestrator (e.g., operating according to a local loop) at a far-edge platform. For example, if an orchestrator at a near-edge platform takes delegated telemetry and/or orchestration processes, then at some later time, the orchestrator at the near-edge platform can return the delegated telemetry and/or orchestration processes to an orchestrator at a far-edge platform as conditions change at the far-edge platform (e.g., as power and computational resources at a far-edge platform satisfy a threshold level, as higher levels of power and/or computational resources become available at a far-edge platform, etc.).

A variety of security approaches may be utilized within the architecture of the edge cloud 2010. In a multi-stakeholder environment, there can be multiple loadable security modules (LSMs) used to provision policies that enforce the stakeholder's interests including those of tenants. In some examples, other operators, service providers, etc. may have security interests that compete with the tenant's interests. For example, tenants may prefer to receive full services (e.g., provided by an edge platform) for free while service providers would like to get full payment for performing little work or incurring little costs. Enforcement point environments could support multiple LSMs that apply the combination of loaded LSM policies (e.g., where the most constrained effective policy is applied, such as where if any of A, B or C stakeholders restricts access then access is restricted). Within the edge cloud 2010, each edge entity can provision LSMs that enforce the Edge entity interests. The cloud entity can provision LSMs that enforce the cloud entity interests. Likewise, the various fog and IoT network entities can provision LSMs that enforce the fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (e.g., to identify what elements are required by the system to conduct a service, how the system responds to service conditions and changes, and the like).

Additionally, in examples disclosed herein, edge platforms and/or orchestration components thereof may consider several factors when orchestrating services and/or applications in an edge environment. These factors can include next-generation central office smart network functions virtualization and service management, improving performance per watt at an edge platform and/or of orchestration components to overcome the limitation of power at edge platforms, reducing power consumption of orchestration components and/or an edge platform, improving hardware utilization to increase management and orchestration efficiency, providing physical and/or end to end security, providing individual tenant quality of service and/or service level agreement satisfaction, improving network equipment-building system compliance level for each use case and tenant business model, pooling acceleration components, and billing and metering policies to improve an edge environment.

A “service” is a broad term often applied to various contexts, but in general, it refers to a relationship between two entities where one entity offers and performs work for the benefit of another. However, the services delivered from one entity to another must be performed with certain guidelines, which ensure trust between the entities and manage the transaction according to the contract terms and conditions set forth at the beginning, during, and end of the service.

An example relationship among services for use in an edge computing system is described below. In scenarios of edge computing, there are several services, and transaction layers in operation and dependent on each other—these services create a “service chain.” At the lowest level, ingredients compose systems. These systems and/or resources communicate and collaborate with each other in order to provide a multitude of services to each other as well as other permanent or transient entities around them. In turn, these entities may provide human-consumable services. With this hierarchy, services offered at each tier must be transactionally connected to ensure that the individual component (or sub-entity) providing a service adheres to the contractually agreed to objectives and specifications. Deviations at each layer could result in overall impact to the entire service chain.

One type of service that may be offered in an edge environment hierarchy is Silicon Level Services. For instance, Software Defined Silicon (SDSi)-type hardware provides the ability to ensure low level adherence to transactions, through the ability to intra-scale, manage and assure the delivery of operational service level agreements. Use of SDSi and similar hardware controls provide the capability to associate features and resources within a system to a specific tenant and manage the individual title (rights) to those resources. Use of such features is among one way to dynamically “bring” the compute resources to the workload.

For example, an operational level agreement and/or service level agreement could define “transactional throughput” or “timeliness”—in case of SDSi, the system and/or resource can sign up to guarantee specific service level specifications (SLS) and objectives (SLO) of a service level agreement (SLA). For example, SLOs can correspond to particular key performance indicators (KPIs) (e.g., frames per second, floating point operations per second, latency goals, etc.) of an application (e.g., service, workload, etc.) and an SLA can correspond to a platform level agreement to satisfy a particular SLO (e.g., one gigabyte of memory for 10 frames per second). SDSi hardware also provides the ability for the infrastructure and resource owner to empower the silicon component (e.g., components of a composed system that produce metric telemetry) to access and manage (add/remove) product features and freely scale hardware capabilities and utilization up and down. Furthermore, it provides the ability to provide deterministic feature assignments on a per-tenant basis. It also provides the capability to tie deterministic orchestration and service management to the dynamic (or subscription based) activation of features without the need to interrupt running services, client operations or by resetting or rebooting the system.

At the lowest layer, SDSi can provide services and guarantees to systems to ensure active adherence to contractually agreed-to service level specifications that a single resource has to provide within the system. Additionally, SDSi provides the ability to manage the contractual rights (title), usage and associated financials of one or more tenants on a per component, or even silicon level feature (e.g., stockkeeping unit (SKU) features). Silicon level features may be associated with compute, storage or network capabilities, performance, determinism or even features for security, encryption, acceleration, etc. These capabilities ensure not only that the tenant can achieve a specific service level agreement, but also assist with management and data collection, and assure the transaction and the contractual agreement at the lowest manageable component level.

At a higher layer in the services hierarchy, Resource Level Services, includes systems and/or resources which provide (in complete or through composition) the ability to meet workload demands by either acquiring and enabling system level features via SDSi, or through the composition of individually addressable resources (compute, storage, and network). At yet a higher layer of the services hierarchy, Workflow Level Services, is horizontal, since service-chains may have workflow level requirements. Workflows describe dependencies between workloads in order to deliver specific service level objectives and requirements to the end-to-end service. These services may include features and functions like high-availability, redundancy, recovery, fault tolerance or load-leveling (we can include lots more in this). Workflow services define dependencies and relationships between resources and systems, describe requirements on associated networks and storage, as well as describe transaction level requirements and associated contracts in order to assure the end-to-end service. Workflow Level Services are usually measured in Service Level Objectives and have mandatory and expected service requirements.

At yet a higher layer of the services hierarchy, Business Functional Services (BFS) are operable, and these services are the different elements of the service which have relationships to each other and provide specific functions for the customer. In the case of Edge computing and within the example of Autonomous Driving, business functions may be composing the service, for instance, of a “timely arrival to an event”—this service would require several business functions to work together and in concert to achieve the goal of the user entity: GPS guidance, RSU (Road Side Unit) awareness of local traffic conditions, Payment history of user entity, Authorization of user entity of resource(s), etc. Furthermore, as these BFS(s) provide services to multiple entities, each BFS manages its own SLA and is aware of its ability to deal with the demand on its own resources (Workload and Workflow). As requirements and demand increases, it communicates the service change requirements to Workflow and resource level service entities, so they can, in-turn provide insights to their ability to fulfill. This operation assists the overall transaction and service delivery to the next layer.

At the highest layer of services in the service hierarchy, Business Level Services (BLS), is tied to the capability that is being delivered. At this level, the customer or entity might not care about how the service is composed or what ingredients are used, managed, and/or tracked to provide the service(s). The primary objective of business level services is to attain the goals set by the customer according to the overall contract terms and conditions established between the customer and the provider at the agreed to a financial agreement. BLS(s) are comprised of several Business Functional Services (BFS) and an overall SLA.

This arrangement and other service management features described herein are designed to meet the various requirements of edge computing with its unique and complex resource and service interactions. This service management arrangement is intended to inherently address several of the resource basic services within its framework, instead of through an agent or middleware capability. Services such as: locate, find, address, trace, track, identify, and/or register may be placed immediately in effect as resources appear on the framework, and the manager or owner of the resource domain can use management rules and policies to ensure orderly resource discovery, registration, and certification.

Moreover, any number of edge computing architectures described herein may be adapted with service management features. These features may enable a system to be constantly aware and record information about the motion, vector, and/or direction of resources as well as fully describe these features as both telemetry and metadata associated with the devices. These service management features can be used for resource management, billing, and/or metering, as well as an element of security. The same functionality also applies to related resources, where a less intelligent device, like a sensor, might be attached to a more manageable resource, such as an edge gateway. The service management framework is made aware of change of custody or encapsulation for resources. Since nodes and components may be directly accessible or be managed indirectly through a parent or alternative responsible device for a short duration or for its entire lifecycle, this type of structure is relayed to the service framework through its interface and made available to external query mechanisms.

Additionally, this service management framework is always service aware and naturally balances the service delivery requirements with the capability and availability of the resources and the access for the data upload the data analytics systems. If the network transports degrade, fail or change to a higher cost or lower bandwidth function, service policy monitoring functions provide alternative analytics and service delivery mechanisms within the privacy or cost constraints of the user. With these features, the policies can trigger the invocation of analytics and dashboard services at the edge ensuring continuous service availability at reduced fidelity or granularity. Once network transports are re-established, regular data collection, upload and analytics services can resume.

The deployment of a multi-stakeholder edge computing system may be arranged and orchestrated to enable the deployment of multiple services and virtual edge instances, among multiple edge platforms and subsystems, for use by multiple tenants and service providers. In a system example applicable to a cloud service provider (CSP), the deployment of an edge computing system may be provided via an “over-the-top” approach, to introduce edge computing platforms as a supplemental tool to cloud computing. In a contrasting system example applicable to a telecommunications service provider (TSP), the deployment of an edge computing system may be provided via a “network-aggregation” approach, to introduce edge computing platforms at locations in which network accesses (from different types of data access networks) are aggregated. However, these over-the-top and network aggregation approaches may be implemented together in a hybrid or merged approach or configuration.

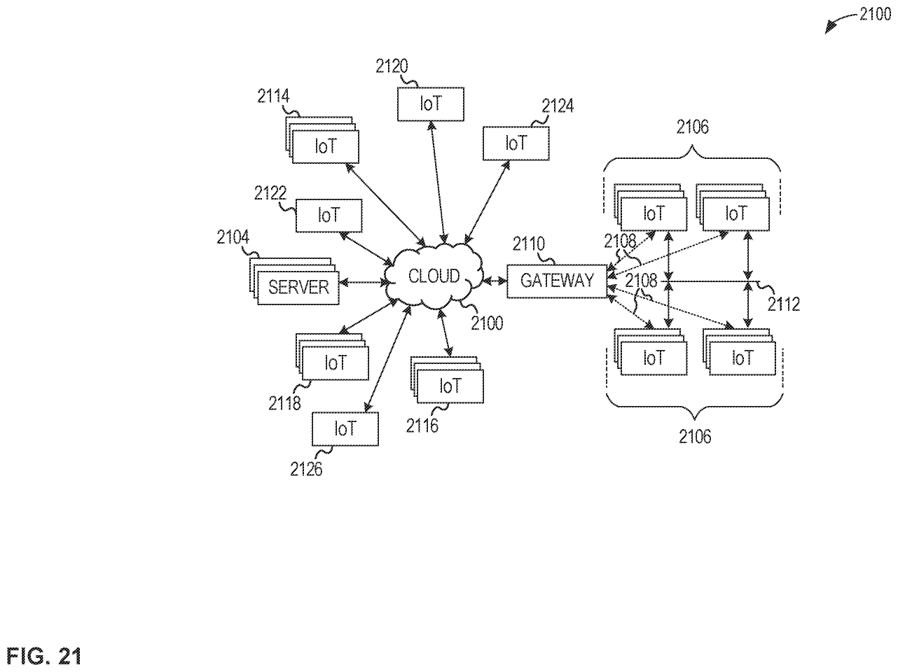

FIG. 21 illustrates a drawing of a cloud computing network, or cloud 2100, in communication with a number of IoT devices. The cloud 2100 may represent the Internet, or may be a local area network (LAN), or a wide area network (WAN), such as a proprietary network for a company. The IoT devices may include any number of different types of devices, grouped in various combinations. For example, a traffic control group 2106 may include IoT devices along streets in a city. These IoT devices may include stoplights, traffic flow monitors, cameras, weather sensors, and the like. The traffic control group 2106, or other subgroups, may be in communication with the cloud 2100 through wired or wireless links 2108, such as LPWA links, and the like. Further, a wired or wireless sub-network 2112 may allow the IoT devices to communicate with each other, such as through a local area network, a wireless local area network, and the like. The IoT devices may use another device, such as a gateway 2110 or 2128 to communicate with remote locations such as the cloud 2100; the IoT devices may also use one or more servers 2130 to facilitate communication with the cloud 2100 or with the gateway 2110.

For example, the one or more servers 2130 may operate as an intermediate network node to support a local Edge cloud or fog implementation among a local area network. Further, the gateway 2128 that is depicted may operate in a cloud-to-gateway-to-many Edge devices configuration, such as with the various IoT devices 2114, 2120, 2124 being constrained or dynamic to an assignment and use of resources in the cloud 2100.

Other example groups of IoT devices may include remote weather stations 2114, local information terminals 2116, alarm systems 2118, automated teller machines 2120, alarm panels 2122, or moving vehicles, such as emergency vehicles 2124 or other vehicles 2126, among many others. Each of these IoT devices may be in communication with other IoT devices, with servers 2104, with another IoT fog device or system (not shown), or a combination therein. The groups of IoT devices may be deployed in various residential, commercial, and industrial settings (including in both private or public environments). A possible advantage of examples disclosed herein is that example measurement engines (e.g., a measurement engine that includes and/or is implemented by the wireless measurement engine circuitry 200 of FIG. 2) as disclosed herein may achieve measurement determination of one(s) of the IoT devices of the traffic control group 2106, one(s) of the IoT devices 2114, 2116, 2118, 2120, 2122, 2124, 2126, etc., and/or a combination thereof with improved performance, improved accuracy, and/or reduced latency.

As may be seen from FIG. 21, a large number of IoT devices may be communicating through the cloud 2100. This may allow different IoT devices to request or provide information to other devices autonomously. For example, a group of IoT devices (e.g., the traffic control group 2106) may request a current weather forecast from a group of remote weather stations 2114, which may provide the forecast without human intervention. Further, an emergency vehicle 2124 may be alerted by an automated teller machine 2120 that a burglary is in progress.

As the emergency vehicle 2124 proceeds towards the automated teller machine 2120, it may access the traffic control group 2106 to request clearance to the location, for example, by lights turning red to block cross traffic at an intersection in sufficient time for the emergency vehicle 2124 to have unimpeded access to the intersection.

Clusters of IoT devices, such as the remote weather stations 2114 or the traffic control group 2106, may be equipped to communicate with other IoT devices as well as with the cloud 2100. This may allow the IoT devices to form an ad-hoc network between the devices, allowing them to function as a single device, which may be termed a fog device or system (e.g., as described above with reference to FIG. 20).

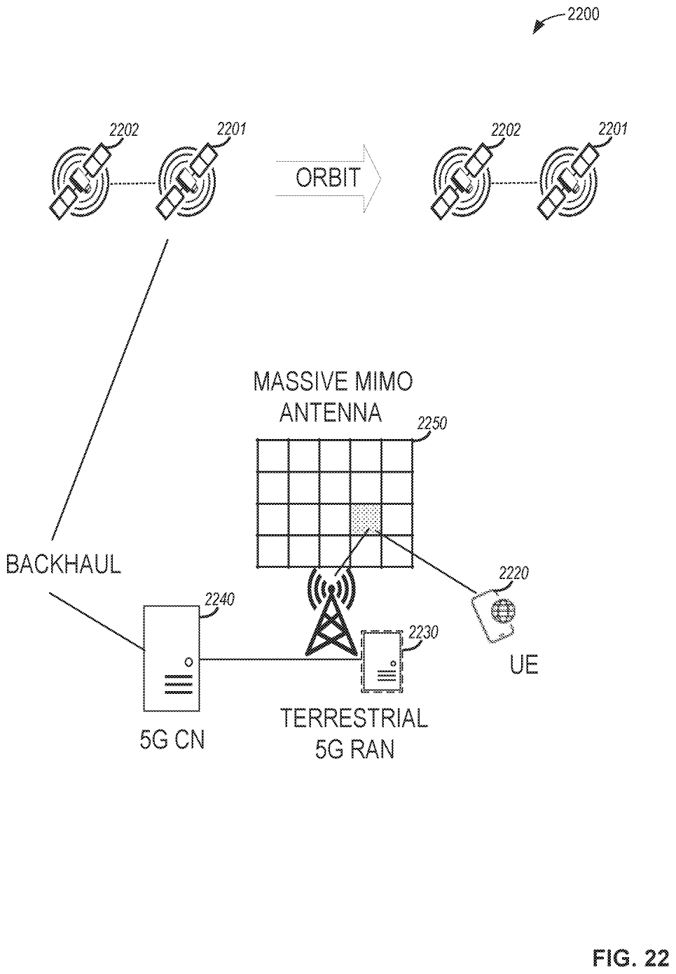

FIG. 22 illustrates network connectivity in non-terrestrial (satellite) and terrestrial (mobile cellular network) settings, according to an example. As shown, a satellite constellation (e.g., a Low Earth Orbit constellation) may include multiple satellites 2201, 2202, which are connected to each other and to one or more terrestrial networks. Specifically, the satellite constellation is connected to a backhaul network, which is in turn connected to a 5G core network 2240. The 5G core network is used to support 5G communication operations at the satellite network and at a terrestrial 5G RAN 2230.

FIG. 22 also depicts the use of the terrestrial 5G RAN 2230, to provide radio connectivity to a UE 2220 via a massive multiple input, multiple output (MIMO) antenna 2250. It will be understood that a variety of network communication components and units are not depicted in FIG. 22 for purposes of simplicity. With these basic entities in mind, the following techniques describe ways in which terrestrial and satellite networks can be extended for various Edge computing scenarios. Alternatively, the illustrated example of FIG. 22 may be applicable to other cellular technologies (e.g., 6G and the like).

Flowcharts representative of example machine readable instructions, which may be executed to configure processor circuitry to implement the wireless measurement engine circuitry 200 of FIG. 2, are shown in FIGS. 23-28. The machine readable instructions may be one or more executable programs or portion(s) of an executable program for execution by processor circuitry, such as the processor 3352 shown in the example IoT device 3350 discussed below in connection with FIG. 33, the processor circuitry 3412 shown in the example processor platform 3400 discussed below in connection with FIG. 34, and/or the example processor circuitry discussed below in connection with FIGS. 35 and/or 36. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 23-28, many other methods of implementing the example wireless measurement engine circuitry 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 23-28 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 23 is a flowchart representative of example machine-readable instructions and/or example operations 2300 that may be executed and/or instantiated by the processor circuitry to implement the wireless measurement engine circuitry 200 of FIG. 2 to cause an adjustment to a network based on wireless measurements. The example machine-readable instructions and/or example operations 2300 of FIG. 23 begin at block 2302, at which the wireless measurement engine circuitry 200 enqueues a data pointer into a first data queue. For example, at block 2302, the interface circuitry 210 (FIG. 2) receives wireless data, which can include reference signal (e.g., SRS) data, from the wireless device 502 of FIG. 5. In some examples, the RX core 1210 of FIG. 12A receives the wireless data identified by UE #1 L1 wireless data in FIG. 12A. In some examples, the wireless data identified by UE #1 L1 wireless data in FIG. 12A can be the wireless data transmitted by the wireless device 502 of FIG. 5 to the first gNB 504 of FIG. 5. Additionally, for example, at block 2302, the parser circuitry 220 (FIG. 2) enqueues a data pointer that references and/or otherwise is associated with the wireless data into a first data queue. In some examples, the first data queue is associated with a first core of multi-core processor circuitry. For example, the DLB circuitry 1214, which can be included in and/or implemented by the parser circuitry 220, enqueues the data pointer into a first data queue that is associated with a first core of the multi-core processor circuitry 1208, such as one of the one or more second cores 1222 of FIG. 12A.

In the illustrated example of FIG. 23, at block 2304, the wireless measurement engine circuitry 200 determines wireless network measurements based on wireless data from a wireless device. For example, at block 2304, the wireless measurement determination circuitry 240 (FIG. 2) determines and/or generates the wireless physical layer measurements 264 (FIG. 2) based on wireless data received at one or more base stations, such as the first gNB 504, that is transmitted from the wireless device 502. In some examples, the one of the one or more second cores 1222 can determine the wireless physical layer measurements 264 based on the UE #1 L1 wireless data in FIG. 12A.

In the illustrated example of FIG. 23, at block 2306, the wireless measurement engine circuitry 200 dequeues the data pointer from the first data queue to a second data queue. For example, at block 2306, the parser circuitry 220 dequeues the data pointer from the first data queue to a second data queue associated with a second core of the multi-core processor circuitry. For example, the DLB circuitry 1214, which can be included in and/or implemented by the parser circuitry 220, dequeues the data pointer from the first data queue to a second data queue that is associated with a second core of the multi-core processor circuitry 1208, such as the TX core 1212 of FIG. 12A.

In the illustrated example of FIG. 23, at block 2308, the wireless measurement engine circuitry 200 causes an adjustment to a network associated with the wireless device based on the wireless network measurements. For example, if the wireless measurement determination circuitry 240 determines that there is increased interference associated with the wireless device 502, then at block 2308, the event generation circuitry 250 (FIG. 2) generates an event representative of a recommendation to change a channel on which the wireless device 502 is to communicate with the first base station to reduce, resolve, and/or otherwise remove the interference. In the example of FIG. 23, after causing the adjustment at block 2308, the example machine-readable instructions and/or the example operations 2300 of FIG. 23 conclude.

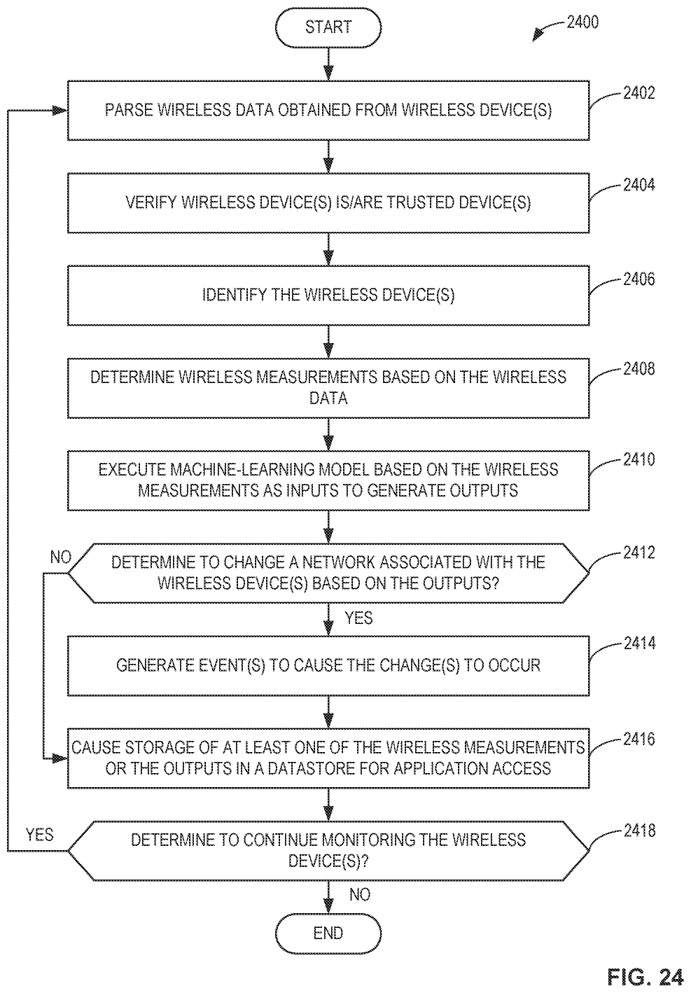

FIG. 24 is another flowchart representative of example machine-readable instructions and/or example operations 2400 that may be executed and/or instantiated by processor circuitry to implement the wireless measurement engine circuitry 200 of FIG. 2 to cause an adjustment to a network based on wireless measurements. The example machine-readable instructions and/or the example operations 2400 of FIG. 24 begin at block 2402, at which the wireless measurement engine circuitry 200 parses wireless data obtained from wireless device(s). For example, at block 2402, the parser circuitry 220 (FIG. 2) parses wireless data from the wireless device 502 of FIG. 5 to identify measurements and/or statistics, such as the measurements 612 of FIG. 6, based on the wireless data received from the wireless device 502 of FIG. 5.

In the illustrated example of FIG. 24, at block 2404, the wireless measurement engine circuitry 200 verifies wireless device(s) is/are trusted device(s). For example, at block 2404, the device identification circuitry 230 (FIG. 2) determines whether the wireless device 502 is a trusted device, an authorized device, etc. In some examples, at block 2404, the device identification circuitry 230 determines that the wireless device 502 is an authorized device based on authentication data, authorization data, security data, validation data, etc., in the wireless data as associated with an SLA.

In the illustrated example of FIG. 24, at block 2406, the wireless measurement engine circuitry 200 identifies the wireless device(s). For example, at block 2406, the device identification circuitry 230 identifies the wireless device 502 based on an identifier associated with the wireless device 502, such as a UE identifier of the wireless device 502. At block 2408, the wireless measurement engine circuitry 200 determines wireless measurements based on the wireless data. For example, at block 2408, the wireless measurement determination circuitry 240 generates and/or determines the measurements 612 of FIG. 6. At block 2410, the wireless measurement engine circuitry 200 executes a machine-learning model based on the wireless measurements as inputs to generate outputs. For example, at block 2410, the wireless measurement determination circuitry 240 executes and/or instantiates the machine-learning model 266 (FIG. 2) using the wireless physical data 262 (FIG. 2) as input(s) to generate output(s).

In the illustrated example of FIG. 24, at block 2412, the wireless measurement engine circuitry 200 determines whether to change a network associated with the wireless device(s) based on the outputs of the machine-learning model. For example, if, at block 2412, the wireless measurement determination circuitry 240 determines that the output(s) of the machine-learning model 266 (FIG. 2) is and/or include a recommendation to change a configuration of at least one of the wireless device 502 or one(s) of the gNBs 504, 506, 508 of FIG. 5, then the wireless measurement determination circuitry 240 determines to change the network associated with the wireless device 502 based on the output(s) of the machine-learning model 266 (FIG. 2). If, at block 2412, the wireless measurement engine circuitry 200 determines not to change a network associated with the wireless device(s) based on the outputs of the machine-learning model, control proceeds to block 2416. Otherwise (e.g., if the wireless measurement engine circuitry 200 determines to change a network associated with the wireless device(s) based on the outputs of the machine-learning model), control proceeds to block 2414.

In the illustrated example of FIG. 24, at block 2414, the wireless measurement engine circuitry 200 generates event(s) to cause the change(s) to occur. For example, at block 2414, the event generation circuitry 250 (FIG. 2) generates one or more events, which can cause at least one of the wireless device 502 or the one(s) of the gNBs 504, 506, 508 to carry out and/or otherwise perform one or more actions, activities, operations, tasks, etc., in accordance with the output(s). At block 2416, the wireless measurement engine circuitry 200 causes storage of at least one of the wireless measurements or the outputs in a datastore for application access. For example, at block 2416, the interface circuitry 210 (FIG. 2) causes storage of the at least one of the wireless physical layer measurements 264 or the output(s) from the ML model 266 in the datastore 260 (FIG. 2) as the wireless physical layer data 262 (FIG. 2). In some examples, hardware (e.g., electronic device(s)), software (e.g., service(s), application(s), etc.), and/or firmware can access the at least one of the wireless physical layer measurements 264 or the output(s) in the datastore 260.

In the illustrated example of FIG. 24, at block 2418, the wireless measurement engine circuitry 200 determines whether to continue monitoring the wireless device(s). For example, at block 2418, the interface circuitry 210 (FIG. 2) determines whether additional wireless data is to be received from the wireless device 502. In some examples, the determination can be based on an SLA associated with the wireless device 502. If, at block 2418, the wireless measurement engine circuitry 200 determines to continue monitoring the wireless device(s), control returns to block 2402. Otherwise (e.g., if the wireless measurement engine circuitry 200 determines not to continue monitoring the wireless device(s)), the example machine-readable instructions and/or the example operations 2400 of FIG. 24 conclude.

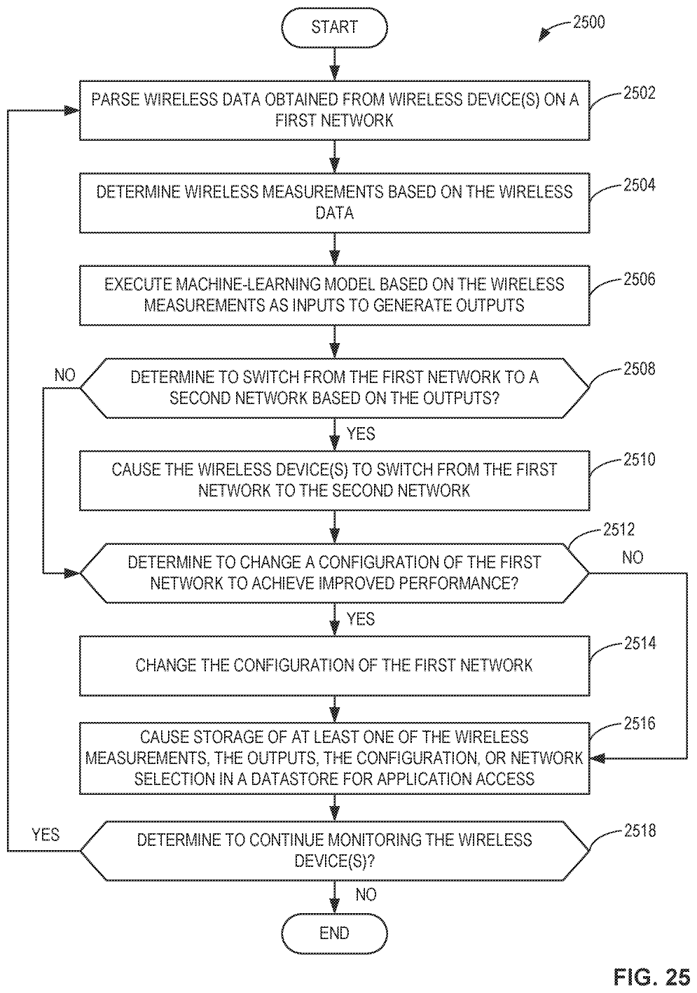

FIG. 25 is a flowchart representative of example machine-readable instructions and/or example operations 2500 that may be executed and/or instantiated by processor circuitry to implement the wireless measurement engine circuitry 200 of FIG. 2 to change a network associated with a wireless device. The example machine-readable instructions and/or the example operations 2500 of FIG. 25 begin at block 2502, at which the wireless measurement engine circuitry 200 parses wireless data obtained from wireless device(s) on a first network. For example, at block 2502, the parser circuitry 220 (FIG. 2) parses wireless data from the wireless device 502 of FIG. 5 to identify measurements and/or statistics, such as the measurements 612 of FIG. 6, based on the wireless data received from the wireless device 502 of FIG. 5.

In the illustrated example of FIG. 25, at block 2504, the wireless measurement engine circuitry 200 determines wireless measurements based on the wireless data. For example, at block 2504, the wireless measurement determination circuitry 240 (FIG. 2) generates and/or determines the measurements 612 of FIG. 6. At block 2506, the wireless measurement engine circuitry 200 executes a machine-learning model based on the wireless measurements as inputs to generate outputs. For example, at block 2506, the wireless measurement determination circuitry 240 executes and/or instantiates the machine-learning model 266 (FIG. 2) using the wireless physical layer data 262 (FIG. 2) as input(s) to generate output(s).

In the illustrated example of FIG. 25, at block 2508, the wireless measurement engine circuitry 200 determines whether to switch from the first network to a second network based on the outputs. For example, at block 2508, the wireless measurement determination circuitry 240 can determine to switch from a 5G network to a Wi-Fi network based on a determination that the outputs of the machine-learning model 266 (FIG. 2) indicate such a switch is warranted based on the wireless physical layer measurements 264. If, at block 2508, the wireless measurement engine circuitry 200 determines not to switch from the first network to a second network based on the outputs, control proceeds to block 2512. Otherwise (e.g., if the wireless measurement engine circuitry 200 determines to switch from the first network to a second network based on the outputs), control proceeds to block 2510.

In the illustrated example of FIG. 25, at block 2510, the wireless measurement engine circuitry 200 causes the wireless device(s) to switch from the first network to the second network. For example, at block 2510, the event generation circuitry 250 (FIG. 2) can generate an event representative of an instruction to cause the wireless device 502 to switch from a 5G network to a Wi-Fi network. At block 2512, the wireless measurement engine circuitry 200 determines whether to change a configuration of the first network to achieve improved performance. For example, if, at block 2512, a receive power of the first gNB 504 can be increased to improve performance associated with communication between the wireless device 502 and the first gNB 504, then the wireless measurement determination circuitry 240 can determine to change the receive power of the first gNB 504.

In the illustrated example of FIG. 25, if, at block 2512, the wireless measurement engine circuitry 200 determines not to change a configuration of the first network to achieve improved performance, control proceeds to block 2516. Otherwise (e.g., if the wireless measurement engine circuitry 200 determines to change a configuration of the first network to achieve improved performance), control proceeds to block 2514. At block 2514, the wireless measurement engine circuitry 200 changes the configuration of the first network. For example, at block 2514, the event generation circuitry 250 generates an event representative of an instruction to cause the first gNB 504 to increase a receive power of one or more antennas of the first gNB 504.

In the illustrated example of FIG. 25, at block 2516, the wireless measurement engine circuitry 200 causes storage of at least one of the wireless measurements, the outputs, the configuration, or network selection in a datastore for application access. For example, at block 2516, the wireless measurement determination circuitry 240 causes storage of at least one of the wireless physical layer measurements 264, the outputs, the configuration, or network selection in the datastore 260 (FIG. 2), which can be accessed by hardware (e.g., electronic device(s)), software (e.g., service(s), application(s), etc.), and/or firmware. At block 2518, the wireless measurement engine circuitry 200 determines whether to continue monitoring the wireless device(s). For example, at block 2518, the interface circuitry 210 (FIG. 2) determines whether additional wireless data is to be received from the wireless device 502. In some examples, the determination can be based on an SLA associated with the wireless device 502. If, at block 2518, the wireless measurement engine circuitry 200 determines to continue monitoring the wireless device(s), control returns to block 2502. Otherwise (e.g., if the wireless measurement engine circuitry 200 determines not to continue monitoring the wireless device(s)), the example machine-readable instructions and/or the example operations 2500 of FIG. 25 conclude.

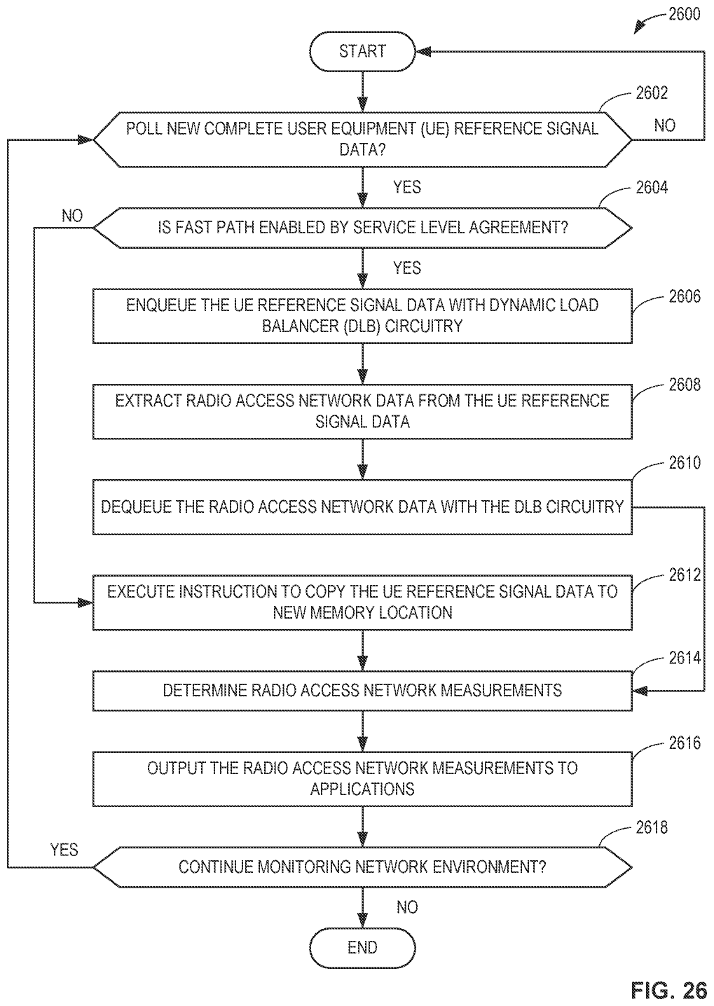

FIG. 26 is a flowchart representative of example machine-readable instructions and/or example operations 2600 that may be executed and/or instantiated by processor circuitry to implement the wireless measurement engine circuitry 200 of FIG. 2 to determine wireless measurements. The example machine-readable instructions and/or the example operations 2600 of FIG. 26 begin at block 2602, at which the wireless measurement engine circuitry 200 of FIG. 2 determines whether to poll new complete user equipment reference signal (e.g., SRS) data. For example, at block 2602, the interface circuitry 210 (FIG. 2) determines whether to poll new complete reference signal (e.g., SRS) data associated with one or more UEs.

In the illustrated example of FIG. 26, if, at block 2602, the wireless measurement engine circuitry 200 determines not to poll new complete user equipment reference signal data, control waits at block 2602. Otherwise (e.g., if the wireless measurement engine circuitry 200 determines to poll new complete user equipment reference signal data), control proceeds to block 2604. At block 2604, the wireless measurement engine circuitry 200 determines whether a fast path is enabled by a service level agreement. For example, at block 2604, the parser circuitry 220 (FIG. 2) determines whether an SLA that is in effect for a particular application allows and/or unlocks (e.g., unlocks via an SDSi technique as disclosed herein) the processing of reference signal data with improved efficiency and throughput with reduced latency. In some examples, the parser circuitry 220 determines that the fast path is enabled and corresponds to a hardware efficient reference signal data processing feature, which can be implemented by DLB circuitry as disclosed herein.

In the illustrated example of FIG. 26, if, at block 2604, the wireless measurement engine circuitry 200 determines that a fast path is enabled by a service level agreement, control proceeds to block 2606. At block 2606, the wireless measurement engine circuitry 200 enqueues the UE reference signal data with dynamic load balancer (DLB) circuitry. For example, at block 2606, the parser circuitry 220 enqueues the UE SRS data using hardware. In some examples, at block 2606, the DLB circuitry 1214 of FIG. 12A, which can be included in and/or implemented by the parser circuitry 220, enqueues the UE #2 L1 wireless data of FIG. 12A into a first data queue. In some examples, the first data queue can be associated with one of the worker cores of the multi-core processor circuitry 1208, such as the worker core identified as UE1 in FIG. 12A.

In the illustrated example of FIG. 26, at block 2608, the wireless measurement engine circuitry 200 extracts radio access network data from the UE reference signal data. For example, at block 2608, the parser circuitry 220 extracts SRS data from the UE #2 L1 wireless data of FIG. 12A. In some examples, worker core UE1 of FIG. 12A executes and/or instantiates one or more computing tasks, instructions, etc., on the UE #2 L1 wireless data of FIG. 12A to output the extracted SRS data. At block 2610, the wireless measurement engine circuitry 200 dequeues the location data with the DLB circuitry. For example, at block 2610, the parser circuitry 220 dequeues the SRS data from the first data queue to a second data queue using hardware. In some examples, the second data queue can be associated with a core of the multi-core processor circuitry 1208, such as the TX core 1212 of FIG. 12A. After dequeuing the radio access network data with the DLB circuitry at block 2610, control proceeds to block 2614.

In the illustrated example of FIG. 26, if, at block 2604, the wireless measurement engine circuitry 200 determines that a fast path is not enabled by a service level agreement, control proceeds to block 2612. At block 2612, the wireless measurement engine circuitry 200 executes an instruction to copy the UE reference signal data to a new memory location, which may be carried out with reduced efficiency with respect to the fast path as described above. For example, at block 2612, the parser circuitry 220 executes a MEMCPY instruction to copy the UE SRS data, or portion(s) thereof, to memory in the multi-core processor circuitry 1208 and/or memory not included in the multi-core processor circuitry 1208.

In the illustrated example of FIG. 26, at block 2614, the wireless measurement engine circuitry 200 determines radio access network measurements. For example, at block 2614, the wireless measurement determination circuitry 240 (FIG. 2) determines the wireless physical layer measurements 264 (FIG. 2) based on the UE SRS data. In some examples, the wireless measurement determination circuitry 240 estimates, determines, and/or predicts the wireless physical layer measurements 264 by executing and/or instantiating the ML model 266 with the UE SRS data as input(s) to generate output(s), which can include the wireless physical layer measurements 264.

In the illustrated example of FIG. 26, at block 2616, the wireless measurement engine circuitry 200 outputs the radio access network measurements to applications. For example, at block 2616, the interface circuitry 210 (FIG. 2) provides the estimate, determination, prediction, etc., of the wireless physical layer measurements 264 to a GUI executed and/or instantiated by an application/service as disclosed herein. At block 2618, the wireless measurement engine circuitry 200 determines whether to continue monitoring a network environment. If, at block 2618, the wireless measurement engine circuitry 200 determines to continue monitoring the network environment, control returns to block 2602. Otherwise (e.g., if the wireless measurement engine circuitry 200 determines not to continue monitoring the network environment), the example machine-readable instructions and/or the example operations 2600 of FIG. 26 conclude.

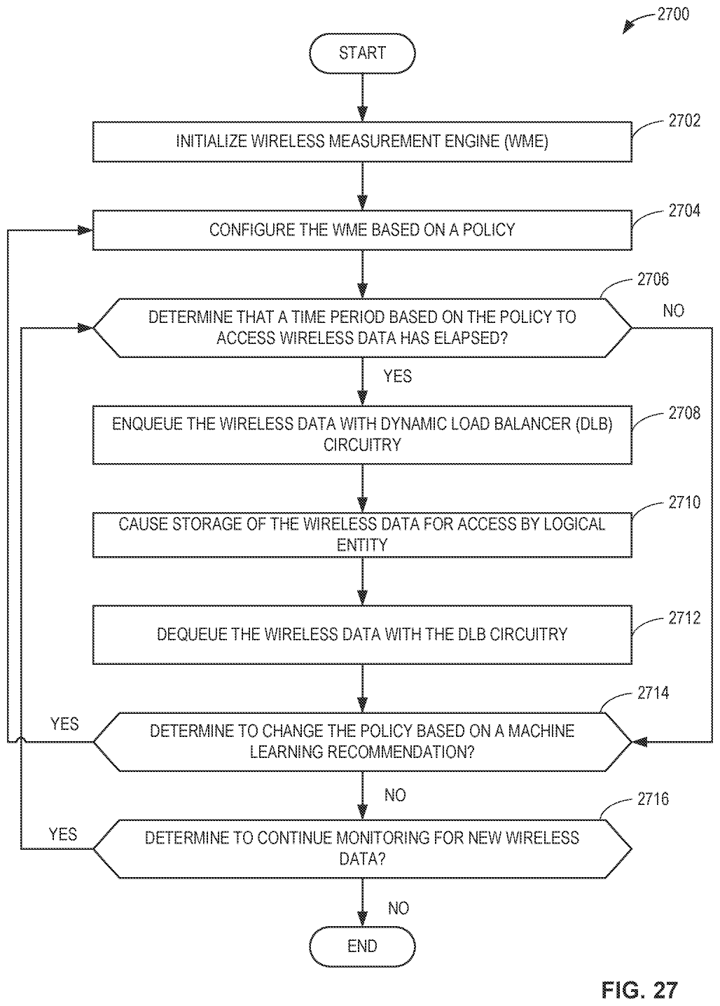

FIG. 27 is a flowchart representative of example machine-readable instructions and/or example operations 2700 that may be executed and/or instantiated by processor circuitry to implement the wireless measurement engine circuitry 200 of FIG. 2 to determine wireless measurements. The example machine-readable instructions and/or the example operations 2700 of FIG. 27 begin at block 2702, at which the wireless measurement engine circuitry 200 initializes a wireless measurement engine (WME). For example, a block 2702, the wireless measurement engine circuitry 200 can execute, instantiate and/or implement the wireless measurement engine 930 of FIG. 9 or any other wireless measurement engine as disclosed herein.

In the illustrated example of FIG. 27, at block 2706, the wireless measurement engine circuitry 200 configures the wireless measurement engine based on a policy. For example, at block 2706, the parser circuitry 220 (FIG. 2) can be configured to parse L1 wireless data (e.g., 5G SRS data, L1 Wi-Fi data, etc.) substantially instantaneously and/or simultaneously with the receipt of the L1 wireless data by the interface circuitry 210 (FIG. 2) based on an SLA. In some examples, at block 2706, the parser circuitry 220 can be configured and/or programmed to parse L1 wireless data periodically (e.g., every minute, every hour, every day, etc.) based on an SLA.

In the illustrated example of FIG. 27, at block 2706, the wireless measurement engine circuitry 200 determines whether a time period based on the policy to access wireless data has elapsed. For example, if the time period to access L1 wireless data indicated by the SLA is one hour, then, at block 2706, the parser circuitry 220 determines whether an hour has elapsed since L1 wireless data was last accessed. In some examples, the parser circuitry 220 can determine that one hour has elapsed since the last access of the L1 wireless data and thereby the parser circuitry 220 is to access the available L1 wireless data received by the interface circuitry 210. In some examples, the parser circuitry 220 can access the L1 wireless data substantially instantaneously and/or simultaneously with the receipt of new L1 wireless data (e.g., the parser circuitry 220 can access the L1 wireless data every clock and/or processor clock cycle, computational cycle, etc.).

In the illustrated example of FIG. 27, if, at block 2706, the wireless measurement engine circuitry 200 determines that the time period based on the policy to access wireless data has not elapsed, control proceeds to block 2714. If, at block 2706, the wireless measurement engine circuitry 200 determines that the time period based on the policy to access wireless data has elapsed, then, at block 2708, the wireless measurement engine circuitry 200 enqueues the wireless data with dynamic load balancer (DLB) circuitry. For example, at block 2708, the parser circuitry 220 enqueues the L1 wireless data using hardware to cause one or more worker compute cores to carry out processing tasks on the L1 wireless data with reduced latency and/or increased throughput. In some examples, the parser circuitry 220 enqueues the L1 wireless data by enqueuing a data pointer to a queue implemented using hardware with the data pointer referencing a UE associated with the L1 wireless data, the L1 wireless data, and/or any combination(s) thereof. In some examples, the data pointer can point, correspond to, and/or otherwise reference a memory location at which the L1 wireless data associated with the UE is stored and can be accessed by worker compute core(s).

In the illustrated example of FIG. 27, at block 2710, the wireless measurement engine circuitry 200 causes storage of the wireless data for access by a logical entity. For example, at block 2710, the parser circuitry 220 causes storage of and/or otherwise copies the L1 wireless data to a new memory or mass storage location. In some examples, a logical entity such as other hardware, software, and/or firmware can access the copied L1 wireless data. For example, an API can be invoked by an application to access the copied L1 wireless data for location determination operations in connection with one or more UEs. In some examples, a VM instantiated by a RAN server can poll and/or otherwise request the copied L1 wireless data for wireless measurement determination operations in connection with one or more UEs.

In the illustrated example of FIG. 27, at block 2712, the wireless measurement engine circuitry 200 dequeues the wireless data with the DLB circuitry. For example, at block 2712, the parser circuitry 220 dequeues the L1 wireless data by dequeuing the data pointer from the queue in response to receiving an indication that the L1 wireless data has been stored in the new memory or mass storage location. In some examples, the indication (e.g., an alert, a data bit written into a data structure, a hardware interrupt, data generation representative of the indication, etc.) is generated after the worker compute core(s) completed processing task(s) on the L1 wireless data. At block 2714, the wireless measurement engine circuitry 200 determines whether to change the policy based on a machine learning recommendation. For example, at block 2714, the wireless measurement determination circuitry 240 (FIG. 2) can determine, using the ML model 266, that a change to the SLA is needed for improved efficiency and/or accuracy of wireless measurement operations in connection with one or more UEs. For example, the ML model 266 can process the L1 wireless data to determine the change to the SLA for improved efficiency and/or accuracy of wireless measurement determination operations.

In the illustrated example of FIG. 27, if, at block 2714, the wireless measurement engine circuitry 200 determines to change the policy based on a machine learning recommendation, control returns to block 2704 to configure the wireless measurement engine based on the AI/ML recommended change to the policy. Otherwise (e.g., if the wireless measurement engine circuitry 200 determines not to change the policy based on a machine learning recommendation), control proceeds to block 2716. At block 2716, the wireless measurement engine circuitry 200 determines whether to continue monitoring for new wireless data. If, at block 2716, the wireless measurement engine circuitry 200 determines to continue monitoring for new wireless data, control returns to block 2706. Otherwise (e.g., if the wireless measurement engine circuitry 200 determines not to continue monitoring for new wireless data), the example machine-readable instructions and/or the example operations 2700 of FIG. 27 conclude.

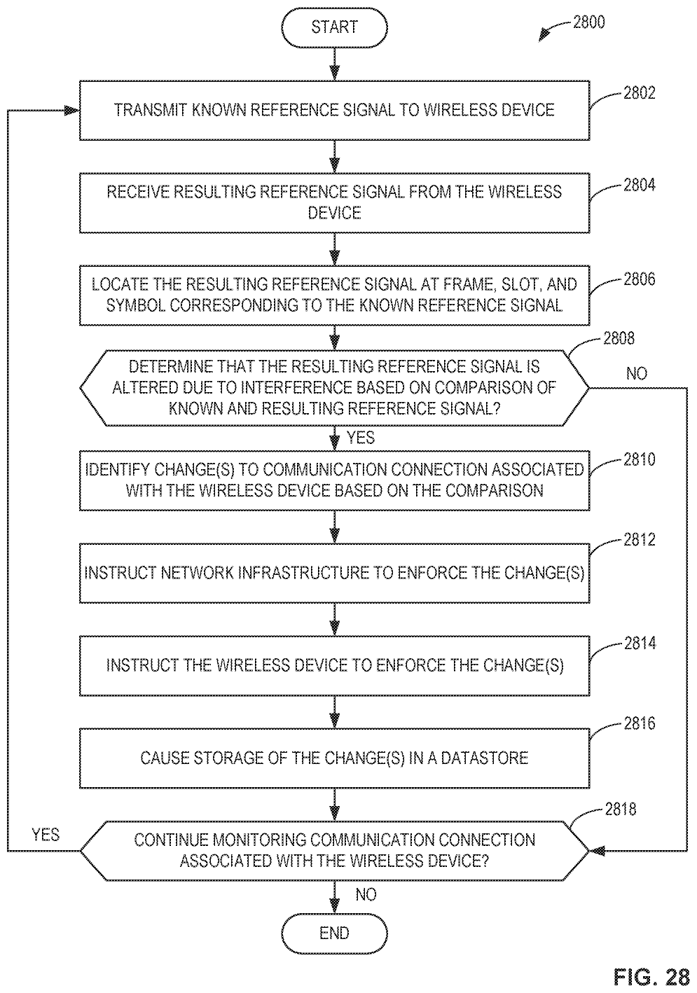

FIG. 28 is a flowchart representative of example machine-readable instructions and/or example operations 2800 that may be executed and/or instantiated by processor circuitry to implement the wireless measurement engine circuitry 200 of FIG. 2 to change a communication connection associated with a wireless device based on a reference signal comparison. The example machine-readable instructions and/or the example operations 2800 of FIG. 28 begin at block 2802, at which the wireless measurement engine circuitry 200 transmits a known reference signal to a wireless device. For example, at block 2802, the interface circuitry 210 (FIG. 2) generates a first SRS signal that, when received by a wireless device, causes the wireless device to transmit a second SRS signal back to the interface circuitry 210 at a specified and/or defined frame and slot (e.g., communication frame and communication slot).

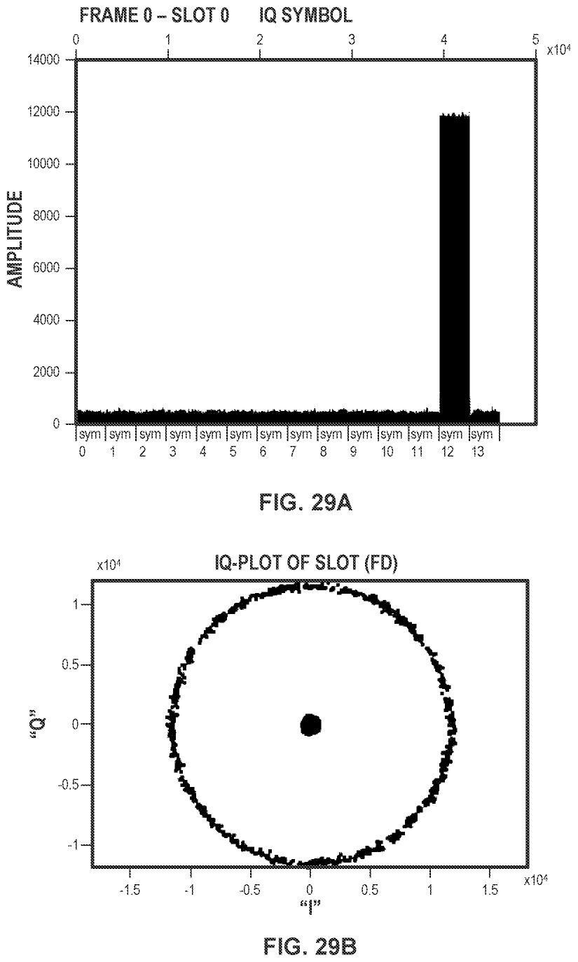

Additionally or alternatively, at block 2802, one of the DUs 810, which may implement the wireless measurement engine circuitry 200, transmits a known reference (e.g., SRS) signal to one of the wireless devices 802. The known reference (e.g., SRS) signal transmitted by the one of the DUs 810 is referred to as a known reference signal because the particulars of the reference signal are known by the one of the DUs 810, stored in the datastore 260 (FIG. 2) for future referencing and/or looking up, etc. In some examples, the interface circuitry 210 transmits and/or causes transmission of the reference (e.g., SRS) signal from one of the DUs 810 of FIG. 8 to one of the wireless devices 802 of FIG. 8. An example of the known reference signal is depicted in FIG. 29A. An example of the known reference signal of FIG. 29A in IQ representation is depicted in FIG. 29B.

In the illustrated example of FIG. 28, at block 2804, the wireless measurement engine circuitry 200 receives a resulting reference signal from the wireless device. For example, after one of the wireless devices 802 receives the known SRS signal from the one of the DUs 810, the one of the wireless devices 802 can retransmit the known SRS signal back to the one of the DUs 810 at the specified and/or defined frame, slot, and symbol. In some examples, the known reference (e.g., SRS) signal transmitted from the one of the wireless devices 802 to the one of the DUs 810 is referred to as a resulting reference (e.g., SRS) signal.

In the illustrated example of FIG. 28, at block 2806, the wireless measurement engine circuitry 200 locates the resulting reference signal at a frame, slot, and symbol corresponding to the known reference signal. For example, at block 2806, the parser circuitry 220 (FIG. 2) identifies the frame, slot, and symbol that corresponds to the known reference signal because the resulting reference (e.g., SRS) signal is expected to be received in a particular frame at a particular slot. In some examples, after the resulting reference signal is received by the interface circuitry 210, the parser circuitry 220 can identify that the resulting reference signal is received by looking at the specified frame, slot, and symbol that corresponds to the known reference signal. For example, Table 1 illustrates an example format of the wireless physical layer data 262 of FIG. 2 which may be parsed by the parser circuitry 220 to identify the resulting reference signal.

TABLE 1

| Fr Slot Sym | Chan Info | Tput Carr 0 | UE 17020 Carr 0 |
|---|---|---|---|
| (896, 5, 0) DL | 0 1 1 1 | 0 2 320 | |
| | | 1 2 0 | |
| (896, 4, 0) UL | 0 0 1 1 | 0 0 0 | RS 1(256 1 13 0 59)(2 12 0 0) |
| | | | (144 0 X X) (0 0 0 0)(23.53) |

Table 1 may be interpreted according to the legend illustrated in Table 2.

TABLE 2
Reference Signal: (2 Lines)

| Line 1 Format: | Line 2 Format: |
|---|---|
| \| A B (C D E F) (G H I J) \| | \| (A B C D) (E F G H)(I) \| |
| A = RS - Indicates Reference Signal | A = nStartSc, port 0, sym 0 |
| B = nPorts | B = nStartSc, port 1, sym 0 |
| C = nPRBs | C = nStartSc, port 0, sym 1 |
| D = nSymNum | D = nStartSc, port 1, sym 1 |
| E = nBsrs | E = nRefSigGroupSeqHop |
| F = nCsrs | F = nKtcbar |
| G = nComb | G = nStartPos |
| H = sShift | H = nBhop |
| I = nFreqPos | I = fSnr (WideBand SNR) |
| J = nCyclicShift | |

Read together, Table 1 and Table 2 indicate that UE 17020 had an SNR of 23.53 during uplink in frame 896, slot 4, symbol 0. By including the field A in Line 1 (e.g., RS), the wireless data (e.g., the wireless physical layer data 262 generated by the wireless measurement engine circuitry 200) indicates a specific symbol position, in a specific slot, of a specific frame that is experiencing communication problems on a per UE basis. As such, the wireless measurement engine circuitry 200 can analyze the wireless data (e.g., the wireless data represented in Table 1) to determine whether the resulting reference signal from a UE is altered. For example, at block 2808, the wireless measurement engine circuitry 200 determines whether the resulting reference signal is altered due to interference based on comparison of known and resulting reference signal. In the example of FIG. 28, if the wireless measurement determination circuitry 240 (FIG. 2) determines that the resulting reference signal matches the known reference signal, then the wireless measurement determination circuitry 240 (FIG. 2) determines that the known reference signal transmitted by the one of the wireless devices 802 was not altered due to interference. An example resulting reference signal that was transmitted without interference would appear similarly to the known reference signal depicted in FIGS. 29A and 29B.

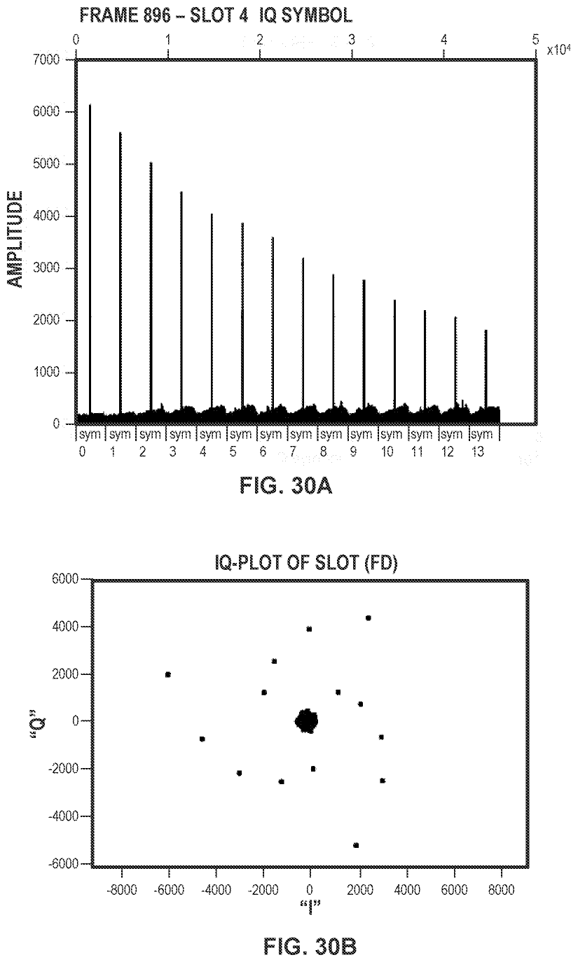

Additionally, for example, if the wireless measurement determination circuitry 240 (FIG. 2) determines that the resulting reference signal does not match the known reference signal, then the wireless measurement determination circuitry 240 (FIG. 2) determines that the known reference signal transmitted by the one of the wireless devices 802 was altered due to interference, which resulted in the receiving of the resulting reference signal. FIG. 30A illustrates an example resulting reference signal that does not include expected data at a frame, slot, and symbol corresponding to a known reference signal. An example of the resulting reference signal of FIG. 30A in IQ representation is depicted in FIG. 30B. For example, FIG. 30B depicts comparison(s) of the resulting reference signal in FIG. 30A to the known reference signal in FIG. 29A to yield the plot in FIG. 30B. For example, the scatter of data points depicted around the origin of the plot of FIG. 30B (e.g., coordinates (0,0)) illustrates the interference associated with the transmission of the reference signal from the one of the wireless devices 802 to the one of the DUs 810.

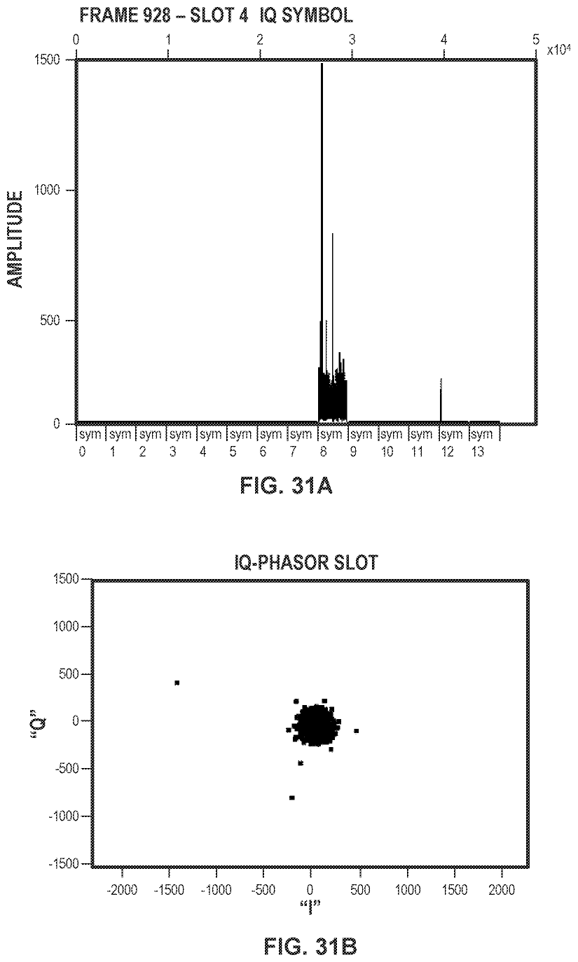

In some examples, the resulting reference signal may include data at an unexpected frame, slot, and symbol that does not correspond to the known reference signal. An example resulting reference signal including data in an unexpected frame, slot, and symbol is depicted in FIG. 31A. An example of the resulting reference signal of FIG. 31A in IQ representation is depicted in FIG. 31B. For example, FIG. 31B depicts comparison(s) of the resulting reference signal in FIG. 31A to the known reference signal in FIG. 29A to yield the plot in FIG. 31B. For example, the lack of data points depicted around the origin of the plot of FIG. 31B (e.g., coordinates (0,0)) illustrates the data in the resulting reference signal being in an unexpected frame, slot, and symbol.

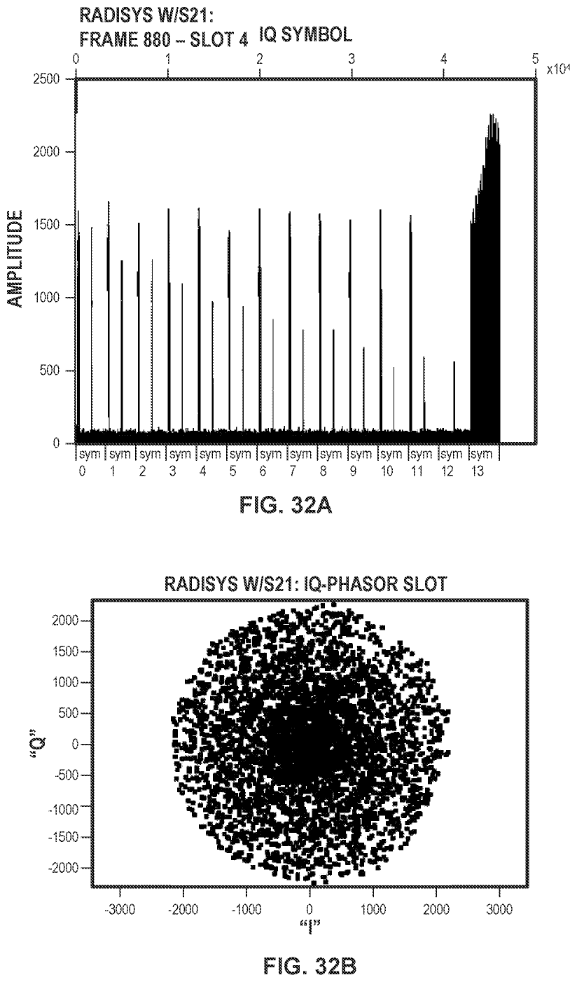

In additional or alternative examples, the resulting reference signal may include data at the expected frame and slot that corresponds to the known reference signal but may be noisy. An example noisy resulting reference signal including data in the expected frame, slot, and symbol is depicted in FIG. 32A. An example of the resulting reference signal of FIG. 32A in IQ representation is depicted in FIG. 32B. For example, FIG. 32B depicts comparison(s) of the resulting reference signal in FIG. 32A to the known reference signal in FIG. 29A to yield the plot in FIG. 32B. For example, the dense distribution of data points depicted around the origin of the plot of FIG. 32B (e.g., coordinates (0,0)) illustrates the noise associated with the transmission of the reference signal from the one of the wireless devices 802 to the one of the DUs 810.

In the illustrated example of FIG. 28, if, at block 2808, the wireless measurement engine circuitry 200 determines that the resulting reference signal is not altered due to interference based on comparison of known and resulting reference signal, control proceeds to block 2818. Otherwise (e.g., if the wireless measurement engine circuitry 200 determines that the resulting reference signal is altered due to interference), control proceeds to block 2810. At block 2810, the wireless measurement engine circuitry 200 identifies change(s) to a communication connection associated with the wireless device based on the comparison. For example, at block 2810, the wireless measurement determination circuitry 240 determines to change a timing and/or scheduling of data transmissions, a phase of one or more antennas, power settings of the one or more antennas, cause beam forming to occur, change existing beam forming, etc., based on the comparison. For example, the wireless measurement determination circuitry 240 can determine to change a transmit power of an antenna of the one of the wireless devices 802 and/or a receive power of an antenna of one(s) of the RRHs 804 of FIG. 8 to mitigate and/or otherwise reduce the impact of interference on communication transmissions associated with the one of the wireless devices 802.

In the illustrated example of FIG. 28, at block 2812, the wireless measurement engine circuitry 200 instructs network infrastructure to enforce the change(s). For example, at block 2812, the event generation circuitry 250 (FIG. 2) generates event data representative of a command, a direction, an instruction, etc., to cause network infrastructure, such as one(s) of the DUs 810 of FIG. 8, to effectuate and/or otherwise enforce the change(s) determined by the wireless measurement determination circuitry 240. For example, the one(s) of the DUs 810 can cause transmission of data to the RRHs 804 to cause the one(s) of the RRHs 804 to increase a receive power of an antenna of the one(s) of the RRHs 804 to optimize and/or otherwise improve the communication connection to the wireless device 802 of FIG. 8.

In the illustrated example of FIG. 28, at block 2814, the wireless measurement engine circuitry 200 instructs the wireless device to enforce the change(s). For example, at block 2814, the event generation circuitry 250 generates event data representative of a command, a direction, an instruction, etc., to cause the wireless device 802 to effectuate and/or otherwise enforce the change(s) determined by the wireless measurement determination circuitry 240. For example, the one(s) of the DUs 810 cause transmission of data to the wireless device 802 to cause the wireless device 802 to increase a transmit power of an antenna of the wireless device 802 to optimize and/or otherwise improve the communication connection to the RRHs 804 of FIG. 8.

In the illustrated example of FIG. 28, at block 2816, the wireless measurement engine circuitry 200 causes storage of the change(s) in a datastore. For example, at block 2816, the wireless measurement determination circuitry 240 causes storage of the change(s) to the wireless device 802, the one(s) of the RRHs 804, etc., in the datastore 260 as the wireless physical layer measurements 264 (FIG. 2). At block 2818, the wireless measurement engine circuitry 200 determines whether to continue monitoring a communication connection associated with the wireless device. For example, at block 2818, the interface circuitry 210 determines whether to transmit another known reference signal to the wireless device (e.g., control returns to block 2802). In some examples, the interface circuitry 210 determines whether another resulting reference signal is to be received (e.g., control returns to block 2804).

In the illustrated example of FIG. 28, if, at block 2818, the wireless measurement engine circuitry 200 determines to continue monitoring a communication connection associated with the wireless device, control returns to block 2802. Otherwise (e.g., if the wireless measurement engine circuitry 200 determines not to continue monitoring a communication connection associated with the wireless device), the example machine-readable instructions and/or the example operations 2800 of FIG. 28 conclude. As disclosed in FIG. 28, the wireless measurement engine circuitry 200 can detect unhealthy signal and/or symbol position. As such, the wireless measurement engine circuitry 200 can monitor communication quality in each slot in each frame for each UE to diagnose issues occurring with network infrastructure and/or wireless devices in the network. Additionally, by evaluating the IQ representations of reference signals, the wireless measurement engine circuitry 200 determines the changes to the network infrastructure and/or wireless devices in the network to improve communication quality.

Accordingly, the wireless measurement engine circuitry 200 can remediate issues occurring with network infrastructure and/or wireless devices in the network without a person having to be physically present in the field to interact with the network infrastructure (e.g., a physical cell tower).

FIG. 33 is a block diagram of an example of components that may be present in an IoT device 3350 for implementing the techniques described herein. In some examples, the IoT device 3350 may include and/or implement the wireless measurement engine circuitry 200 of FIG. 2. The IoT device 3350 may include any combinations of the components shown in the example or referenced in the disclosure above. The components may be implemented as ICs, portions thereof, discrete electronic devices, or other modules, logic, hardware, software, firmware, or a combination thereof adapted in the IoT device 3350, or as components otherwise incorporated within a chassis of a larger system. Additionally, the block diagram of FIG. 33 is intended to depict a high-level view of components of the IoT device 3350. However, some of the components shown may be omitted, additional components may be present, and different arrangement of the components shown may occur in other implementations.

The IoT device 3350 may include processor circuitry in the form of, for example, a processor 3352, which may be a microprocessor, a multi-core processor, a multithreaded processor, an ultra-low voltage processor, an embedded processor, or other known processing elements. The processor 3352 may be a part of a system on a chip (SoC) in which the processor 3352 and other components are formed into a single integrated circuit, or a single package, such as the Edison™ or Galileo™ SoC boards from Intel. As an example, the processor 3352 may include an Intel® Architecture Core™ based processor, such as a Quark™, an Atom™, an i3, an i5, an i7, or a Microcontroller Unit (MCU) class (MCU-class) processor, or another such processor available from Intel® Corporation, Santa Clara, CA. However, any number other processors may be used, such as available from Advanced Micro Devices, Inc. (AMD) of Sunnyvale, CA, a Microprocessor without Interlocked Pipelined Stages (MIPS) based (MIPS-based) design from MIPS Technologies, Inc. of Sunnyvale, CA, an ARM-based design licensed from ARM Holdings, Ltd. Or customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc.

The processor 3352 may communicate with a system memory 3354 over an interconnect 3356 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., low power DDR (LPDDR), LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 3358 may also couple to the processor 3352 via the interconnect 3356. In an example the storage 3358 may be implemented via a solid state disk drive (SSDD). Other devices that may be used for the storage 3358 include flash memory cards, such as SD cards, microSD cards, xD picture cards, and the like, and USB flash drives. In low power implementations, the storage 3358 may be on-die memory or registers associated with the processor 3352. However, in some examples, the storage 3358 may be implemented using a micro hard disk drive (HDD). Further, any number of new technologies may be used for the storage 3358 in addition to, or instead of, the technologies described, such resistance change memories, phase change memories, holographic memories, or chemical memories, among others.

The components may communicate over the interconnect 3356. The interconnect 3356 may include any number of technologies, including industry standard architecture (ISA), extended ISA (EISA), peripheral component interconnect (PCI), peripheral component interconnect extended (PCIx), PCI express (PCIe), or any number of other technologies. The interconnect 3356 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 3362, 3366, 3368, or 3370. Accordingly, in various examples, applicable means for communicating (e.g., receiving, transmitting, etc.) may be embodied by such communications circuitry.

The interconnect 3356 may couple the processor 3352 to a mesh transceiver 3362, for communications with other mesh devices 3364. The mesh transceiver 3362 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 3364. For example, a wireless LAN (WLAN) unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a wireless WAN (WWAN) unit.

The mesh transceiver 3362 may communicate using multiple standards or radios for communications at different range. For example, the IoT device 3350 may communicate with close devices, e.g., within about 10 meters, using a local transceiver based on BLE, or another low power radio, to save power. More distant mesh devices 3364, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 3366 may be included to communicate with devices or services in the cloud 3300 via local or wide area network protocols. The wireless network transceiver 3366 may be a Low-Power Wide-Area (LPWA) transceiver that follows the IEEE 802.15.4, or IEEE 802.15.4g standards, among others. The IoT device 3350 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 3362 and wireless network transceiver 3366, as disclosed herein. For example, the radio transceivers 3362 and 3366 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 3362 and 3366 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Area radio communication technology, which may include e.g. a 5^{th} Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 3366, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 3368 may be included to provide a wired communication to the cloud 3300 or to other devices, such as the mesh devices 3364. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 3368 may be included to allow connect to a second network, for example, a NIC 3368 providing communications to the cloud over Ethernet, and a second NIC 3368 providing communications to other devices over another type of network.

The interconnect 3356 may couple the processor 3352 to an external interface 3370 that is used to connect external devices or subsystems. The external devices may include sensors 3372, such as accelerometers, level sensors, flow sensors, optical light sensors, camera sensors, temperature sensors, global positioning system (GPS) sensors, pressure sensors, barometric pressure sensors, and the like. The external interface 3370 further may be used to connect the IoT device 3350 to actuators 3374, such as power switches, valve actuators, an audible sound generator, a visual warning device, and the like.

In some optional examples, various input/output (I/O) devices may be present within, or connected to, the IoT device 3350. For example, a display or other output device 3384 may be included to show information, such as sensor readings or actuator position. An input device 3386, such as a touch screen or keypad may be included to accept input. An output device 3386 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 3350.

A battery 3376 may power the IoT device 3350, although in examples in which the IoT device 3350 is mounted in a fixed location, it may have a power supply coupled to an electrical grid. The battery 3376 may be a lithium ion battery, or a metal-air battery, such as a zinc-air battery, an aluminum-air battery, a lithium-air battery, and the like.

A battery monitor/charger 3378 may be included in the IoT device 3350 to track the state of charge (SoCh) of the battery 3376. The battery monitor/charger 3378 may be used to monitor other parameters of the battery 3376 to provide failure predictions, such as the state of health (SoH) and the state of function (SoF) of the battery 3376. The battery monitor/charger 3378 may include a battery monitoring integrated circuit, such as an LTC4020 or an LTC2990 from Linear Technologies, an ADT7488A from ON Semiconductor of Phoenix, Arizona, or an IC from the UCD90xxx family from Texas Instruments of Dallas, TX. The battery monitor/charger 3378 may communicate the information on the battery 3376 to the processor 3352 over the interconnect 3356. The battery monitor/charger 3378 may also include an analog-to-digital (ADC) convertor that allows the processor 3352 to directly monitor the voltage of the battery 3376 or the current flow from the battery 3376. The battery parameters may be used to determine actions that the IoT device 3350 may perform, such as transmission frequency, mesh network operation, sensing frequency, and the like.

A power block 3380, or other power supply coupled to a grid, may be coupled with the battery monitor/charger 3378 to charge the battery 3376. In some examples, the power block 3380 may be replaced with a wireless power receiver to obtain the power wirelessly, for example, through a loop antenna in the IoT device 3350. A wireless battery charging circuit, such as an LTC4020 chip from Linear Technologies of Milpitas, CA, among others, may be included in the battery monitor/charger 3378. The specific charging circuits chosen depends on the size of the battery 3376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 3358 may include instructions 3382 in the form of software, firmware, or hardware commands to implement the techniques described herein. Although such instructions 3382 are shown as code blocks included in the memory 3354 and the storage 3358, it may be understood that any of the code blocks may be replaced with hardwired circuits, for example, built into an ASIC.

In an example, the instructions 3382 provided via the memory 3354, the storage 3358, or the processor 3352 may be embodied as a non-transitory, machine-readable medium 3360 including code to direct the processor 3352 to perform electronic operations in the IoT device 3350. The processor 3352 may access the non-transitory, machine-readable medium 3360 over the interconnect 3356. For instance, the non-transitory, machine-readable medium 3360 may be embodied by devices described for the storage 3358 of FIG. 33 or may include specific storage units such as optical disks, flash drives, or any number of other hardware devices. The non-transitory, machine-readable medium 3360 may include instructions to direct the processor 3352 to perform a specific sequence or flow of actions, for example, as described with respect to the flowchart(s) and block diagram(s) of operations and functionality depicted above.

Also in a specific example, the instructions 3382 on the processor 3352 (separately, or in combination with the instructions 3382 of the machine-readable medium 3360) may configure execution or operation of a trusted execution environment (TEE) 3390. In an example, the TEE 3390 operates as a protected area accessible to the processor 3352 for secure execution of instructions and secure access to data. Various implementations of the TEE 3390, and an accompanying secure area in the processor 3352 or the memory 3354 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the IoT device 3350 through the TEE 3390 and the processor 3352.

FIG. 34 is a block diagram of an example processor platform 3400 structured to execute and/or instantiate the example machine-readable instructions and/or the example operations of FIGS. 23-28 to implement the wireless measurement engine circuitry 200 of FIG. 2. The processor platform 3400 can be, for example, a server, a radio unit (e.g., a remote radio unit), a radio access network device, a distributed unit, a centralized unit, a core device or server, a personal computer, a workstation, a self-learning machine (e.g., a neural network), a mobile device (e.g., a cell phone, a smart phone, a tablet such as an iPad™), or any other type of computing device. In some examples, the processor platform 3400 can be a baseband unit or an access point.

The processor platform 3400 of the illustrated example includes processor circuitry 3412. The processor circuitry 3412 of the illustrated example is hardware. For example, the processor circuitry 3412 can be implemented by one or more integrated circuits, logic circuits, FPGAs, microprocessors, CPUs, GPUs, DSPs, and/or microcontrollers from any desired family or manufacturer. The processor circuitry 3412 may be implemented by one or more semiconductor based (e.g., silicon based) devices. In this example, the processor circuitry 3412 implements the parser circuitry 220, the device identification circuitry 230 (identified by DEVICE ID CIRCUITRY), the wireless measurement determination circuitry 240 (identified by WM DETERM CIRCUITRY), and the event generation circuitry 250 (identified by EVENT GEN CIRCUITRY) of FIG. 2. In some examples, the processor circuitry 3412 can be referred to as access point circuitry or baseband unit circuitry.

The processor circuitry 3412 of the illustrated example includes a local memory 3413 (e.g., a cache, registers, etc.). The processor circuitry 3412 of the illustrated example is in communication with a main memory including a volatile memory 3414 and a non-volatile memory 3416 by a bus 3418. In some examples, the bus 3418 can implement the bus 270 of FIG. 2. The volatile memory 3414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3416 may be implemented by flash memory and/or any other desired type of memory device. Access to the main memory 3414, 3416 of the illustrated example is controlled by a memory controller 3417.

The processor platform 3400 of the illustrated example also includes interface circuitry 3420. The interface circuitry 3420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 3420 implements the interface circuitry 210 of FIG. 2.

In the illustrated example, one or more input devices 3422 are connected to the interface circuitry 3420. The input device(s) 3422 permit(s) a user to enter data and/or commands into the processor circuitry 3412. The input device(s) 3422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 3424 are also connected to the interface circuitry 3420 of the illustrated example. The output device(s) 3424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3420 of the illustrated example, thus, typically includes a graphics driver card, a graphics driver chip, and/or graphics processor circuitry such as a GPU.

The interface circuitry 3420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 3400 of the illustrated example also includes one or more mass storage devices 3428 to store software and/or data. Examples of such mass storage devices 3428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 3428 implement the datastore 260, the wireless physical layer data 262, the wireless physical layer measurements 264, and the ML model 266 of FIG. 2.

The machine-readable instructions 3432, which may be implemented by the machine-readable instructions of FIGS. 23-28, may be stored in the mass storage device 3428, in the volatile memory 3414, in the non-volatile memory 3416, and/or on a removable non-transitory computer-readable storage medium such as a CD or DVD. Additionally and/or alternatively, the processor platform 3400 of FIG. 34 may include any other type and/or quantity of hardware circuitry, such as acceleration circuitry (e.g., FPGAs, GPUs, neural network accelerators, vision processing units, etc.).

The processor platform 3400 of the illustrated example of FIG. 34 includes example acceleration circuitry 3440, which includes an example graphics processing unit (GPU) 3442, an example vision processing unit (VPU) 3444, and an example neural network processor 3446. In this example, the GPU 3442, the VPU 3444, and the neural network processor 3446 are in communication with different hardware of the processor platform 3400, such as the volatile memory 3414, the non-volatile memory 3416, etc., via the bus 3418. In this example, the neural network processor 3446 may be implemented by one or more integrated circuits, logic circuits, microprocessors, GPUs, DSPs, or controllers from any desired family or manufacturer that can be used to execute an AI model, such as a neural network, which may be implemented by the ML model 266. In some examples, one or more of the parser circuitry 220, the device identification circuitry 230, the wireless measurement determination circuitry 240, and/or the event generation circuitry 250 can be implemented in or with at least one of the GPU 3442, the VPU 3444, or the neural network processor 3446 instead of or in addition to the processor circuitry 3412.

FIG. 35 is a block diagram of an example implementation of the processor 3352 of FIG. 33 and/or the processor circuitry 3412 of FIG. 34. In this example, the processor 3352 of FIG. 33 and/or the processor circuitry 3412 of FIG. 34 is implemented by a microprocessor 3500. For example, the microprocessor 3500 may be a general purpose microprocessor (e.g., general purpose microprocessor circuitry). The microprocessor 3500 executes some or all of the machine-readable instructions of the flowcharts of FIGS. 23-28 to effectively instantiate the wireless measurement engine circuitry 200 of FIG. 2 as logic circuits to perform the operations corresponding to those machine-readable instructions. In some such examples, the wireless measurement engine circuitry 200 of FIG. 2 is instantiated by the hardware circuits of the microprocessor 3500 in combination with the instructions. For example, the microprocessor 3500 may be implemented by multi-core hardware circuitry such as a CPU, a DSP, a GPU, an XPU, etc. Although it may include any number of example cores 3502 (e.g., 1 core), the microprocessor 3500 of this example is a multi-core semiconductor device including N cores.

The cores 3502 of the microprocessor 3500 may operate independently or may cooperate to execute machine-readable instructions. For example, machine code corresponding to a firmware program, an embedded software program, or a software program may be executed by one of the cores 3502 or may be executed by multiple ones of the cores 3502 at the same or different times.

In some examples, the machine code corresponding to the firmware program, the embedded software program, or the software program is split into threads and executed in parallel by two or more of the cores 3502. The software program may correspond to a portion or all of the machine-readable instructions and/or operations represented by the flowcharts of FIGS. 23-28.

The cores 3502 may communicate by a first example bus 3504. In some examples, the first bus 3504 may be implemented by a communication bus to effectuate communication associated with one(s) of the cores 3502. For example, the first bus 3504 may be implemented by at least one of an Inter-Integrated Circuit (I2C) bus, a Serial Peripheral Interface (SPI) bus, a PCI bus, or a PCIe bus. Additionally or alternatively, the first bus 3504 may be implemented by any other type of computing or electrical bus. The cores 3502 may obtain data, instructions, and/or signals from one or more external devices by example interface circuitry 3506. The cores 3502 may output data, instructions, and/or signals to the one or more external devices by the interface circuitry 3506. Although the cores 3502 of this example include example local memory 3520 (e.g., Level 1 (L1) cache that may be split into an L1 data cache and an L1 instruction cache), the microprocessor 3500 also includes example shared memory 3510 that may be shared by the cores (e.g., Level 2 (L2 cache)) for high-speed access to data and/or instructions. Data and/or instructions may be transferred (e.g., shared) by writing to and/or reading from the shared memory 3510. The local memory 3520 of each of the cores 3502 and the shared memory 3510 may be part of a hierarchy of storage devices including multiple levels of cache memory and the main memory (e.g., the memory 3354 of FIG. 33, the main memory 3414, 3416 of FIG. 34, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 3502 may be referred to as a CPU, DSP, GPU, etc., or any other type of hardware circuitry. Each core 3502 includes control unit circuitry 3514, arithmetic and logic (AL) circuitry 3516 (sometimes referred to as an ALU), a plurality of registers 3518, the local memory 3520, and a second example bus 3522. Other structures may be present. For example, each core 3502 may include vector unit circuitry, single instruction multiple data (SIMD) unit circuitry, load/store unit (LSU) circuitry, branch/jump unit circuitry, floating-point unit (FPU) circuitry, etc. The control unit circuitry 3514 includes semiconductor-based circuits structured to control (e.g., coordinate) data movement within the corresponding core 3502. The AL circuitry 3516 includes semiconductor-based circuits structured to perform one or more mathematic and/or logic operations on the data within the corresponding core 3502. The AL circuitry 3516 of some examples performs integer based operations. In other examples, the AL circuitry 3516 also performs floating point operations. In yet other examples, the AL circuitry 3516 may include first AL circuitry that performs integer based operations and second AL circuitry that performs floating point operations. In some examples, the AL circuitry 3516 may be referred to as an Arithmetic Logic Unit (ALU). The registers 3518 are semiconductor-based structures to store data and/or instructions such as results of one or more of the operations performed by the AL circuitry 3516 of the corresponding core 3502. For example, the registers 3518 may include vector register(s), SIMD register(s), general purpose register(s), flag register(s), segment register(s), machine specific register(s), instruction pointer register(s), control register(s), debug register(s), memory management register(s), machine check register(s), etc. The registers 3518 may be arranged in a bank as shown in FIG. 35. Alternatively, the registers 3518 may be organized in any other arrangement, format, or structure including distributed throughout the core 3502 to shorten access time. The second bus 3522 may be implemented by at least one of an I2C bus, a SPI bus, a PCI bus, or a PCIe bus.

Each core 3502 and/or, more generally, the microprocessor 3500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 3500 is a semiconductor device fabricated to include many transistors interconnected to implement the structures described above in one or more integrated circuits (ICs) contained in one or more packages. The microprocessor 3500 may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 36 is a block diagram of another example implementation of the processor 3352 of FIG. 33 and/or the processor circuitry 3412 of FIG. 34. In this example, the processor 3352 of FIG. 33 and/or the processor circuitry 3412 of FIG. 34 is implemented by FPGA circuitry 3600. For example, the FPGA circuitry 3600 may be implemented by an FPGA. The FPGA circuitry 3600 can be used, for example, to perform operations that could otherwise be performed by the example microprocessor 3500 of FIG. 35 executing corresponding machine-readable instructions. However, once configured, the FPGA circuitry 3600 instantiates the machine-readable instructions in hardware and, thus, can often execute the operations faster than they could be performed by a general purpose microprocessor executing the corresponding software.

More specifically, in contrast to the microprocessor 3500 of FIG. 35 described above (which is a general purpose device that may be programmed to execute some or all of the machine-readable instructions represented by the flowcharts of FIGS. 23-28 but whose interconnections and logic circuitry are fixed once fabricated), the FPGA circuitry 3600 of the example of FIG. 36 includes interconnections and logic circuitry that may be configured and/or interconnected in different ways after fabrication to instantiate, for example, some or all of the machine-readable instructions represented by the flowcharts of FIGS. 23-28. In particular, the FPGA circuitry 3600 may be thought of as an array of logic gates, interconnections, and switches. The switches can be programmed to change how the logic gates are interconnected by the interconnections, effectively forming one or more dedicated logic circuits (unless and until the FPGA circuitry 3600 is reprogrammed). The configured logic circuits enable the logic gates to cooperate in different ways to perform different operations on data received by input circuitry. Those operations may correspond to some or all of the software represented by the flowcharts of FIGS. 23-28. As such, the FPGA circuitry 3600 may be structured to effectively instantiate some or all of the machine-readable instructions of the flowcharts of FIGS. 23-28 as dedicated logic circuits to perform the operations corresponding to those software instructions in a dedicated manner analogous to an ASIC. Therefore, the FPGA circuitry 3600 may perform the operations corresponding to the some or all of the machine-readable instructions of FIGS. 23-28 faster than the general purpose microprocessor can execute the same.

In the example of FIG. 36, the FPGA circuitry 3600 is structured to be programmed (and/or reprogrammed one or more times) by an end user by a hardware description language (HDL) such as Verilog. The FPGA circuitry 3600 of FIG. 36, includes example input/output (I/O) circuitry 3602 to obtain and/or output data to/from example configuration circuitry 3604 and/or external hardware 3606. For example, the configuration circuitry 3604 may be implemented by interface circuitry that may obtain machine-readable instructions to configure the FPGA circuitry 3600, or portion(s) thereof. In some such examples, the configuration circuitry 3604 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 3606 may be implemented by external hardware circuitry. For example, the external hardware 3606 may be implemented by the microprocessor 3500 of FIG. 35. The FPGA circuitry 3600 also includes an array of example logic gate circuitry 3608, a plurality of example configurable interconnections 3610, and example storage circuitry 3612. The logic gate circuitry 3608 and the configurable interconnections 3610 are configurable to instantiate one or more operations that may correspond to at least some of the machine-readable instructions of FIGS. 23-28 and/or other desired operations. The logic gate circuitry 3608 shown in FIG. 36 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 3608 to enable configuration of the electrical structures and/or the logic gates to form circuits to perform desired operations. The logic gate circuitry 3608 may include other electrical structures such as look-up tables (LUTs), registers (e.g., flip-flops or latches), multiplexers, etc.

The configurable interconnections 3610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 3608 to program desired logic circuits.

The storage circuitry 3612 of the illustrated example is structured to store result(s) of the one or more of the operations performed by corresponding logic gates. The storage circuitry 3612 may be implemented by registers or the like. In the illustrated example, the storage circuitry 3612 is distributed amongst the logic gate circuitry 3608 to facilitate access and increase execution speed.

The example FPGA circuitry 3600 of FIG. 36 also includes example Dedicated Operations Circuitry 3614. In this example, the Dedicated Operations Circuitry 3614 includes special purpose circuitry 3616 that may be invoked to implement commonly used functions to avoid the need to program those functions in the field. Examples of such special purpose circuitry 3616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 3600 may also include example general purpose programmable circuitry 3618 such as an example CPU 3620 and/or an example DSP 3622. Other general purpose programmable circuitry 3618 may additionally or alternatively be present such as a GPU, an XPU, etc., that can be programmed to perform other operations.

Although FIGS. 35 and 36 illustrate two example implementations of the processor 3352 of FIG. 33 and/or the processor circuitry 3412 of FIG. 34, many other approaches are contemplated. For example, as mentioned above, modern FPGA circuitry may include an on-board CPU, such as one or more of the example CPU 3620 of FIG. 36. Therefore, the processor 3352 of FIG. 33 and/or the processor circuitry 3412 of FIG. 34 may additionally be implemented by combining the example microprocessor 3500 of FIG. 35 and the example FPGA circuitry 3600 of FIG. 36. In some such hybrid examples, a first portion of the machine-readable instructions represented by the flowcharts of FIGS. 23-28 may be executed by one or more of the cores 3502 of FIG. 35, a second portion of the machine-readable instructions represented by the flowcharts of FIGS. 23-28 may be executed by the FPGA circuitry 3600 of FIG. 36, and/or a third portion of the machine-readable instructions represented by the flowcharts of FIGS. 23-28 may be executed by an ASIC. It should be understood that some or all of the wireless measurement engine circuitry 200 of FIG. 2 may, thus, be instantiated at the same or different times. Some or all of the wireless measurement engine circuitry 200 may be instantiated, for example, in one or more threads executing concurrently and/or in series. Moreover, in some examples, some or all of the wireless measurement engine circuitry 200 of FIG. 2 may be implemented within one or more virtual machines and/or containers executing on the microprocessor.

In some examples, the processor 3352 of FIG. 33 and/or the processor circuitry 3412 of FIG. 34 may be in one or more packages. For example, the microprocessor 3500 of FIG. 35 and/or the FPGA circuitry 3600 of FIG. 36 may be in one or more packages. In some examples, an XPU may be implemented by the processor 3352 and/or the processor circuitry 3412 of FIG. 34, which may be in one or more packages. For example, the XPU may include a CPU in one package, a DSP in another package, a GPU in yet another package, and an FPGA in still yet another package.

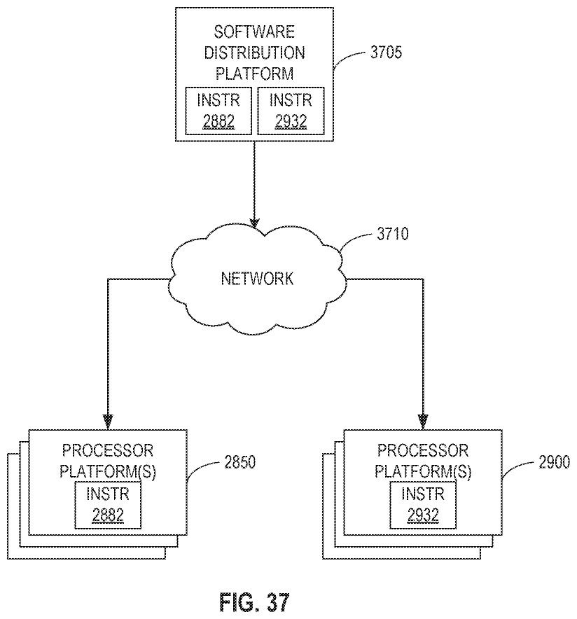

A block diagram illustrating an example software distribution platform 3705 to distribute software such as the example machine-readable instructions 3382 of FIG. 33 and/or the example machine-readable instructions 3432 of FIG. 34 to hardware devices owned and/or operated by third parties is illustrated in FIG. 37. The example software distribution platform 3705 may be implemented by any computer server, data facility, cloud service, etc., capable of storing and transmitting software to other computing devices. The third parties may be customers of the entity owning and/or operating the software distribution platform 3705. For example, the entity that owns and/or operates the software distribution platform 3705 may be a developer, a seller, and/or a licensor of software such as the example machine-readable instructions 3382 of FIG. 33 and/or the example machine-readable instructions 3432 of FIG. 34. The third parties may be consumers, users, retailers, OEMs, etc., who purchase and/or license the software for use and/or re-sale and/or sub-licensing. In the illustrated example, the software distribution platform 3705 includes one or more servers and one or more storage devices. The storage devices store the example machine-readable instructions 3382 of FIG. 33 and/or the example machine-readable instructions 3432 of FIG. 34, which may correspond to the example machine-readable instructions 2300, 2400, 2500, 2600, 2700, 2800 of FIGS. 23-28, as described above. The one or more servers of the example software distribution platform 3705 are in communication with an example network 3710, which may correspond to any one or more of the Internet and/or any of the example networks 104, 106, 107, 118, 3300, 3426 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the example machine-readable instructions 3382 of FIG. 33 and/or the example machine-readable instructions 3432 of FIG. 34 from the software distribution platform 3705. For example, the software, which may correspond to the example machine-readable instructions 3382 of FIG. 33 and/or the example machine-readable instructions 3432 of FIG. 34, may be downloaded to the example IoT device 3350, which is to execute the machine-readable instructions 3382 to implement the wireless measurement engine circuitry 200, and/or the example processor platform 3400, which is to execute the machine-readable instructions 3432 to implement the wireless measurement engine circuitry 200. In some examples, one or more servers of the software distribution platform 3705 periodically offer, transmit, and/or force updates to the software (e.g., the example machine-readable instructions 3382 of FIG. 33 and/or the example machine-readable instructions 3432 of FIG. 34) to ensure improvements, patches, updates, etc., are distributed and applied to the software at the end user devices.

From the foregoing, it will be appreciated that example systems, methods, apparatus, and articles of manufacture have been disclosed that determine wireless measurements associated with a wireless device, and/or, more generally, a wireless network, in substantially real-time. Disclosed systems, apparatus, articles of manufacture, and methods improve the efficiency of computing devices adapted, configured, and/or otherwise instantiated for wireless measurement determination associated with wireless devices and/or networks by using less total time and/or resources by implementing the wireless measurement determination on reduced information. Disclosed systems, apparatus, articles of manufacture, and methods are accordingly directed to one or more improvement(s) in the operation of a machine such as a computer or other electronic and/or mechanical device.

Example 1 includes a method for wireless measurement determination comprising enqueueing a data pointer into a first data queue, the data pointer associated with wireless data from a wireless device, the first data queue associated with a first worker core of the processor circuitry, generating, with the first worker core, a wireless measurement based on the wireless data, dequeuing the data pointer from the first data queue into a second data queue, the data pointer associated with the wireless measurement, the second data queue associated with a second worker core of the processor circuitry, and determining, with the second worker core, a change to a configuration of at least one of the wireless device or a network associated with the wireless device based on the wireless measurement.

In Example 2, the subject matter of Example 1 can optionally include that parsing the wireless data into data portions.

In Example 3, the subject matter of any of Examples 1-2 can optionally include verifying that the wireless device is a trusted wireless device.

In Example 4, the subject matter of any of Examples 1-3 can optionally include identifying the wireless device based on an identifier included in the wireless data.

In Example 5, the subject matter of any of Examples 1-4 can optionally include at least one of executing or instantiating a machine-learning model based on the wireless data to output the wireless measurement.

In Example 6, the subject matter of any of Examples 1-5 can optionally include executing or instantiating a machine-learning model based on the wireless data to output the change.

In Example 7, the subject matter of any of Examples 1-6 can optionally include generating event data to cause the change to occur.

In Example 8, the subject matter of any of Examples 1-7 can optionally include storing at least one of the wireless data, the wireless measurement, or the output from the machine-learning model in a datastore for access by at least one of an application or a service.

In Example 9, the subject matter of any of Examples 1-8 can optionally include determining to switch the wireless device from a first network to a second network.

In Example 10, the subject matter of any of Examples 1-9 can optionally include that the first network is a cellular network and the second network is a Wireless Fidelity network.

In Example 11, the subject matter of any of Examples 1-10 can optionally include that the first network is a Wireless Fidelity network and the second network is a cellular network.

In Example 12, the subject matter of any of Examples 1-11 can optionally include that the wireless data is fifth generation cellular data.

In Example 13, the subject matter of any of Examples 1-12 can optionally include that the wireless data is Wireless Fidelity data.

In Example 14, the subject matter of any of Examples 1-13 can optionally include that the change is to effectuate power management associated with the wireless device.

In Example 15, the subject matter of any of Examples 1-14 can optionally include that the change is to reduce radiofrequency interference associated with the wireless device.

In Example 16, the subject matter of any of Examples 1-15 can optionally include that the change is to a communication channel associated with the wireless device.

In Example 17, the subject matter of any of Examples 1-16 can optionally include that the change is to change at least one of a receive power or a transmit power of an antenna of the wireless device.

In Example 18, the subject matter of any of Examples 1-17 can optionally include determining a location of the wireless device based on the wireless measurement.

In Example 19, the subject matter of any of Examples 1-18 can optionally include effectuating a lawful interception of the wireless data.

In Example 20, the subject matter of any of Examples 1-19 can optionally include that the determination of the wireless measurement is substantially in real-time.

In Example 21, the subject matter of any of Examples 1-20 can optionally include that the wireless measurement is a minimum value, a maximum value, or an average value of downlink latency.

In Example 22, the subject matter of any of Examples 1-21 can optionally include that the wireless measurement is a minimum value, a maximum value, or an average value of downlink latency per transmission time interval.

In Example 23, the subject matter of any of Examples 1-22 can optionally include that the wireless measurement is a minimum value, a maximum value, or an average value of uplink latency.

In Example 24, the subject matter of any of Examples 1-23 can optionally include that the wireless measurement is a minimum value, a maximum value, or an average value of uplink latency per transmission time interval.

In Example 25, the subject matter of any of Examples 1-24 can optionally include that the wireless measurement is a minimum value, a maximum value, or an average value of sounding reference signal latency.

In Example 26, the subject matter of any of Examples 1-25 can optionally include that the wireless measurement is a minimum value, a maximum value, or an average value of sounding reference signal latency per transmission time interval.

In Example 27, the subject matter of any of Examples 1-26 can optionally include that the wireless measurement is a throughput value of the wireless data.

In Example 28, the subject matter of any of Examples 1-27 can optionally include that the wireless measurement is a utilization percentage of one or more cores of a network interface that receives the wireless data.

In Example 29, the subject matter of any of Examples 1-28 can optionally include that the wireless measurement is a number of a total number of receive packets, a number of receive packets that are on time, a number of receive packets that are early, a number of receive packets that are late, a number of receive packets that are corrupt, or a number of receive packets that are duplicate.

Example 30 includes a method comprising obtaining multi-access wireless data from a wireless device associated with a network, the multi-access wireless data associated with an operation of at least one of the wireless device or infrastructure of the network, computing, in substantially real time relative to the operation by executing an instruction with programmable circuitry, a measurement based on the multi-access wireless data, and determining, in substantially real time relative to the operation by executing an instruction with the programmable circuitry, a change to a configuration of at least one of the wireless device or a virtual radio based on the measurement, the virtual radio associated with the network.

In Example 31, the subject matter of Example 30 can optionally include outputting a signal to instruct the at least one of the wireless device or the network to change the configuration of the at least one of the wireless device or the virtual radio.

In Example 32, the subject matter of any of Examples 30-31 can optionally include determining the change to the configuration of the at least one of the wireless device or the virtual radio based on a mode of operation of the virtual radio.

In Example 33, the subject matter of any of Examples 30-32 can optionally include determining the change to the configuration of at least one of the wireless device or the virtual radio to improve performance of an application associated with the wireless device.

In Example 34, the subject matter of any of Examples 30-33 can optionally include that the multi-access wireless data is multi-access physical layer wireless data.

In Example 35, the subject matter of any of Examples 30-34 can optionally include determining the mode of operation for the virtual radio based on a signal from a compute device that is remote with respect to the programmable circuitry.

In Example 36, the subject matter of any of Examples 30-35 can optionally include transmitting a first reference signal to the wireless device, and processing the multi-access wireless data to determine a difference between the first reference signal and a second reference signal included in the multi-access wireless data.

In Example 37, the subject matter of Example 36 can optionally include that the change is a first change, and the method further includes processing the difference between the first reference signal and the second reference signal to determine a second change, the second change including at least one of a timing change of a data transmission associated with the wireless device, a phase change of an antenna associated with the wireless device, a power settings change of the antenna, formation of a first beam between the wireless device and interface circuitry associated with the programmable circuitry, or alteration of a second beam formed between the wireless device and the interface circuitry.

In Example 38, the subject matter of any of Examples 30-37 can optionally include executing a machine learning model to determine the change to the configuration of the at least one of the wireless device or the virtual radio based on the measurement.

In Example 39, the subject matter of any of Examples 30-38 can optionally include that the measurement includes at least one of a location measurement associated with the multi-access wireless data, registration data associated with the multi-access wireless data, a reference signal measurement associated with the multi-access wireless data, a signal-to-noise ratio measurement associated with the multi-access wireless data, a channel impulse response measurement associated with the multi-access wireless data, device identifier data associated with the multi-access wireless data, header data associated with the multi-access wireless data, payload data associated with the multi-access wireless data, a Wi-Fi measurement associated with the multi-access wireless data, a Bluetooth measurement associated with the multi-access wireless data, or a satellite measurement associated with the multi-access wireless data.

In Example 40, the subject matter of any of Examples 30-39 can optionally include that the change to the configuration of the at least one of the wireless device or the virtual radio includes at least one of an increase to a first antenna power of the wireless device, an increase to a second antenna power of interface circuitry, activation of a first number of compute cores of the programmable circuitry to increase throughput of the network, or deactivation of a second number of compute cores of the programmable circuitry to reduce power consumption.

Example 41 is at least one computer readable medium comprising instructions to perform the method of any of Examples 1-29 and/or the method of any of Examples 30-40.

Example 42 is at least one machine readable medium comprising instructions to perform the method of any of Examples 1-29 and/or the method of any of Examples 30-40.

Example 43 is edge server processor circuitry to perform the method of any of Examples 1-29 and/or the method of any of Examples 30-40.

Example 44 is an edge cloud processor circuitry to perform the method of any of Examples 1-29 and/or the method of any of Examples 30-40.

Example 45 is edge node processor circuitry to perform the method of any of Examples 1-29 and/or the method of any of Examples 30-40.

Example 46 is measurement engine circuitry to perform the method of any of Examples 1-29 and/or the method of any of Examples 30-40.

Example 47 is a wireless measurement engine to perform the method of any of Examples 1-29 and/or the method of any of Examples 30-40.

Example 48 is wireless measurement engine circuitry to perform the method of any of Examples 1-29 and/or the method of any of Examples 30-40.

Example 49 is an apparatus comprising processor circuitry to perform the method of any of Examples 1-29 and/or the method of any of Examples 30-40.

Example 50 is an apparatus comprising programmable circuitry to perform the method of any of Examples 1-29 and/or the method of any of Examples 30-40.

Example 51 is an apparatus comprising one or more edge gateways to perform the method of any of Examples 1-29 and/or the method of any of Examples 30-40.

Example 52 is an apparatus comprising one or more edge switches to perform the method of any of Examples 1-29 and/or the method of any of Examples 30-40.

Example 53 is an apparatus comprising at least one of one or more edge gateways or one or more edge switches to perform the method of any of Examples 1-29 and/or the method of any of Examples 30-40.

Example 54 is an apparatus comprising accelerator circuitry to perform the method of any of Examples 1-29 and/or the method of any of Examples 30-40.

Example 55 is an apparatus comprising one or more graphics processor units to perform the method of any of Examples 1-29 and/or the method of any of Examples 30-40.

Example 56 is an apparatus comprising one or more Artificial Intelligence processors to perform the method of any of Examples 1-29 and/or the method of any of Examples 30-40.

Example 57 is an apparatus comprising one or more machine learning processors to perform the method of any of Examples 1-29 and/or the method of any of Examples 30-40.

Example 58 is an apparatus comprising one or more neural network processors to perform the method of any of Examples 1-29 and/or the method of any of Examples 30-40.

Example 59 is an apparatus comprising one or more digital signal processors to perform the method of any of Examples 1-29 and/or the method of any of Examples 30-40.

Example 60 is an apparatus comprising one or more general purpose processors to perform the method of any of Examples 1-29 and/or the method of any of Examples 30-40.

Example 61 is an apparatus comprising network interface circuitry to perform the method of any of Examples 1-29 and/or the method of any of Examples 30-40.

Example 62 is an Infrastructure Processor Unit to perform the method of any of Examples 1-29 and/or the method of any of Examples 30-40.

Example 63 is dynamic load balancer circuitry to perform the method of any of Examples 1-29 and/or the method of any of Examples 30-40.

Example 64 is radio unit circuitry to perform the method of any of Examples 1-29 and/or the method of any of Examples 30-40.

Example 65 is remote radio unit circuitry to perform the method of any of Examples 1-29 and/or the method of any of Examples 30-40.

Example 66 is radio access network circuitry to perform the method of any of Examples 1-29 and/or the method of any of Examples 30-40.

Example 67 is one or more base stations to perform the method of any of Examples 1-29 and/or the method of any of Examples 30-40.

Example 68 is base station circuitry to perform the method of any of Examples 1-29 and/or the method of any of Examples 30-40.

Example 69 is user equipment circuitry to perform the method of any of Examples 1-29 and/or the method of any of Examples 30-40.

Example 70 is one or more Internet-of-Things devices to perform the method of any of Examples 1-29 and/or the method of any of Examples 30-40.

Example 71 is one or more fog devices to perform the method of any of Examples 1-29 and/or the method of any of Examples 30-40.

Example 72 is a software distribution platform to distribute machine-readable instructions that, when executed by processor circuitry, cause the processor circuitry to perform the method of any of Examples 1-29 and/or the method of any of Examples 30-40.

Example 73 is edge cloud circuitry to perform the method of any of Examples 1-29 and/or the method of any of Examples 30-40.

Example 74 is distributed unit circuitry to perform the method of any of Examples 1-29 and/or the method of any of Examples 30-40.

Example 75 is central or centralized unit circuitry to perform the method of any of Examples 1-29 and/or the method of any of Examples 30-40.

Example 76 is core server circuitry to perform the method of any of Examples 1-29 and/or the method of any of Examples 30-40.

Example 77 is satellite circuitry to perform the method of any of Examples 1-29 and/or the method of any of Examples 30-40.

Example 78 is at least one of one more GEO satellites or one or more LEO satellites to perform the method of any of Examples 1-29 and/or the method of any of Examples 30-40.

Example 79 is an autonomous vehicle to perform the method of any of Examples 1-29 and/or the method of any of Examples 30-40.

Example 80 is a robot to perform the method of any of Examples 1-29 and/or the method of any of Examples 30-40.

Example 81 is circuitry to execute and/or instantiate instructions to implement FLEXRAN™ protocol to perform the method of any of Examples 1-29 and/or the method of any of Examples 30-40.

Example 82 is circuitry to execute and/or instantiate instructions to implement a virtual radio access network protocol to perform the method of any of Examples 1-29 and/or the method of any of Examples 30-40.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
interface circuitry to obtain multi-access wireless data from a wireless device associated with a network, the multi-access wireless data associated with an operation of at least one of the wireless device or infrastructure of the network;
machine readable instructions; and
programmable circuitry to utilize the machine readable instructions to:
compute, in substantially real time relative to the operation, a measurement based on the multi-access wireless data; and
determine, in substantially real time relative to the operation, a change to a configuration of at least one of the wireless device or a virtual radio based on the measurement, the virtual radio associated with the network.

2. The apparatus of claim 1, wherein the programmable circuitry is to cause the interface circuitry to output a signal to instruct the at least one of the wireless device or the network to change the configuration of the at least one of the wireless device or the virtual radio.

3. The apparatus of claim 1, wherein the programmable circuitry is to determine the change to the configuration of the at least one of the wireless device or the virtual radio based on a mode of operation of the virtual radio.

4. The apparatus of claim 1, wherein the programmable circuitry is to determine the change to the configuration of at least one of the wireless device or the virtual radio to improve performance of an application associated with the wireless device.

5. The apparatus of claim 1, wherein the multi-access wireless data is multi-access physical layer wireless data.

6. The apparatus of claim 1, wherein the programmable circuitry is to determine a mode of operation for the virtual radio based on a signal from a compute device that is remote with respect to the apparatus.

7. The apparatus of claim 1, wherein:
the interface circuitry is to transmit a first reference signal to the wireless device; and
the programmable circuitry is to process the multi-access wireless data to determine a difference between the first reference signal and a second reference signal included in the multi-access wireless data.

8. The apparatus of claim 7, wherein the change is a first change, and the programmable circuitry is to process the difference between the first reference signal and the second reference signal to determine a second change, the second change including at least one of:
a timing change of a data transmission associated with the wireless device;
a phase change of an antenna associated with the wireless device;
a power settings change of the antenna;
formation of a first beam between the wireless device and the interface circuitry; or
alteration of a second beam formed between the wireless device and the interface circuitry.

9. The apparatus of claim 1, wherein the programmable circuitry is to execute a machine learning model to determine the change to the configuration of the at least one of the wireless device or the virtual radio based on the measurement.

10. The apparatus of claim 1, wherein the measurement includes at least one of a location measurement associated with the multi-access wireless data, registration data associated with the multi-access wireless data, a reference signal measurement associated with the multi-access wireless data, a signal-to-noise ratio measurement associated with the multi-access wireless data, a channel impulse response measurement associated with the multi-access wireless data, device identifier data associated with the multi-access wireless data, header data associated with the multi-access wireless data, payload data associated with the multi-access wireless data, a Wi-Fi measurement associated with the multi-access wireless data, a Bluetooth measurement associated with the multi-access wireless data, or a satellite measurement associated with the multi-access wireless data.

11. The apparatus of claim 1, wherein the change to the configuration of the at least one of the wireless device or the virtual radio includes at least one of an increase to a first antenna power of the wireless device, an increase to a second antenna power of the interface circuitry, activation of a first number of compute cores of the programmable circuitry to increase throughput of the network, or deactivation of a second number of compute cores of the programmable circuitry to reduce power consumption.

12. A non-transitory computer readable medium comprising instructions to cause programmable circuitry to:
compute, in substantially real-time relative to an operation of at least one of a wireless device or infrastructure of a network associated with the wireless device, a measurement based on multi-access wireless data obtained from the wireless device; and
determine, in substantially real time relative to the operation, a change to a configuration of at least one of the wireless device or a virtual radio based on the measurement, the virtual radio associated with the network.

13. The non-transitory computer readable medium of claim 12, wherein the instructions cause the programmable circuitry to cause interface circuitry to output a signal to instruct the at least one of the wireless device or the network to change the configuration of the at least one of the wireless device or the virtual radio.

14. The non-transitory computer readable medium of claim 12, wherein the instructions cause the programmable circuitry to determine the change to the configuration of the at least one of the wireless device or the virtual radio based on a mode of operation of the virtual radio.

15. The non-transitory computer readable medium of claim 12, wherein the instructions cause the programmable circuitry to determine the change to the configuration of at least one of the wireless device or the virtual radio to improve performance of an application associated with the wireless device.

16. The non-transitory computer readable medium of claim 12, wherein the multi-access wireless data is multi-access physical layer wireless data.

17. (canceled)

18. The non-transitory computer readable medium of claim 12, wherein instructions cause the programmable circuitry to process the multi-access wireless data to determine a difference between a first reference signal and a second reference signal included in the multi-access wireless data, the first reference signal having been transmitted to the wireless device.

19. The non-transitory computer readable medium of claim 18, wherein the change is a first change, and the instructions are to cause the programmable circuitry to process the difference between the first reference signal and the second reference signal to determine a second change, the second change including at least one of:
a timing change of a data transmission associated with the wireless device;
a phase change of an antenna associated with the wireless device;
a power settings change of the antenna;
formation of a first beam between the wireless device and interface circuitry associated with the programmable circuitry; or
alteration of a second beam formed between the wireless device and the interface circuitry.

20-22. (canceled)

23. A method comprising:
obtaining multi-access wireless data from a wireless device associated with a network, the multi-access wireless data associated with an operation of at least one of the wireless device or infrastructure of the network;
computing, in substantially real time relative to the operation by executing an instruction with programmable circuitry, a measurement based on the multi-access wireless data; and
determining, in substantially real time relative to the operation by executing an instruction with the programmable circuitry, a change to a configuration of at least one of the wireless device or a virtual radio based on the measurement, the virtual radio associated with the network.

24. The method of claim 23, further including outputting a signal to instruct the at least one of the wireless device or the network to change the configuration of the at least one of the wireless device or the virtual radio.

25-33. (canceled)
